(19) United States
(12) Patent Application Publication
(10) Pub. No.: US 2026/0140420 A1
(43) Pub. Date: May 21, 2026

(54) ELECTROCHROMIC WINDOW WITH ADJUSTABLE TINT AREA

(71) Applicant: View, Inc., San Jose, CA (US)

(72) Inventors: Timothy John Nagle, San Jose, CA (US); Robin Sean Friedman, Redwood City, CA (US)

(73) Assignee: View, Inc., San Jose, CA (US)

(21) Appl. No.: 18/706,177

(22) PCT Filed: Nov. 2, 2022
(86) PCT No.: PCT/US2022/079139

§ 371 Date: Apr. 30, 2024

Related U.S. Application Data
(60) Provisional application No. 63/263,432, filed on Nov. 2, 2021.

(51) Int. Cl. G02F 1/163; G02F 1/153; G02F 1/155

(52) U.S. Cl. CPC G02F 1/163; G02F 1/1533; G02F 1/155

(57) ABSTRACT

Thin-film devices, for example, multi-zone electrochromic windows, and methods of manufacturing are described. In certain cases, a multi-zone electrochromic window comprises a monolithic EC device on a transparent substrate and two or more tinting zones, wherein the tinting zones are configured for independent operation.

### CROSS-REFERENCES TO RELATED APPLICATIONS

This application is a continuation-in-part of U.S. patent application Ser. No. 17/303,944, titled “MULTI-ZONE EC WINDOWS,” filed on Jun. 10, 2021, which is a continuation application of U.S. patent application Ser. No. 16/191,138, titled “MULTI-ZONE EC WINDOWS” and filed on Nov. 14, 2018, which is a continuation application of U.S. patent application Ser. No. 15/039,370, titled “MULTI-ZONE EC WINDOWS” and filed on May 25, 2016, which is a national stage application under 35 U.S.C. § 371 to International Application PCT/US14/71314 (designating the United States), titled “MULTI-ZONE EC WINDOWS” and filed on Dec. 18, 2014, which is a continuation-in-part application to U.S. patent application Ser. No. 14/137,644, titled “MULTI-ZONE EC WINDOWS” and filed on Dec. 20, 2013; U.S. patent application Ser. No. 15/039,370 is also a continuation-in-part application of U.S. patent application Ser. No. 15/094,897, titled “MULTI-ZONE EC WINDOWS” and filed on Apr. 8, 2016, which is a continuation of U.S. patent application Ser. No. 14/137,644 (now U.S. Pat. No. 9,341,912), titled “MULTI-ZONE EC WINDOWS” and filed on Dec. 20, 2013; U.S. patent application Ser. No. 14/137,644 is a continuation-in-part application of International Application PCT/US13/069913 (designating the United States), titled “MULTI-ZONE EC WINDOWS” and filed on Nov. 13, 2013, which claims benefit of and priority to U.S. Provisional Patent Application No. 61/725,980, titled “MULTI-ZONE EC WINDOWS” and filed on Nov. 13, 2012, and to U.S. Provisional Patent Application No. 61/740,651, titled “MULTI-ZONE EC WINDOWS” and filed on Dec. 21, 2012; U.S. patent application Ser. No. 14/137,644 is also a continuation-in-part application of International Application PCT/US13/031098 (designating the United States), titled “PINHOLE MITIGATION FOR OPTICAL DEVICES” and filed on Mar. 13, 2013, which claims benefit of and priority of U.S. Provisional Patent Application No. 61/610,241, titled “PINHOLE MITIGATION FOR OPTICAL DEVICES” and filed on Mar. 13, 2012; each of these applications is hereby incorporated by reference in its entirety and for all purposes.

### FIELD

Embodiments disclosed herein relate generally to optical devices, and more particularly to methods of fabricating optical devices and particularly to electrochromic (EC) windows having multiple tinting zones.

### BACKGROUND

Electrochromism is a phenomenon in which a material exhibits a reversible electrochemically-mediated change in an optical property when placed in a different electronic state, typically by being subjected to a voltage change. The optical property is typically one or more of tint, transmittance, absorbance, and reflectance. For example, one well known electrochromic material is tungsten oxide (WO₃). Tungsten oxide is a cathodically tinting electrochromic material in which a tinting transition, bleached (untinted) to blue, occurs by electrochemical reduction. When electrochemical oxidation takes place, tungsten oxide transitions from blue to a bleached state.

Electrochromic materials may be incorporated into, for example, windows for home, commercial and other uses. The tint, transmittance, absorbance, and/or reflectance of such windows may be changed by inducing a change in the electrochromic material, that is, electrochromic windows are windows that can be darkened and lightened reversibly via application of an electric charge. A small voltage applied to an electrochromic device of the window will cause it to darken; reversing the voltage causes it to lighten. This capability allows control of the amount of light that passes through the windows, and presents an opportunity for electrochromic windows to be used as energy-saving devices.

While electrochromism was discovered in the 1960s, electrochromic devices, and particularly electrochromic windows, still unfortunately suffer various problems and have not begun to realize their full commercial potential despite much recent advancement in electrochromic technology, apparatus, and related methods of making and/or using electrochromic devices.

### SUMMARY

Thin-film devices, for example, electrochromic devices for windows, and methods of manufacturing are described. Embodiments include electrochromic window lites having two or more tinting (or coloration) zones, where there is only a single monolithic electrochromic device on the lite. Certain embodiments include constructs, e.g. laminates, IGUs and the like, that have two EC lites, panes, where one of the panes has EC zones, and the other pane may have a monolithic EC device coating or also be a zoned EC coating. Tinting zones are defined by virtue of the means for applying potential to the device and/or by a resistive zone between adjacent tinting zones. For example, sets of bus bars are configured to apply potential across separate zones (areas) of the device and thereby tint them selectively. The advantages include no visible scribe lines in the viewable area of the EC window due to, e.g., cutting through the EC device to make separate devices that serve as tinting zones. Embodiments that include two EC panes may include a multi-zone EC pane where the zones are formed by cutting through the EC device coating, i.e. the other EC pane is used to mask or otherwise conceal or ameliorate the visual distraction caused by the through cuts on the other pane.

One embodiment is an electrochromic window lite including a monolithic EC device on a transparent substrate, the monolithic EC device including two or more tinting zones, each of said two or more tinting zones configured for operation independent of the others and each having a pair of associated bus bars, where the two or more tinting zones are not separated from each other by isolation scribes. That is, the EC device stack is not cut through, but rather is intact as a monolithic device. For example, there may be two tinting zones on the lite and the associated bus bars arranged are located at opposing edges of the lite (e.g., vertically oriented), wherein a set of bus bars is associated with each of the two tinting zones.

Bus bars may be configured to enhance coloring of tinting zones. In certain embodiments, bus bars have varying width along their length; the varying width of the bus bars may enhance the tinting front and/or promote selective tinting in a particular tinting zone via voltage gradients. In other embodiments, bus bars may be composites, having both high electrically conductive regions and resistive regions, configured to enhance tinting fronts and/or promote selective tinting in a particular tinting zone via voltage gradients. One embodiment is directed to an electrochromic window lite comprising a monolithic EC device on a transparent substrate and at least one pair of lengthwise variable bus bars configured to produce a tint gradient zone on the monolithic EC device when energized.

In certain embodiments, the two or more tinting zones are separated by a resistive zone which inhibits, at least partially, the flow of electrons, ions or both across the resistive zone. Resistive zones may, e.g., be parallel to bus bars and/or orthogonal to bus bars. Resistive zones may include modification of the EC device and/or one or both transparent conductor layers (TCOs) of the EC device. Monolithic EC lites having two or more tinting zones may be integrated into insulating glass units (IGUs) and/or laminates (singly or as part of an IGU). The mate lite may or may not also be an electrochromic lite, and may or may not also have tinting zones.

One embodiment is directed to an electrochromic window lite comprising a monolithic EC device disposed on a transparent substrate and a resistive zone. The monolithic EC device is comprised of first and second transparent conductor layers and an EC stack between the first and second transparent conductor layers. The resistive zone in one of the first and second transparent conducting layers. The resistive zone has a higher electrical resistance than a portion of the one of the first and second transparent conducting layers outside the resistive zone. In one case, the resistive zone is a linear region in the one of the first and second transparent conducting layer with thinner or absent material.

Certain aspects of the disclosure pertain to an electrochromic window lite that may be characterized by the following features: a monolithic EC device on a transparent substrate, the monolithic EC device comprising: two or more tinting zones, each of the two or more tinting zones configured for operation independent of the others and having an associated pair of bus bars. In certain embodiments, the two or more tinting zones contain only a partial cut through the uppermost TCO of the monolithic EC device to form a resistive zone between each of said two or more tinting zones. An associated pair of bus bars means that each zone may have a pair of bus bars that are exclusive to that zone and not shared with any other zone, or two or more zones may share a common bus bar, but in either case no two zones share the same pair of bus bars.

In certain embodiments, the associated bus bars located at opposing edges for each of the two tinting zones. In certain embodiments, the electrochromic window lite is incorporated into an insulated glass unit, which may have a mate lite that is (i) not an electrochromic lite or (ii) a monolithic electrochromic lite with a single tinting zone, or (iii) a monolithic electrochromic lite with two or more tinting zones (where the tinting zones of the mate lite may be aligned with those of the electrochromic window lite), or (iv) an electrochromic lite with three or more tinting zones. In such embodiments, the electrochromic window lite may be configured to tint in one or more tinting zones to <1% T.

In some implementations, the resistive zone substantially spans across the monolithic EC device. In some implementations, the resistive zone is between about 1 nm wide and about 10 nm wide. In certain embodiments, the resistive zone is formed by removing between about 10% and about 90% of the uppermost TCO material along the resistive zone. As an example, the resistive zone may be formed by laser irradiation of the uppermost TCO. As a further example, each of the two or more tinting zones associated bus bars are formed by laser irradiation during formation of the resistive zone by cutting through a single bus bar.

Other aspects of the disclosure pertain to methods of forming a monolithic EC device comprising two tinting zones, where the methods may be characterized by the following operations: (a) forming the monolithic EC device; (b) applying a single bus bar to the top TCO of the monolithic EC device; (c) cutting through the single bus bar along its width; and, (d) cutting at least part way through the top TCO, but not through the electrode layer adjacent to the top TCO, to form a resistive zone between the two tinting zones. In certain embodiments, operation (c) forms separate bus bars for each of the two tinting zones from the single bus bar. In some implementations, operations (c) and (d) are performed in a single cutting step.

In some implementations, the resistive zone substantially spans the width of the monolithic EC device. In certain embodiments, the resistive zone is between about 1 nm wide and about 10 nm wide. In certain embodiments, the resistive zone is formed by removing between about 10% and about 90% of the uppermost TCO material along the resistive zone. As an example, the resistive zone may be formed by laser irradiation of the uppermost TCO.

Zoning in EC windows may be used in certain applications, e.g., a window is made darker at the top to control glare, while the bottom portion is lighter so user view is maintained and more light still enters the room than would otherwise with a monolithic EC coating fully tinted to reduce glare.

Another aspect of the disclosure concerns electrochromic window lites (panes) characterized by the following features: an EC device on a transparent substrate, the EC device comprising bus bars; a region of the transparent substrate that is not covered by the EC device, where the region capable of providing, when not mitigated, a bright spot or bright region when the EC device is tinted; and an obscuring material over the region, wherein the material has a lower transmittance than the substrate. In some embodiments, the region is a pinhole, a scribe line, or an edge line.

Yet another aspect of the disclosure concerns methods of obscuring a potentially bright area produced by a region of a transparent substrate that is not covered by an EC device. Such methods may be characterized by the following operations: (a) providing an electrochromic lite having the EC device coating on a substrate; (b) identifying a site of the potentially bright area on the substrate; and (c) applying an obscuring material to the site. The obscuring material has a lower transmittance than the substrate. In certain embodiments, the region is a pinhole, a scribe line, or an edge line.

These and other features and advantages will be described in further detail below, with reference to the associated drawings.

### BRIEF DESCRIPTION OF THE DRAWINGS

The following detailed description can be more fully understood when considered in conjunction with the drawings in which:

FIG. 1 depicts fabrication of an IGU with an EC lite and associated tinting schemes.

FIGS. 2A and 2B depict an IGU having an EC lite with two tinting zones delineated by laser scribe, and associated tinting schemes, respectively.

FIGS. 3A and 3B depict fabrication of an IGU with an EC lite having tinting zones configured on a monolithic EC device and associated tinting schemes, respectively.

FIG. 3C depicts various tinting schemes as a function of tinting front of tinting zones.

FIGS. 3D and 3E depict fabrication of an IGU having two EC lites, where each of the EC lites has two tinting zones, and associated tinting schemes, respectively.

FIGS. 4A-C depict fabrication of an IGU with an EC lite and associated tinting schemes, respectively.

FIGS. 4D-M depict EC lites, each having a gradient tinting zone.

FIGS. 5A and 5B depict fabrication of an IGU with an EC lite and associated tinting schemes, respectively.

FIG. 5C depicts a perspective and a cross section of an EC device having two tinting zones separated by a resistive zone.

FIG. 5D depicts a perspective and a cross section of an EC device having two tinting zones by virtue of a resistive zone.

FIG. 5E shows graphs of VTCL for two transparent conducting oxide layers of an EC device configured with a resistive zone created by inhibiting the electrical conductivity of only one of the transparent conducting oxide layers.

FIG. 5F depicts a tinting pattern of the EC lite described in relation to FIG. 5C.

FIGS. 5G to 5K depict EC devices configured with a resistive zone created by inhibiting the electrical conductivity of only one of the transparent conducting oxides.

FIG. 6A depicts a resistive zone establishing a closed perimeter defining a separate tinting zone.

FIG. 6B depicts a resistive zone establishing an open perimeter defining a separate tinting zone.

FIG. 7 depicts using resistive zones for multi EC lite patterns/displays.

FIG. 8 depicts a building facade using resistive zones to create words and/or ornamental designs.

FIG. 9 depicts a building facade using gradient zoning across multiple IGUs.

FIG. 10 depicts a perspective and a cross section of an EC device, EC lite 1010, similar to FIG. 5D.

FIG. 11 depicts a front view of the EC lite of FIG. 10 in an exemplary tinted state.

FIG. 12A depicts a first example illustration of repositioning a tint front location on the EC device of FIGS. 10 and 11.

FIG. 12B depicts a second example illustration of repositioning a tint front location on the EC device of FIGS. 10 and 11.

FIG. 13 depicts an example illustration of adjusting a tint transition abruptness on the EC device of FIG. 10.

FIG. 14 depicts an example technique for tinting an EC window having the structure of FIG. 10.

FIG. 15 depicts another example technique for tinting an EC window having the structure of FIG. 10.

FIG. 16 depicts a perspective and a cross section of an EC lite 1610, similar to FIG. 5G.

FIGS. 17A-C depict additional examples of EC device schematics set to various voltages.

FIG. 18 depicts an example illustration of repositioning a tint front location on the EC device of FIG. 16.

FIG. 19 depicts a perspective and a cross-section of an EC device.

FIG. 20 depicts a front view of the EC lite of FIG. 19 in an exemplary tinted state.

FIG. 21 depicts a perspective and a cross-section of an EC device.

### DETAILED DESCRIPTION

Certain embodiments are directed to optical devices, that is, thin-film devices having at least one transparent conductor layer. In the simplest form, an optical device includes a substrate and one or more material layers sandwiched between two conductor layers, one of which is transparent. In one embodiment, an optical device includes a transparent substrate and two transparent conductor layers. Certain embodiments described herein, although not limited as such, work particularly well with solid state and inorganic electrochromic devices.

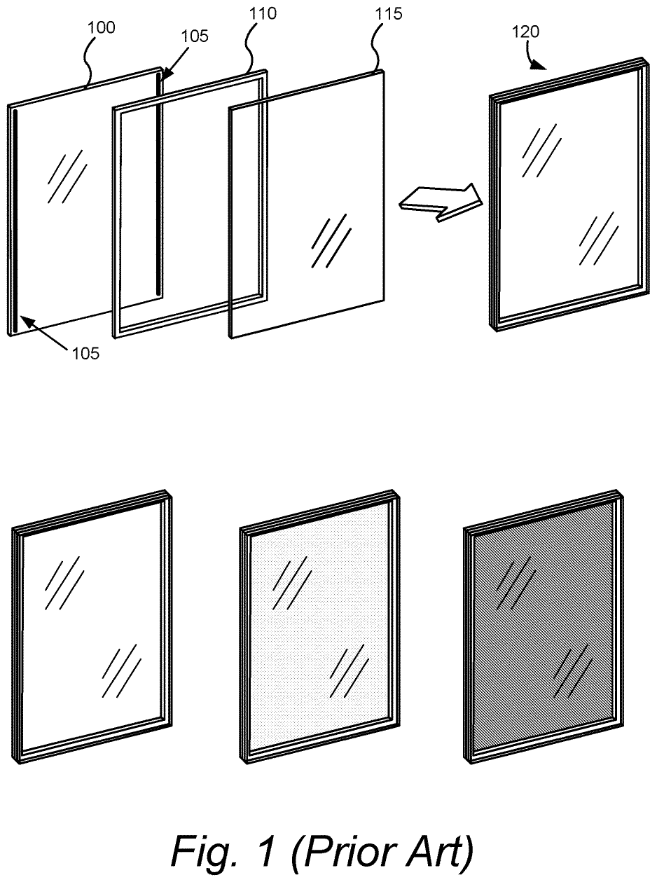

FIG. 1 depicts fabrication of an IGU, 120, with an EC lite, 100, which includes a monolithic EC device and associated pair of bus bars, 105, which energize the device each via a transparent conductor, the pair of transparent conductors sandwich the EC materials between them so that a potential can be applied across the device materials. The IGU is fabricated by combining EC lite 100 with a spacer, 110, and a mate lite, 115, along with the appropriate sealants and wiring (not shown) to the bus bars. In some applications, a second set of spacer and mate lite may be added (i.e. Triple Pane IGU). The two mate lites may be of different types. As depicted on the bottom half of FIG. 1, the IGU can be transparent (left), tinted to an intermediate state (middle) or fully tinted (right). However, there is no possibility of tinting the viewable area of the lite in different areas or “zones.” Conventional technology does exist to achieve this end, however.

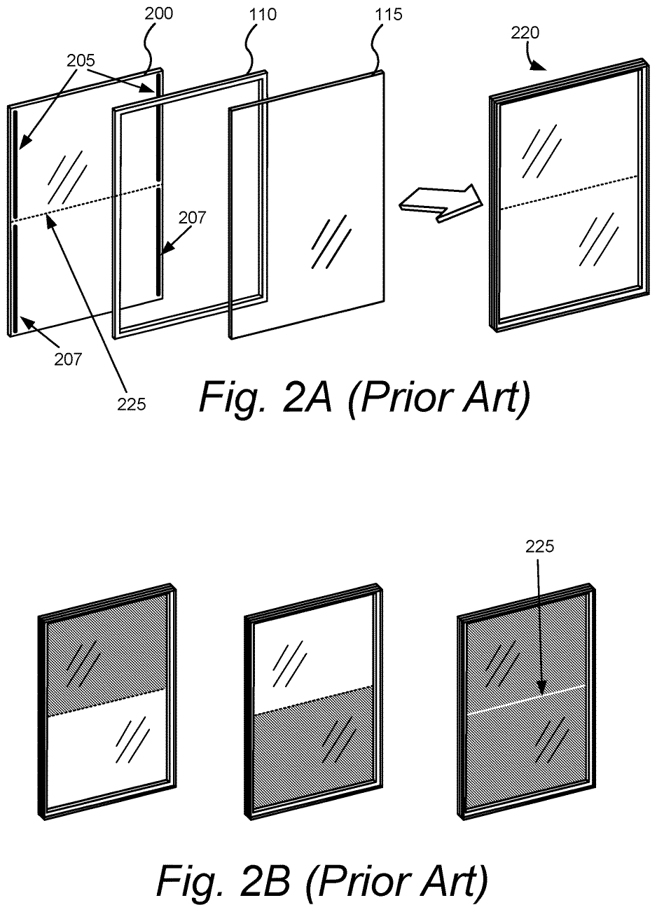

FIG. 2A depicts an IGU, 220, having an EC lite, 200, with two tinting zones delineated by laser scribe, 225. Each tinting zone has an associated pair of bus bars, 205 and 207, respectively. The EC lite 200 may be incorporated into an IGU, 220, as described in relation to FIG. 1. Scribe line 225 cuts through both of the transparent conductor layers which sandwich the electrochromic materials, along with the EC device layer(s), so that there effectively two EC devices, one corresponding to each tinting zone, on the EC lite 200. Scribe line 225 may not be visually discernible when the EC lite is not tinted, as depicted in FIG. 2A, i.e. in the untinted state (bleached or neutral state).

FIG. 2B depicts three possible tinting schemes of IGU 220. As shown, IGU 220 may have the top zone tinted and the bottom zone untinted (left), the top zone untinted and the bottom zone tinted (middle) or both the top and bottom zones tinted (right). Although such windows offer flexibility in tinting, when both zones are tinted, scribe line 225 is visually discernible and is unattractive to an end user because there is a bright line across the middle of the viewable area of the window. This is because the EC material in the area has been destroyed and/or deactivated from the scribe line that cut through the device. The bright line can be quite distracting; either when one is looking at the window itself, or as in most cases, when the end user is trying to view things through the window. The bright line against a tinted background catches one's eye immediately. Many approaches have been taken to create tinting zones in optical devices, but they all involve some sort of physical segmentation of a monolithic optical device into two or more individually operable devices. That is, the functionality of the EC device is destroyed along the scribe line, thus effectively creating two devices from a monolithic single device. Certain embodiments described herein avoid destroying the EC device function between adjacent tinting zones.

One approach to overcoming the visually distracting bright line created by a laser scribe in the viewable area of an EC lite is to apply a tinted material to the lite, e.g. on the scribe line or on an opposing side of the lite, in order to obscure or minimize the light passing through the scribe area. Thus, when tinting zones adjoining the scribe are tinted, the scribe line will be less discernible to the end user. When neither of the adjoining tinting zones is tinted, the tinted material in the scribe line area will be almost or completely indiscernible because it is a thin tinted line against a large untinted background, which is harder to see than a bright line against a tinted background. The thin tinted line need not be opaque, a limited amount of absorption of the visible spectrum can be used, e.g., absorption that will tone down the bright line created when the full spectrum emanates through scribe line 225. Methods for obscuring pinhole defects in optical devices are described in, for example, described in U.S. Provisional Patent Application Ser. No. 61/610,241, filed Mar. 13, 2012, and described in PCT Application Serial No. PCT/US2013/031098 filed on Mar. 13, 2013, which are both hereby incorporated by reference in their entirety. Whether obscuring pin holes, scribe lines, edge lines, or the like, the methods obscure bright areas on EC devices, e.g. by applying tinted material to such areas to make them harder to see to the end user. Edge lines exist where a coating such as a monolithic electrochromic coating, does not extend to the spacer of an IGU (e.g., element 110 of FIG. 2A). In this region, a bright line or wider area is visible when viewing the IGU directly. As understood by those of skill in the art, the obscuring methods described in the present application and in PCT/US2013/031098 have equal applicability to pin holes, edge lines, scribe lines, and the like. The methods described in the aforementioned patent application are particularly useful for obscuring scribe or edge lines in the visible area of an optical device such as an EC device. One embodiment is a method of obscuring a scribe line in the viewable area of an EC window, the method including applying a method used to obscure pinholes as described in the aforementioned US/PCT Patent application. For example, one method includes applying a tinted material to the scribe line and optionally the area adjacent the scribe line. In another example, the glass at the bottom of the scribe line trench (and optionally some adjoining area) is altered so as to diffuse light that passes therethrough, thus ameliorating the “bright line” effect.

### Tinting Zones

As discussed above, certain embodiments described herein avoid destroying the EC device functionality between adjacent tinting zones. Though scribe lines may be visually obscured by application of tinted materials to the lite as described above, the inventors have found that it may be often preferable to maintain the functional integrity of a monolithic EC device, rather than scribe it into discrete devices and thus conventional tinting zones. The inventors have discovered that tinting zones may be created by: 1) configuring the powering mechanism (e.g. bus bars, wiring thereto and associated powering algorithms) of the optical device appropriately, 2) configuring the EC device such that adjacent tinting zones are separated by a resistive zone, or 3) combination of 1) and 2). For example, number 1) may be achieved by appropriately configuring one or more bus bars such that they can be activated independently of other bus bars on the same monolithic EC device. Thus tinting zones are created without the need to physically separate individual EC devices to create corresponding tinting zones. In another example, a resistive zone allows coloration and bleaching of adjacent tinting zones on a single EC device without destroying functionality in the resistive zone itself. A resistive zone can refer to an area of the monolithic optical device, e.g. an EC device, where the function is impaired but not destroyed. Typically, the functionality in the resistive zone is merely slowed relative to the rest of the device. Impairment might include diminished capacity for ion movement in one or more of the layers of the EC device and/or reduced density of the ions. The change in EC stack properties and/or ion density maybe done during deposition/fabrication of the EC stack or post-deposition through a thermal/laser irradiation treatment. For example, one or more EC device layers may be made denser than it otherwise would be in the bulk functioning device and therefore be able to hold fewer ions and/or allow ion passage through the denser material, and therefore color less intensely than the bulk device, but still function. A resistive zone is achieved in at least one of the following ways: i) the electrical resistivity of one or both of the transparent conductor layers is impaired, ii) one or both of the transparent conductor layers is cut, without cutting through the optical device stack therebetween, iii) the function of the optical device stack (not including the transparent conductor layers) is impaired, and iv) combinations of i)-iv). For example, a resistive zone may be created where one or both of the transparent conductor layers is fabricated thinner or absent, e.g. along a linear region, so as to increase electrical resistivity along the linear region of the resistive zone. In another example, one of the transparent conductor layers may be cut along the width of the device, while the other transparent conductor is left intact, either of uniform thickness or thinner, along the resistive zone. In yet another example, the function of the EC device may be inhibited along a line, so that it resists ion transport, while the transparent conductor layers may or may not be altered along the same line. Resistive zones are described in more detail below in terms of specific, but non-limiting examples. If the resistive zone is in one of the transparent layers, the other transparent layer may be left intact (e.g., uniform composition and thickness).

### Configuring Powering Mechanism of EC Devices

One embodiment is an electrochromic window lite including a monolithic EC device on a transparent substrate, the monolithic EC device including two or more tinting zones, each of the two or more tinting zones configured for operation independent of the others and having an associated pair of bus bars. In certain embodiments, the two or more tinting zones are not separated from each other by isolation scribes; that is, the EC device and associated transparent conductors do not have isolation scribes that cut through any of these layers. For example, there may be two tinting zones on the EC lite and two pairs of bus bars, wherein each pair is associated with a tinting zone and both pairs are located at or near opposing edges of the EC lite e.g., the bus bars may be vertically oriented at or near opposing vertical edges with a set of bus bars for each of the two tinting zones. Such lites may be integrated into insulating glass units (IGUs).

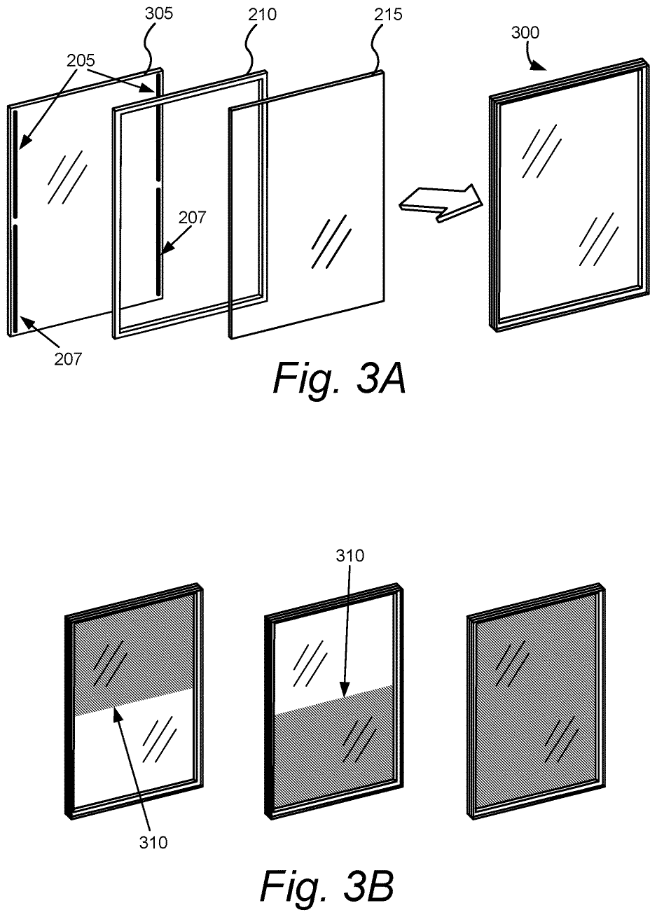

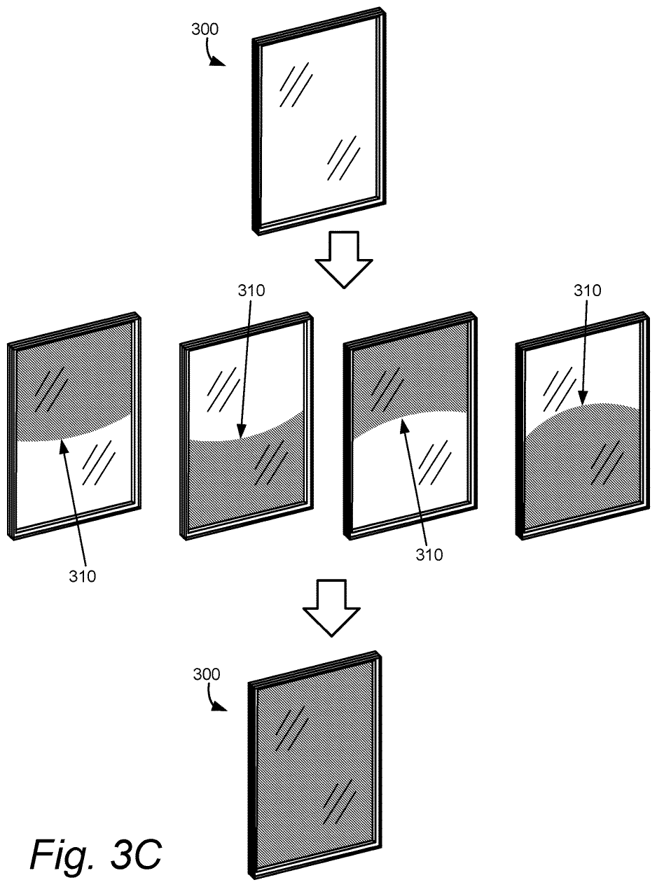

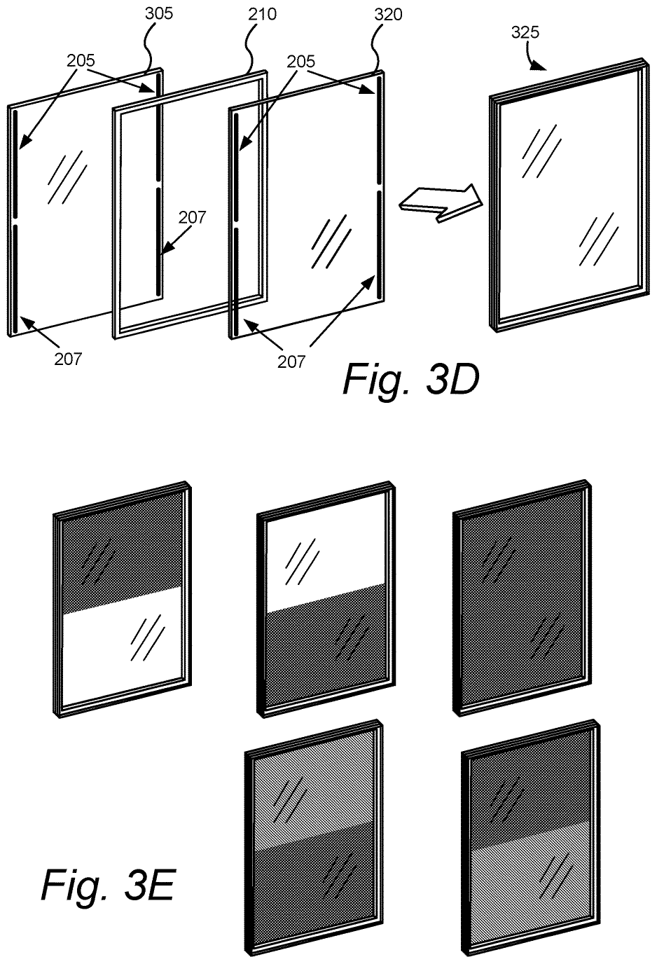

FIG. 3A depicts fabrication of an IGU, 300, with an EC lite, 305 having two tinting zones (upper and lower tinting zones) configured on a monolithic EC device. In this example, there are no laser scribes or other physical sectioning (e.g. bifurcation) of the monolithic EC device or transparent conductor layers on the lite. Each of bus bar pairs, 205 and 207, is configured to energize independently of each other. Thus, referring to FIG. 3B, IGU 300 has three tinting schemes besides the untinted state (bleached or neutral state) depicted in FIG. 3A.

FIG. 3B shows these three tinting schemes where the top zone may be tinted while the bottom zone is not (left), the bottom zone may be tinted while the top zone is not (middle), or both zones may be tinted (right). In contrast to an EC lite having two distinct EC devices by virtue of being divided by a scribe line, each tinting zone of lite 305, when tinted, has a “tinting front” 310 (also referred to herein as a “tint front”). A tinting front can refer to an area of the EC device where the potential applied across the devices TCOs by the bus bars reaches a level that is insufficient to tint the device (e.g. by movement of ions through the layers of the device to balance charge). Thus, in the example depicted, the tinting front 310 corresponds roughly to where the charge is bleeding off into the area of the transparent conductor that is between the pair of bus bars that are not energized.

The shape of a tinting front may depend upon the charging characteristics of the transparent conductors, the configuration of the bus bars, wiring and powering thereto, and the like. The tinting front may be linear, curved (convex, concave, etc.), zigzag, irregular, etc. For example, FIG. 3B depicts the tinting front 310 as a linear phenomenon; that is, the tinting front 310 is depicted as located along a straight line. As another example, FIG. 3C depicts various tinting schemes as a function of tinting front of each of the tinting zones, in this case lower and upper tinting zones. In the illustrated example, the tinting front is curved (e.g., concave or convex) along the tinting front. In certain embodiments, it may be desirable that when both tinting zones are tinted, the tinting of the EC lite is total and uniform. Thus a convex tinting front may be desirable, so a complimentary concave tinting front may be used in an adjacent zone, or another convex tinting front may be used to ensure sufficient charge reaches the entire device for uniform tinting. In certain cases, the tinting front may not be a clean line as depicted in FIGS. 3B and 3C, but rather have a diffuse appearance along the tinting front due to the charge bleeding off into the adjacent tinting zone which is not powered at the time.

In the case where two adjacent zones are tinted, but one zone's tinting level is different than the other, e.g., where one zone is tinted to 5% T and the other adjacent zone tinted to 20% T, there may be no noticeable tinting front. That is, the two zones' tinting may blends into each other for a uniform gradient tinting appearance, e.g. resembling a shading effect, where the coloration is darkest in one zone and appears to gradually lighten into and including the adjacent zone. In the event that individual tinting zones on a monolithic EC device have aesthetically unappealing coloration fronts, one may apply tinting voltages to all zones, but where the tinting voltages to individual zones are the same or different. One embodiment is a method of controlling a monolithic EC device coating, including tinting two adjacent zones simultaneously by virtue of selective application of voltage to different areas of the monolithic EC device.

In certain embodiments, when the EC lite with tinting zones is incorporated into an IGU or a laminate for example, the mate lite may also be an EC lite, having tinting zones or not. Insulated glass unit constructions having two or more (monolithic) EC lites are described in U.S. Pat. No. 8,270,059, which is hereby incorporated by reference in its entirety. Having two EC lites in a single IGU has advantages including the ability to make a near opaque window (e.g. privacy glass), where the percent transmission (% T) of the IGU is <1%. Also, if the EC lites are two-state (tinted or bleached) there may be certain tinting combinations made possible, e.g. a four-tint-state window. If the EC lites are capable of intermediate states, the tinting possibilities may be virtually endless. One embodiment is an IGU having a first EC lite having two or more tinting zones and a mate lite that is a monolithic EC lite. In another embodiment, the mate lite also has two or more tinting zones. In this latter embodiment, the tinting zones may or may not be the same in number or aligned with the tinting zones of the first EC lite with which it is registered in the IGU. Exemplary constructs illustrating these descriptions follow.

FIG. 3D depicts fabrication of an IGU, 325, having two EC lites, 305 and 320, where each of the EC lites has two tinting zones, each of the tinting zones created by appropriately configured bus bar pairs, 205 and 207 at or near two opposing edges. In this illustrated example, the tinting zones of EC lites 305 and 320 are registered, that is, they are aligned with each other and of the same area, but this need not be the configuration. For example, the tinting fronts from opposing EC lites 305 and 320 could overlap each other when tinted in another embodiment. FIG. 3D depicts IGU 325 in an untinted state (bleached or neutral state). Also, each of the tinting zones is capable of only two states, tinted or bleached. Even so, this enables a wide range of tinting schemes for IGU 325. Besides the untinted state, IGU 325 is capable of many tint states (e.g., eight tint states). FIG. 3B depicts three of the possible tint states (i.e. where one EC lite of IGU 325 is tinted in one of the three configurations shown in FIG. 3B). FIG. 3E depicts another five possible tint states for IGU 325. If the top tinting zones of both EC lites are tinted simultaneously, and the bottom two zones are not, then the top half of the IGU is very dark, while the bottom is untinted (top left IGU). If both of the top tinting zones are not tinted, and the bottom two zones are tinted, then the bottom half of the IGU is very dark, while the top is untinted (top middle IGU). If all four zones of the EC lites are tinted, then the entire window is very dark (top right IGU). For example, the combined tinting of all tinting zones in two registered EC lites can achieve <1% T. If one of the top zones in the EC lites is tinted and both of the bottom zones are tinted, then the tint state on the bottom left of FIG. 3E is created. Likewise, if one of the bottom zones is tinted and both of the top zones are tinted, then the tint state on the bottom right of FIG. 3E is created.

One embodiment is an IGU having two or more EC lites, wherein at least two of the two or more EC lites includes multiple tinting zones as described herein. The tinting zones may be formed physically in the coating, i.e. by bifurcation of a monolithic coating, forming a resistive zone in a monolithic EC coating, or both; or a monolithic coating with no resistive zones may be controlled by selective application of voltages to different areas to form tinting zones. One embodiment is an IGU or laminate having two or more EC lites, where a first of the two or more EC lites includes multiple tinting zones created by conventional isolation scribes, and a second of the two or more EC lites includes tinting zones as described herein by techniques other than isolation scribes. One embodiment is an IGU or laminate having two or more EC lites, where a first of the two or more EC lites includes multiple tinting zones, and a second of the two or more EC lites includes a monolithic EC coating without tinting zones.

Configurations such as those depicted in FIGS. 3B and 3E may be particularly useful in applications such as creating day lighting zones vs. occupant (glare) control zones. The day lighting zones may also be tinted but at lower tint level than the glare control zones for the optimal user experience, e.g. day lighting zones may be tinted to % Tvis˜4%-30% while the glare control zones may be tinted to % Tvis˜0.1-1%. Day lighting transoms are very common. For example, creating “virtual transoms” with a piece of glass and thus removing the frame and associated glazier labor has a cost benefit as well as better sight lines. Also, having a variety of tint states such as those depicted in FIGS. 3B and 3E allows for customization of room lighting based on the amount and location of the sun striking individual windows.

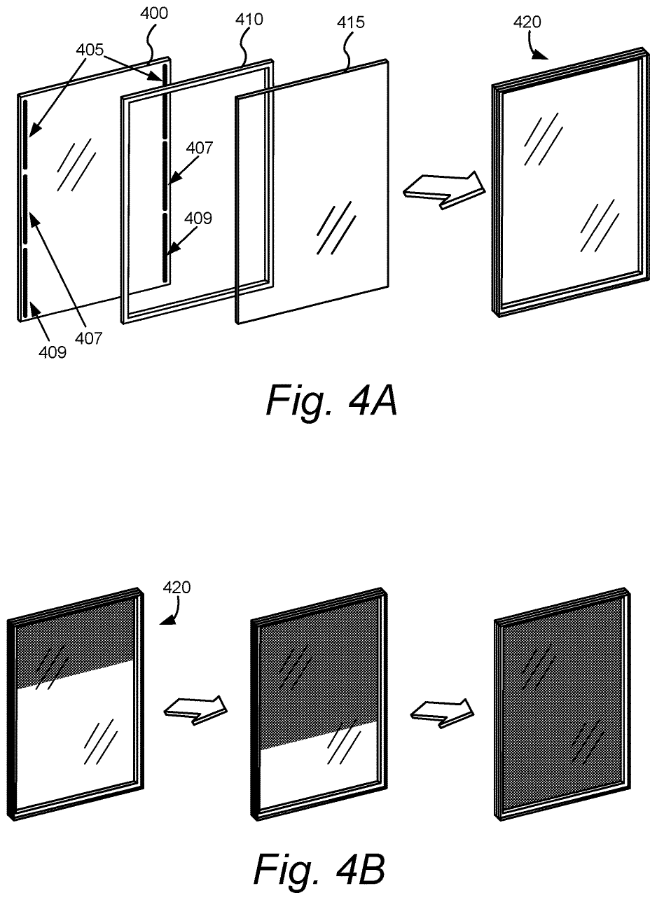

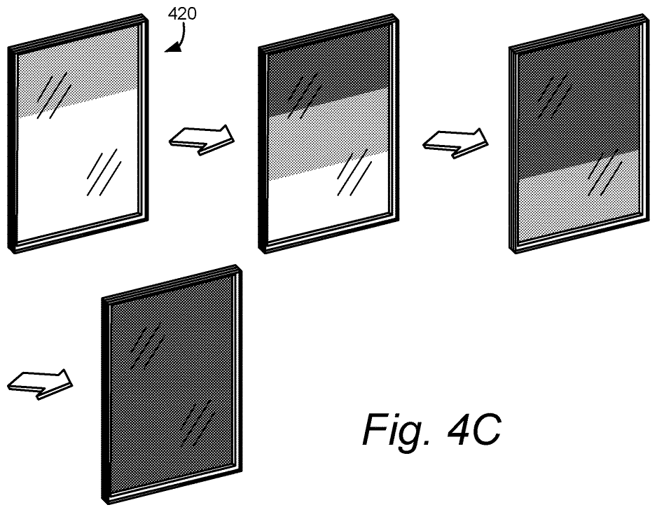

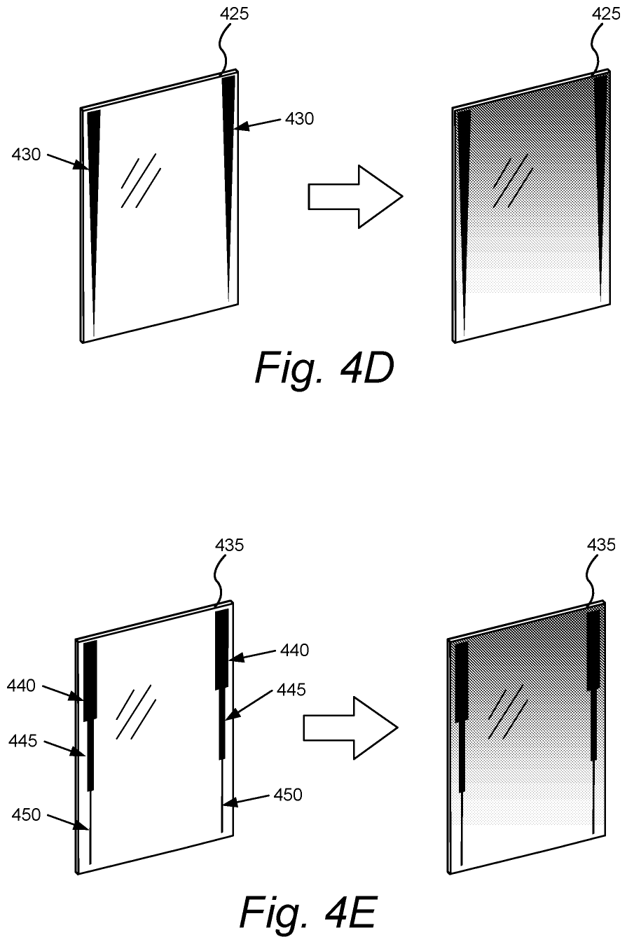

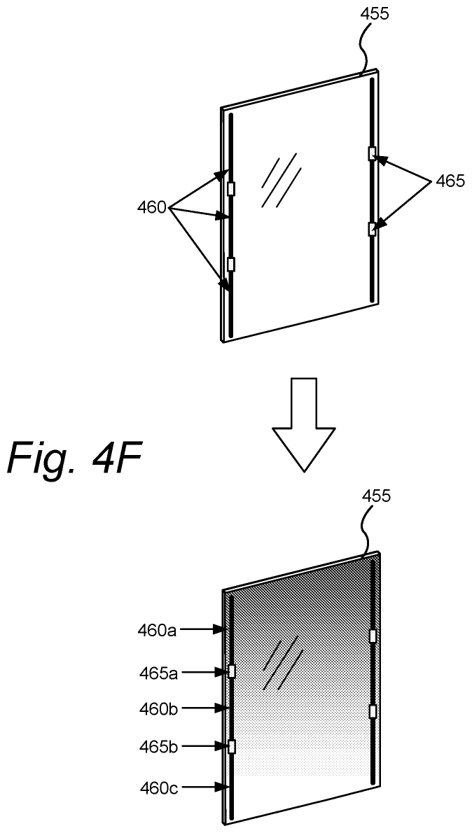

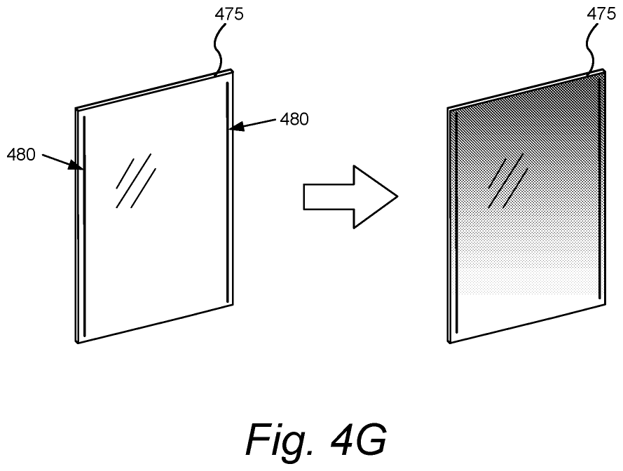

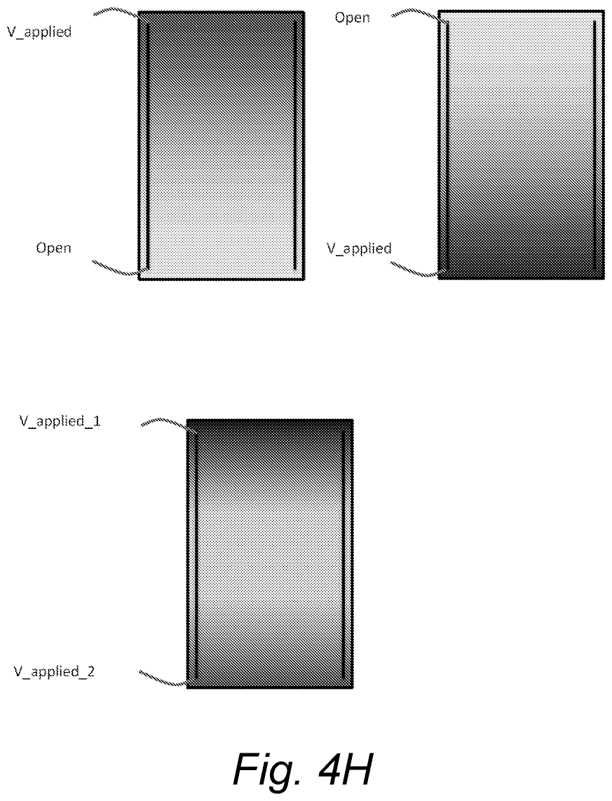

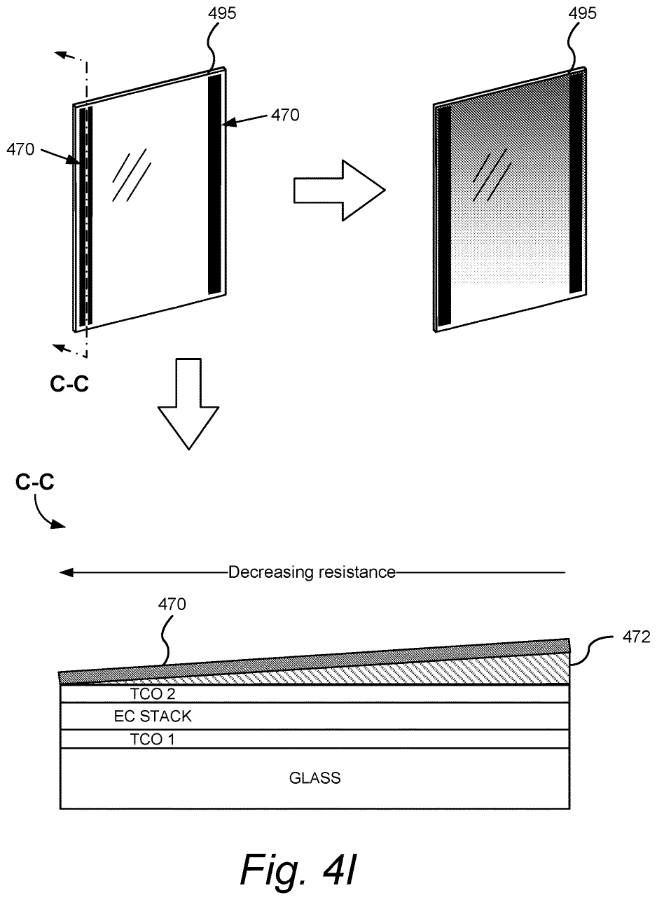

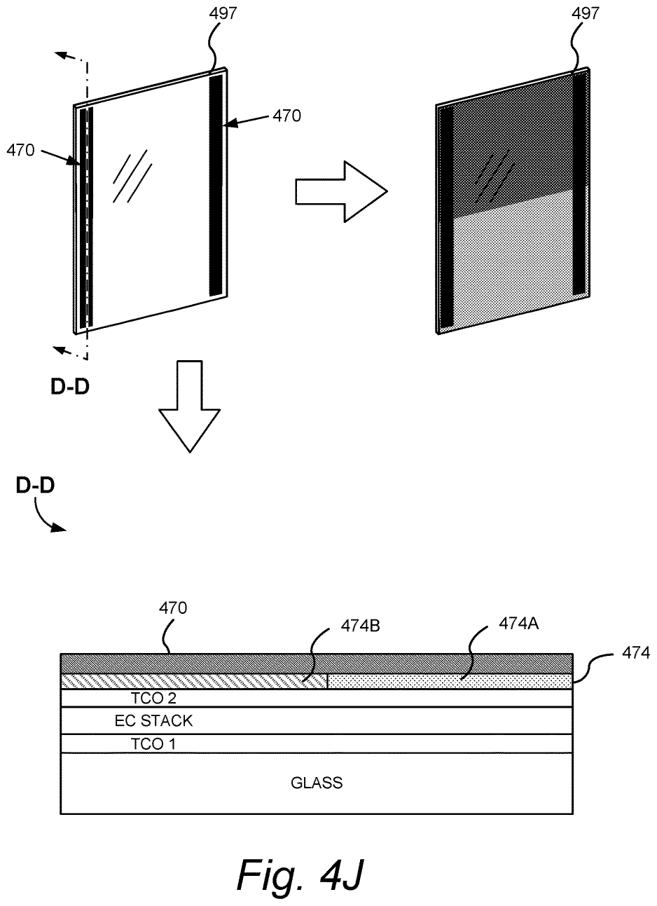

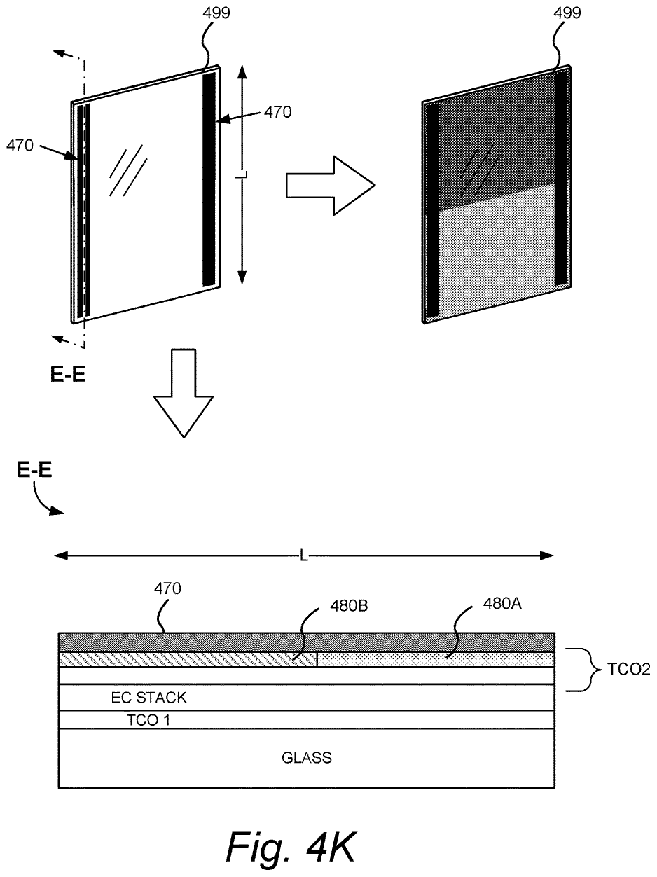

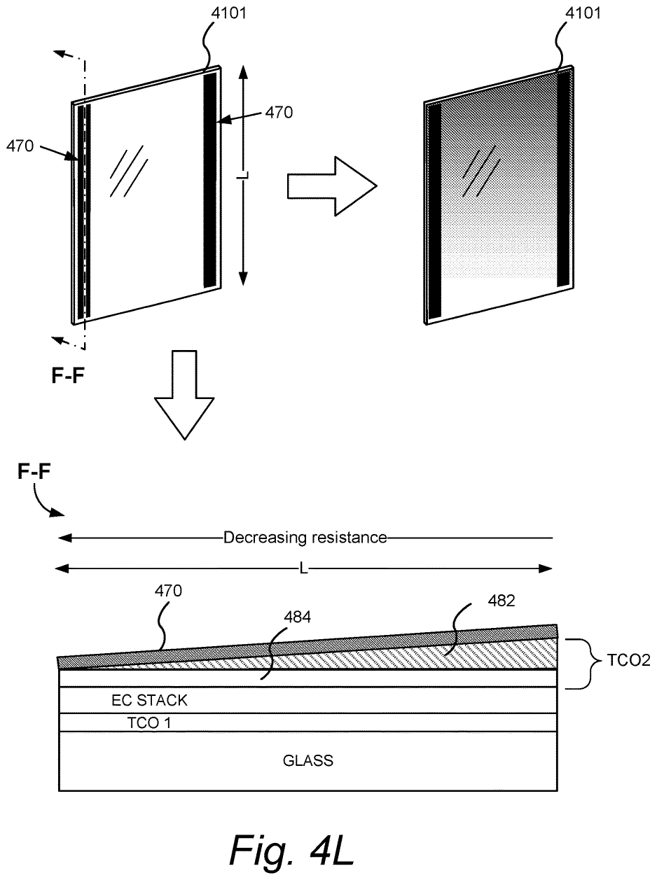

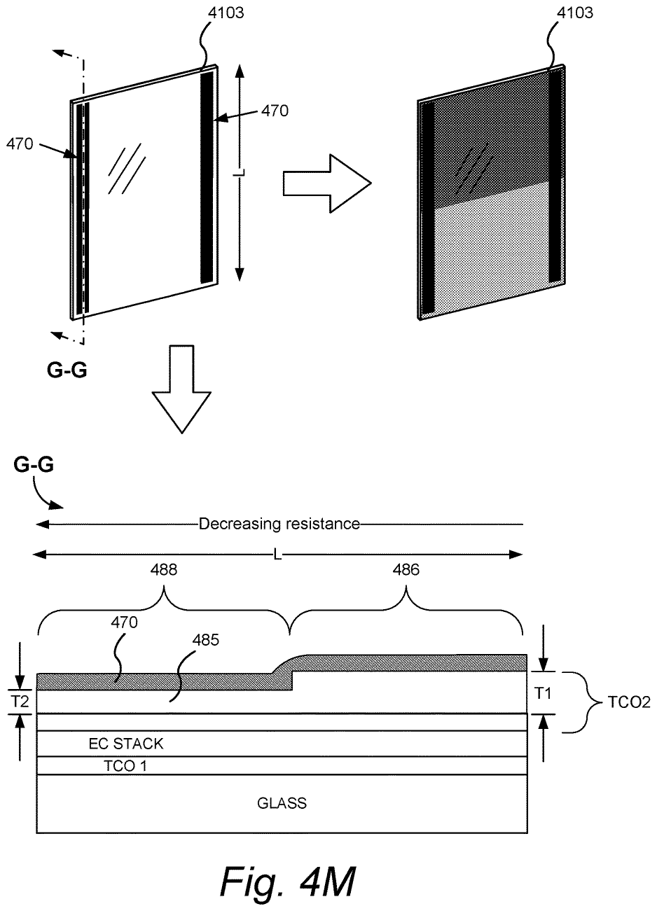

Certain embodiments pertain to methods of transitioning an EC lite having two or more tinting zones. In one embodiment, an EC lite having three or more tinting zones is transitioned across the three or more tinted zones from a first zone at one edge of the device, to a second adjacent tinting zone, and then to a third tinting zone, adjacent to the second zone. In other words, the tinting zones are used to give the effect of drawing a physical shade across the window, without actually having a physical shade, since EC windows may eliminate the need for physical shades. Such methods may be implemented with conventional zoned EC lites or those described herein. This is illustrated in FIGS. 4A-C with respect to an EC lite of an embodiment.

Referring to FIG. 4A, an EC lite, 400, is configured with a first set of bus bars, 405, a second set of bus bars 407, and a third set of bus bars, 409. The three sets of bus bars are configured so as to create three tinting zones, respectively. Although EC lite 400 in FIG. 4A is incorporated into an IGU, 420, using a spacer 410 and a mate lite 415, lamination to a mate lite (EC lite or otherwise) or use as a single EC lite is also possible.

Referring to FIG. 4B, assuming that each of the tinting zones is tinted as a two-state zone, then the three tinting zones may be activated sequentially, e.g. from top to bottom as depicted, to create a physical shade effect, i.e. as if one were lowering a roller shade or drawing a Roman shade over the window. For example, the top zone may be fully tinted, then the second zone may be fully tinted, finally the third zone may be fully tinted. The tinting zones could be sequentially tinted from the bottom up or in the middle and then the upper and lower zones tinted, depending upon the desired effect.

Another method is to tint the tinting zones as described with respect to FIG. 4B, except that before transition in a particular tinting zone is complete, transition in an adjacent tinting zone begins, which can also create a shading effect. In the illustrated example of FIG. 4C, the top tinting zone's tinting is initiated (top left), but before tinting is complete in the top zone, the middle zone's tinting is initiated. Once the top zone's tinting is complete, the middle zone's tinting is not yet complete (top center). At some point during the transition of the middle zone, the bottom zone's tinting is initiated. Once the middle zone's tinting is complete, the bottom zone's tinting is not yet complete (top right), thus the top and middle zones are fully tinted and the bottom zone's tinting is yet to be completed. Finally, the bottom zone is fully tinted. Using tinting zones with intermediate state capability, rather than two-state “tint or not,” will increase the possible variations of tinting schemes.

### Lengthwise Variable Bus Bars

In certain embodiments, an EC lite may be configured to have one or more tint gradient zones. In these embodiments, the EC lite has an EC device, such as, e.g., a monolithic EC device on a transparent substrate, and also has at least one pair of bus bars with geometry and/or material composition that varies along their lengths to vary electrical resistance lengthwise (lengthwise variable bus bars). This variation in resistance can produce a lengthwise gradient in the voltage applied to the EC device supplied across bus bars (Vₐₚₚ) and a lengthwise gradient in the local effective voltage (V_{eff}) in the EC device. The term V_{eff} refers to the potential between the positive and negative transparent conducting layers at any particular location on the EC device. The lengthwise gradient of the V_{eff} may generate a corresponding tint gradient zone that varies lengthwise in a region between the pair of bus bars when energized. In these embodiments, the lengthwise variable bus bars will have resistance profiles along their lengths that are functions of both the local bus bar geometry and resistivity. In certain embodiments, the bus bars are designed so that the resistance is lowest at one end of the bus bar and highest at the other end of the bus bar. Other designs are possible, such as designs where the resistance is lowest in the middle of a bus bar and highest at the ends of the bus bar. A description of voltage profiles in various EC devices powered by bus bars can be found in U.S. patent application Ser. No. 13/682,618, titled “DRIVING THIN FILM SWITCHABLE OPTICAL DEVICES,” filed on Nov. 20, 2013, which is hereby incorporated by reference in its entirety.

EC devices configured, e.g., as described in relation to FIGS. 4D and 4E, in addition to being capable of tinting in a gradient fashion as depicted, may also, e.g. upon application of sufficient voltage, tint to a uniform coloration. For example, a maximum (and uniform) tinting may be achieved across the monolithic device coating by application of sufficient voltage using bus bars also configured to apply a gradient voltage (and give the gradient tinting shown).

The local material composition of a bus bar may determine its local resistivity. It is contemplated that the bus bar material composition, and therefore the bus bar resistivity may vary along the length of the bus bar in certain embodiments. The resistivity can be tailored based on various compositional adjustments known to those of skill in the art. For example, resistivity can be adjusted by adjusting the concentration of a conductive material in the bus bar composition. In some embodiments, bus bars are made from a conductive ink such as a silver ink. By varying the concentration of silver in the ink along the length of the bus bar, one can produce a bus bar in which the resistivity likewise varies along the length. The resistivity can also be varied by other compositional adjustments such as the local inclusion of resistive materials in the bus bar or the variation of the composition of a conductive component to adjust its resistivity. Slight variations in composition can change the resistivity of certain conductive materials such as conductive polymers. In certain embodiments, the electrical conductivity of the bus bar material is constant, but the thickness and/or width of the bus bar varies along its length.

The value of the voltage that can be applied at any position on the bus bar is a function of the location where the bus bar connects to an external power source and the resistance profile of the bus bar. A bus bar may be connected to the source of electrical power at locations where the bus bar has least resistance, although this is not required. The value of the voltage will be greatest at the locations where the power source connection attaches to the bus bars. The decrease in voltage away from the connection is determined by the distance from the connection and the resistance profile of the bus bars along the path from the connection to the point where voltage is measured. Typically, the value of voltage in a bus bar will be greatest at the location where an electrical connection to the power source attaches and least at the distal point of the bus bar. In various embodiments, a bus bar will have lower electrical resistance at an end proximal to the connection to the electrical source and a higher resistance at a distal end (i.e. the resistance is higher at the distal end than at the proximal end).

Each of the lengthwise variable bus bars may have linearly, stepped, or otherwise varying geometry and/or material composition along its length. For example, a bus bar with lengthwise-varying geometry may have its width, height, and/or other cross-sectional dimension linearly tapering from the proximal end to the distal end. As another example, a bus bar may be comprised of multiple segments with stepwise decreasing widths or other dimensions from the proximal end to the distal end. In yet another example, a bus bar may have a material composition that varies lengthwise to increase electrical resistivity between proximal and distal ends.

FIGS. 4D and 4E depict EC lites, 425 and 435 respectively, each having a monolithic EC device on a transparent substrate and a pair of bus bars. The width of each of the bus bars varies along its length. This geometric lengthwise variation in the bus bars may produce a tint gradient zone (gradient in lengthwise direction) on the monolithic EC device when energized.

FIG. 4D depicts an EC lite, 425, including bus bars 430. Each of the bus bars 430 has a varying width along its length that linearly tapers lengthwise. In certain embodiments, the variation in width between the two ends may be between about 10% and about 100% from the average width over the length of the bus bar. In one embodiment, the variation in width may be between about 10% and about 80% from the average width over the length of the bus bar. In another embodiment, the variation in width may be between about 25% and about 75% from the average width over the length of the bus bar. In this example, not drawn to scale, the bus bars 430 are widest at the top of EC lite 425 and linearly taper lengthwise to their thinnest width near the bottom of lite 425. Because of the varying width, bus bars 430, when energized, establish a voltage gradient. For example, when energized, bus bars 430 have their highest effective voltage at the top, and their lowest voltage at their bottom portion; a voltage gradient is established along the bus bars. As depicted in the right portion of FIG. 4D, a corresponding tinting gradient is established by virtue of the voltage gradient. Thus a tint gradient zone is established. Bus bars of varying width can be used in one or more zones of an EC lite having two or more zones as described herein. In this illustrated example, a single tint gradient zone is established across an EC lite. Although a linearly tapered width is illustrated in FIG. 4D, a non-linearly tapered width can be used in other cases.

In certain embodiments, the tapering of the bus bars need not be a smooth taper. For example, a bus bar may have a stepped down width along its length (i.e. stepwise width variation along its length). FIG. 4E depicts an EC lite, 435, having a monolithic EC device and bus bars that have stepped widths along their lengths. Each bus bar has three segments with stepped down widths along its length. Each bus bar has a first width that spans a first portion, 440, of the length of the bus bar. Adjacent to the first portion, is a second portion, 445, of the length of each bus bar. The second portion has a second width shorter than the first width. Finally, adjacent to the second portion and having a third width, is a third portion, 450 of each bus bar. The net tinting gradient effect may be the same as or similar to the smooth linearly taper bus bars described in relation to FIG. 4D. One of ordinary skill in the art would appreciate that varying the width of the bus bars can be done in other patterns, such as thicker in the middle than at the ends, etc. without escaping the scope of embodiments described herein, that is for an EC lite having bus bars of varying widths configured to create one or more tint gradient zones, and corresponding tinting effects, on a monolithic EC device.

### Electrically Resistive Bus Bars

In certain embodiments, a bus bar with uniform cross-section and electrical conductivity characteristics is used to create the required electrical gradient from one end of the bus bar to the other end. This is achieved by taking advantage of voltage drop along a bus bar. That is, a bus bar of sufficient resistivity, e.g. a sufficiently thin bus bar of highly conductive material or a bus bar made of more resistive, though still conductive material, such that there is a voltage drop along the bus bar's length when voltage is applied to one end. It can be shown that:

ΔV_{L}=(R_{B}*J*W₀*L)²/2 where:
ΔV_{L} is voltage drop along Bus bar at a distance L from point of application of power
R_{B} is the resistance per unit length of the Bus bar
J is the leakage current density of the EC window
W₀ is the width of the EC window
   Thus, for a window where the bus bar is powered at one end only, if:

RB>(ΔV/L₀)*(2/I_{EC}) where:
ΔV is the required voltage drop along the bus bar
I_{EC} is the net current draw for the EC device
L₀ is the length of the EC window

Then the electrically resistive bus bar will act as a resistance path in the circuit and be able to provide adequate drop in voltage along its length. Since the Transmission of the EC window is proportional to the V_eff, and the drop in the voltage along the Bus bar (ΔV) reduces the V_eff as described previously, the (ΔV/L₀) terms represents the gradient of the shading/Tvis from one end to the other, e.g. a small part (small L₀) with a large voltage drop along the bus bar from end to the other will have a very pronounced Tvis shading/gradient, while for a large part will need a larger voltage drop along the bus bar to maintain the same shading along its length. Thus, the bus bar properties, e.g. height, width, material, though having a uniform cross section, can be selected during fabrication to provide the required shading from one end to the other. This enables ease of design/manufacturing to avoid complex-geometry bus bars, while still providing a gradient in the optical properties across the window. For example, one can fabricate a thin bus bar that has a voltage drop across its length to create a gradient shading.

### Variable Contact Resistance Between a Bus Bar and TCO Layer

In certain embodiments, the resistance between a bus bar and a transparent conductive oxide (TCO) layer may be varied along at least a part of the bus bar length to create the required electrical gradient applied to the TCO layer by the bus bar. This may be considered variable bus bar contact resistance, including lengthwise variable bus bar contact resistance that varies along some or all of the length of the bus bar, and/or variable resistance between the bus bar and TCO layer. In some embodiments, the bus bar may have a uniform, or substantially uniform (e.g., within 10% of uniform due to manufacturing inconsistencies or tolerances, for example), cross-sectional area and the variable resistance between the bus bar and TCO layer to which it is applied creates a voltage gradient on the TCO layer and resulting tint gradient.

The variable resistance between a bus bar and a TCO layer on which it is positioned may be created in various ways. In some embodiments, one or more layers of material may be positioned between the bus bar and the corresponding TCO layer and the one or more layers of material may provide electrical resistance between the bus bar and corresponding TCO layer. The one or more layers of material may have variable resistance along their length that is caused by them having a variable cross-sectional area along its length, a variable material configuration along their length, or both. For example, the one or more layers of material may have a non-uniform cross-sectional area along their length such as a cross-sectional area that is tapered, stepped, sloped, linearly sloped, and/or angled with linear and/or not linear sections. In another example, the one or more layers of material may have a uniform cross-sectional area and at least two lengthwise sections that have different resistances. In some implementations, additionally or alternatively, the resistance of some portion of the TCO layer on which the bus bar is positioned may have variable resistance along a linear section of at least some portion of the bus bar. As provided herein, these “one or more layers of material” may be collectively referred to as an “insulating layer of material” and/or and “insulating layer.”

Accordingly, in some embodiments, an electrochromic window lite may be provided that includes a transparent substrate, a monolithic electrochromic device disposed on the transparent substrate and having a first transparent conductive oxide (“TCO”) layer, a second TCO layer opposite the first TCO layer, and an electrochromic stack between the first and second TCO layers, and a pair of bus bars disposed on the first TCO layer, such that one or both bus bars have a substantially uniform cross-sectional area along their length, and variable resistance exists between at least one bus bar and the first TCO layer.

FIG. 4I depicts an EC lite, 495, having a monolithic EC device and bus bars positioned thereon, and having variable resistance between the bus bars and the TCO layer to which they are applied. Here, the top left portion illustrates the EC lite 495 having two bus bars 470 (or one pair of bus bars) along the length of the EC lite and the variable resistance between these bus bars 470 and the TCO layer. When the bus bars 470 are energized, the configuration of the resistance between these bus bars 470 and the TCO layer to which they are applied produces a tint gradient on the EC lite as indicated in the upper right portion of the Figure. In some implementations, like in FIG. 4I, the bus bars 470 may have a uniform cross-sectional area along their length. The EC lite 495 is also configured to have variable resistance between the bus bars and the TCO layer to which they are applied by having an insulating layer of material positioned between the TCO layer and at least one bus bar. In the cross-sectional view C-C taken along the length of one bus bar 470, the glass, TCO 1 positioned thereon, an EC stack positioned in between TCO 1 and TCO 2, TCO 2, and bus bar 470 are shown.

Positioned in-between the bus bar 470 and the TCO 2 is one or more material layers of material 472 that provides electrical resistance between the bus bar and TCO 2. In this embodiment, the bus bar 470 may not be considered as being in direct contact with the TCO layer, TCO 2, because the bus bar 470 is positioned directly on the insulating layer of material 472 which are in direct contact with TCO 2. This insulating layer of material 472 may be, and act, as an electrical insulator or insulating layers that have an electrical resistance. The section of the one or more material layers of material 472 has a variable cross-sectional area along its length, illustrated as linearly sloped, that creates variable resistance between the bus bar 470 and the TCO 2 and results in a voltage gradient applied to the TCO 2 by the bus bar 470 when the bus bar 470 is energized. The resistance between the bus bar 470 and TCO 2 also decreases as the cross-sectional area of the one or more material layers of material 472 decreases as indicated by the arrow. In this example, the more resistance that exists between the bus bar 470 and TCO 2, the less the EC lite 495 can tint. Here, the right-side of the cross-section C-C may be considered the bottom of EC lite 495 depicted in the upper portions of FIG. 4I.

In some embodiments, the variable resistance between the bus bar and the TCO layer may be created, additionally or alternatively, by configuring the one or more material layers to have different material properties that create different resistances. FIG. 4J depicts an EC lite, 497, having a monolithic EC device and bus bars positioned thereon, and having variable resistance between the bus bars and the TCO layer to which they are applied. Here, the top left portion illustrates the EC lite 497 having two bus bars 470 (or one pair of bus bars) along the length of the EC lite and the variable resistance between these bus bars 470 and the TCO layer. When the bus bars 470 are energized, the configuration of the resistance between these bus bars 470 and the TCO layer to which they are applied produces a tint gradient on the EC lite as indicated in the upper right portion of the Figure. In some implementations, like in FIG. 4J, the bus bars 470 may have a uniform cross-sectional area along their length. The EC lite 497 is also configured to have variable resistance between the bus bars and the TCO layer to which they are applied by having the insulating layer of material positioned between the TCO layer and at least one bus bar. In the cross-sectional view D-D taken along the length of one bus bar 470, the glass, TCO 1 positioned thereon, an EC stack positioned in between TCO 1 and TCO 2, TCO 2, and bus bar 470 are shown.

Positioned in-between the bus bar 470 and the TCO 2 is one or more material layers of material 474 that provides electrical resistance between the bus bar and TCO 2. In this embodiment, the bus bar 470 may not be considered as being in direct contact with the TCO layer, TCO 2, because the bus bar 470 is positioned directly on the insulating layer of material 474 which is in direct contact with TCO 2. This insulating layer of material may be, and act, as an electrical insulator or insulating layers that has one or more electrical resistances. In the example of FIG. 4J, the overall one or more material layers of material 474 has a uniform cross-sectional area along its length and includes two sections having different resistances, with section 474A having a first resistance and section 474B having a second resistance different than the first resistance. These sections with different resistances create a variable resistance between the bus bar 470 and TCO 2, and results in at least two different voltages applied to the TCO 2 by the bus bar 470 and to different resulting tints in the EC lite 497. In this example, the more resistance that exists between the bus bar 470 and TCO 2, the less the EC lite 497 can tint. Here, the right-side of the cross-section D-D may be considered the bottom of EC lite 497 of the upper portions of FIG. 4J; as illustrated in the upper right section of the Figure, because the lower portion of EC lite 497 has more resistance between the bus bar 470 and TCO 2, there is less voltage applied to TCO 2, and thus less tinting, in this bottom region.

In some embodiments, the insulating layer of material 474 between the bus bar 470 and the TCO 2 may have more than two sections with different resistances, such as three sections, four sections, and any number of N sections that each have a corresponding resistance that may be different than one or more of the other sections. Additionally or alternatively, the insulating layer of material 474 in some embodiments may have variable resistance along all of its length and all of the bus bar length, while still having a relatively uniform cross-sectional area, thereby creating variable resistance between the TCO 2 and all of the length of the bus bar. In some other embodiments, the insulating layer of material 474 may have variable resistance along only a linear section that is less than the overall length of the bus bars. This may result in variable resistance between that one linear section of the bus bars and the TCO layer, and not in other areas of the bus bar, and further result in a voltage and tint gradient in only this section and a uniform tint along the remaining portion(s) of the bus bar.

Some implementations of the insulating layer of material 474 may be made of a plurality of layers positioned adjacent to each other end to end and that that each have a different resistance to an adjacent layer. For example, in FIG. 4J, section 474A may be one layer of material deposited or positioned on the TCO 2, and section 474B may be another layer of material deposited or positioned on the TCO 2 end to end with section 474A; these sections 474A and 474B have different resistances from each other.

In some implementations, additionally or alternatively, the insulating layer of material 474 may have sections that have been modified to change their resistance, such as by heating or otherwise changing the morphology or density of the insulating layer of material 474. For example, in FIG. 4J, the insulating layer of material 474 may have initially existed during manufacturing as a single section that is subsequently modified to have two or more sections with different resistances. For instance, section 474A may be a section with one material composition having a first resistance and section 474B may be a section with a modified material composition that changed its resistance to a second resistance different than the first resistance.

In some embodiments, alternatively or additionally to the above example, the TCO layer may be modified in order to create variable resistance between that TCO layer and the bus bar positioned thereon. FIG. 4K depicts an EC lite, 499, having a monolithic EC device and bus bars positioned thereon, and having variable resistance between the bus bars and the TCO layer to which they are applied. Here, the top left portion illustrates the EC lite 499 having two bus bars 470 (or one pair of bus bars) along the length of the EC lite. When the bus bars 470 are energized, the configuration of the resistance between these bus bars 470 and the TCO layer to which they are applied produces a tint gradient on the EC lite as indicated in the upper right portion of the Figure. In some implementations, like in FIG. 4K, the bus bars 470 may have a uniform cross-sectional area. The EC lite 499 is also configured to have variable resistance between the bus bars and the TCO layer to which they are applied by having variable resistance in the TCO layer, TCO 2, on which the bus bars 470 are positioned. In the cross-sectional view E-E taken along the length of one bus bar 470, the glass, TCO 1 positioned thereon, an EC stack positioned in between TCO 1 and TCO 2, TCO2, and bus bar 470 are shown.

Here in FIG. 4K, TCO 2 has been modified to provide variable resistance along its length L (and along the length of the bus bars as opposed to along its width) under the bus bar to provide variable electrical resistance to the bus bar 470. In some instances, like shown, the bus bar 470 be considered in direct contact with the TCO layer, TCO 2, and in some other embodiments, the bus bar may be indirectly positioned on TCO 2, such as on an adhesive layer with a uniform resistance. A first section 480A of TCO 2 has a first resistance and a second section 480B of TCO 2 has a second resistance different than the first resistance. In some implementations, like depicted in FIG. 4K, TCO 2 may have distinct sections with different resistances from each other. In some other embodiments, as illustrated in FIG. 4L and discussed below, a portion of TCO 2 may physically altered to have a sloped or steadily increasing or decreasing shape, such as linearly or non-linearly, for example. In FIG. 4K, these TCO 2 sections 480A and 480B with different resistances create a variable resistance between the bus bar 470 and the TCO 2, and result in at least two different voltages applied to TCO 2 by the bus bar 470 and thus different tinting in the EC lite 499. In this example, the more resistance that exists between the bus bar 470 and TCO 2, the less the EC lite 497 can tint. Here, the right-side of the cross-section E-E may be considered the bottom of the upper portions of FIG. 4K; as illustrated in the upper right section of the Figure, because the lower portion of EC lite 499 has more resistance between the bus bar 470 and TCO 2, there is less voltage applied to TCO 2, and thus less tinting, in this bottom region.

In some embodiments, the modified TCO 2 may have more than two sections with different resistances, such as three sections, four sections, and any number of N sections that each have a corresponding resistance that may be different than the other sections. Additionally or alternatively, some embodiments may have a TCO 2 with variable resistance along all of its length L and all of the bus bar length, thereby creating variable resistance between the TCO 2 and all of the length of the bus bar. In some other embodiments, the modified sections of the TCO 2 may only be along only a part of the TCO 2 that is less than the overall length of the bus bars. This may result in variable resistance between one section of the bus bars and the TCO layer, and further result in a voltage and tint gradient in only this section and a uniform tint along the remaining portion of the bus bar without variable resistance between the TCO layer and bus bar.

FIG. 4L depicts an EC lite, 4101, having a monolithic EC device and bus bars positioned thereon, and having variable resistance between the bus bars and the TCO layer to which they are applied. Here, the top left portion illustrates the EC lite 4101 having two bus bars 470 (or one pair of bus bars) along the length of the EC lite and the variable resistance between these bus bars 470 and the TCO layer. When the bus bars 470 are energized, the configuration of the resistance between these bus bars 470 and the TCO layer to which they are applied produces a tint gradient on the EC lite as indicated in the upper right portion of the Figure. In some implementations, like in FIG. 4L, the bus bars 470 may have a uniform cross-sectional area. The EC lite 4101 is also configured to have variable resistance between the bus bars and TCO layer to which they are applied by having variable resistance in the TCO layer, TCO 2, on which the bus bars 470 are positioned. In the cross-sectional view F-F taken along the length of one bus bar 470, the glass, TCO 1 positioned thereon, an EC stack positioned in between TCO 1 and TCO 2, TCO 2 and bus bar 470 are shown.

In FIG. 4L, TCO 2 has been modified to provide variable resistance along its length L (and along the length of the bus bars as opposed to along its width) under the bus bar to provide variable electrical resistance to the bus bar 470. In some instances, like shown, the bus bar 470 be considered in direct contact with the TCO layer, TCO 2, and in some other embodiments, the bus bar may be indirectly positioned on TCO 2, such as on an adhesive layer with a uniform resistance. In FIG. 4L, a top portion 482 of TCO 2 has been modified to provide variable resistance along the length L of the TCO 2 at a constant, or substantially constant, variance that may be defined, in some instances as a linear or substantially linear change along the length L of the TCO 2. The remaining portion 484 of TCO 2 may be unmodified. In some instances, the topography of TCO 2 may be modified to remove some of the TCO 2 material and create a sloped or angled surface, as depicted. In some embodiments the morphology of a top section 482 of TCO 2 may be modified to create varying resistance over the length of TCO 2 and the cross-hatched section 482 of FIG. 4K may only be a representative illustration of the resistance in this section and not representative of its actual topography. In this FIG. 4L example, the more resistance that exists between the bus bar 470 and TCO 2, the less the EC lite 4101 can tint. Here, the right-side of the cross-section E-E may be considered the bottom of the upper portions of FIG. 4L with more resistance and thus less voltage and less tinting.

In some embodiments, portions of the TCO layer to which the bus bar is positioned may have portions removed in order to created variable resistance between the bus bar and that TCO layer. FIG. 4M depicts an EC lite, 4103, having a monolithic EC device and bus bars positioned thereon, and having variable resistance between the bus bars and the TCO layer to which they are applied. Here, the top left portion illustrates the EC lite 4103 having two bus bars 470 (or one pair of bus bars) along the length of the EC lite and the variable resistance between these bus bars 470 and the TCO layer. When the bus bars 470 are energized, the configuration of the resistance between these bus bars 470 and the TCO layer to which they are applied produces a tint gradient on the EC lite as indicated in the upper right portion of the Figure. In some implementations, like in FIG. 4M, the bus bars 470 may have a uniform cross-sectional area. The EC lite 4103 is also configured to have variable resistance between the bus bars and TCO layer to which they are applied by having variable resistance in the TCO layer, TCO 2, on which the bus bars 470 are positioned. In the cross-sectional view G-G taken along the length of one bus bar 470, the glass, TCO 1 positioned thereon, an EC stack positioned in between TCO 1 and TCO 2, TCO 2, and bus bars 470 are shown.

In FIG. 4M, TCO 2 has been modified to provide variable resistance along its length L (and along the length of the bus bars as opposed to along its width) under the bus bar to provide variable electrical resistance to the bus bar 470. In some instances, like shown, the bus bar 470 be considered in direct contact with the TCO layer, TCO 2, and in some other embodiments, the bus bar may be indirectly positioned on TCO 2, such as on an adhesive layer with a uniform resistance. In FIG. 4M, the topography of the top surface of TCO 2 that faces the bus bar has been modified to remove a portion of the TCO 2 material. For instance, section 486 of TCO 2 has a first thickness T1 and section 488 of TCO 2 has a second thickness T2 that is less than T1, thereby creating different resistances through the thickness of TCO 2 and between TCO 2 and the bus bar 470. In some instances, the section of TCO 2 having the variable resistance may be considered a stepped thickness. During manufacturing, section 488 of TCO 2 may have been removed from TCO 2 or TCO 2 may have been manufactured with this topography without modification. The remaining portion 485 of TCO 2 may be unmodified. In this example, the more resistance that exists between the bus bar 470 and TCO 2, the less the EC lite 4101 can tint. Here, the right-side of the cross-section E-E may be considered the bottom of the upper portions of FIG. 4L with more resistance and thus less voltage and less tinting.

Some embodiments may include techniques for manufacturing one or more of the EC window lites provide above, including in FIGS. 4I through 4N. For example, a method of manufacturing an electrochromic window lite may include providing a transparent conductive oxide (“TCO”) layer, applying a bus bar onto the TCO layer, and creating variable resistance between the bus bar and the TCO layer, the bus bar having a substantially uniform cross-sectional area. In some implementations, the creating may include heating, while the bus bar is disposed directly or indirectly on the TCO layer, a first portion of the bus bar to a first temperature and heating a second portion of the bus bar to a second temperature different than the first temperature such that after the creating, the first portion of the bus bar has a first resistance between the bus bar and the TCO layer, and the second portion of the bus bar has a second resistance between the bus bar and the TCO layer different than the first resistance.

In some embodiments, the creating may include modifying, before applying the bus bar onto the TCO layer, a first section of the TCO layer such that the first section has a first resistance different than a second resistance of a second section of the TCO layer. The applying may include applying the bus bar to the first and second sections of the TCO layer. After the applying and the creating, a third resistance exists between bus bar and the TCO layer at the first section, and a fourth resistance different than the first resistance exists between the bus bar and the TCO layer at the second section. In some such instances, the modifying may include changing the morphology of the TCO layer and/or removing a portion of the first section of the TCO layer.

In some embodiments, the creating may include positioning, before applying the bus bar onto the TCO layer, one or more layers of material, e.g., an insulating layer onto the TCO layer, and the applying includes applying the bus bar to the insulating layer. In some implementations, the insulating layer may have a variable resistance along its length and/or a variable cross-sectional area along its length. In some embodiments, the creating may further include modifying, after applying the insulating layer onto the TCO layer, the insulating layer and causing the insulating layer to have a variable resistance along its length. The modifying may include changing the morphology of the insulating layer, changing the density of the insulating layer, heating the insulating layer to at least two different temperatures along its length, and/or changing the cross-sectional area of the insulating layer along its length. The changing may be performed by one or more of laser etch, chemical etch, or planarizing.

### Dual Powered Bus Bar

In certain embodiments described above, the bus bars, particularly those in the “electrically resistive bus bar” embodiments described in relation to FIG. 4G, can be powered from one end of the bus bars (as described above) or both ends of each bus bar (as described in relation to FIG. 4H). Powering bus bars from both ends provides additional control over the gradients/shading of the EC window. For example, as depicted in FIG. 4H (top left), a voltage is applied to the top ends of the two bus bars that power each of the TCO's of the EC device coating. The bottom ends are also in electrical communication through leads (depicted here as “open”). A voltage gradient is established over the length of the bus bars, in this example substantially equal gradients across the bus bars of substantially the same length. This results in a voltage gradient across the TCO's and a corresponding tinting gradient across the monolithic EC device coating. By using a dual lead configuration, one can “flip” the tinting gradient (see FIG. 4H, top right) by applying voltage at the bottom of the bus bars and establishing the opposite tinting gradient (depicted vertically here).

Referring again to FIG. 4H, bottom, one of ordinary skill in the art can see that multiple combinations are possible by suitable selections of V_applied_1, V_applied_2 and bus bar pattern and RB. In this example, the top and bottom portions of the EC device are tinted darker than a middle portion, when V_applied_1 and V_applied_2 are applied to both ends of both bus bars (only one bus bar's application depicted).

In one embodiment, an IGU includes two EC lites, each EC lite having a tint gradient zone as described in relation to FIGS. 4D and 4E. In one embodiment, the tint gradient zone of each EC lite is configured in opposition to each other, that is, one EC lite has a tinting front that starts at the opposite side (e.g., edge) of where the tinting front of the other EC lite starts. In this embodiment, a unique curtaining effect is established where the tinting fronts approach each other from opposite sides and cross paths in the middle of the IGU. In one case, when transition is complete in both EC lites, the IGU may have a “privacy glass” tint level, of e.g. <1% T. In another embodiment, each EC lite may be tinted independently to provide a “top down” tint gradient or “bottom up” tint gradient. In one embodiment, the tint gradient zones of the EC lites are registered together i.e. aligned so that the tinting fronts of the EC lites start on the same side of the IGU and end at the other opposing side. In this latter embodiment, tinting of the IGU may be done for different tint levels with one lite, e.g., to provide a top down tint gradient of one intensity (absorption gradient e.g.) for one tint level, and another (darker) tint level of tinting gradient when both lites are tinted. Either of the two aforementioned IGU embodiments may have their individual EC lites tinted together or alternatively tinted asynchronously for yet another shading effect that is not possible with conventional monolithic EC devices.

In one embodiment, a bus bar may include an inner portion of electrically conductive material with a cross-sectional dimension (e.g., width) that varies lengthwise, and an outer portion of electrically resistive material. The outer portion may have geometry which is designed to couple and form with the inner portion a uniform cross-section along the length of the bus bar.

In certain embodiments, such as some embodiments described above, an electrochromic window lite includes a monolithic EC device on a transparent substrate, wherein the EC lite includes at least one pair of bus bars configured to produce a tint gradient zone on the monolithic EC device when energized. In some embodiments, tinting gradients are established using bus bars, where each bus bar has at least two portions that are highly conductive. The at least two portions are separated by a portion that is more resistive than the highly conductive at least two portions, while still being electrically conductive. The more resistive portion is configured adjacent to or overlapping the at least two highly conductive portions. In this embodiment, the at least two highly conductive portions are separated, they do not touch, but rather each only touches, and is in electrical communication with the more resistive portion in between them. An electrical power source is configured to power only one portion of the at least two highly conductive portions of each of the at least one pair of bus bars. Each of the only one portion of the at least two highly conductive portions is proximate the same side of the monolithic EC device as the other of the only one portion. One of these embodiments is described in more detail in relation to FIG. 4F.

Tint gradient zones can be created using bus bars having varying material composition along their lengths. For example, FIG. 4F depicts an EC lite, 455, having two bus bars, each configured along opposing edges (e.g., vertically, horizontally, etc.) and parallel to each other on lite 455. In this example, each bus bar has highly electrically conductive portions, 460a, 460b, and 460c (collectively, 460), and less electrically conductive portions, 465a and 465b (collectively, 465). In the illustrated example, less electrically conductive portions, 465a is between highly electrically conductive portions 460a and 460b, and less electrically conductive portions, 465b is between highly electrically conductive portions 460b and 460c. The less electrically conductive portions, 465a and 465b, may be portions of a monolithic bus bar where the conductivity has been reduced by, e.g. changing the morphology of the bus bar material and/or perforating the material, etc. In another example, separate bus bars are used, for example as described in relation to FIGS. 4A and 4B, and the TCO on which it lies, specifically the area of the TCO between ends of bus bars, acts as a resistive element to slow current flow between proximate bus bar ends. Referring again to the specific example in FIG. 4F, highly electrically conductive portions 460a, 460b, and 460c may be conventional silver based conductive bus bar ink, while portions 465a and 465b may be a less conductive ink. In this illustrated example, the bus bars may be connected to an electrical source at the top portion, 460a, of each bus bar. A voltage gradient may be established along the length of the bus bars by virtue of the resistive portions 465a and 465b. That is, the top highly conductive portions 460a may have the highest voltage, and the middle highly conductive portions 460b may have a somewhat lower voltage because the more resistive portions 465a creates an IR voltage drop between the middle portions 460b and portions 460a. Likewise the bottom-most highly conductive portions 460c may have the lowest voltage because the more resistive portions 465b lie between them and the middle highly conductive portions 460b preventing some of the electrical current from flowing from middle portion 460b to lower portion 460c. The net effect may be a tint gradient zone, for example, the one depicted in FIG. 4F. Highly electrically conductive portions 460 may be of the same or different conductive material, and likewise, less electrically conductive portions 465 may be comprised of the same or different conductive material. The key is that portions 465 are less electrically conductive than their adjacent neighbors 460. Using this technology, a wide variety of voltage and/or resistance patterns may be established in order to create corresponding tint gradient zones in an EC lite. In addition, a combination of bus bars of lengthwise varying width and those bus bars configured as described in relation to FIG. 4F may be used. For example, each as partners in a bus bar pair and/or in individual tint gradient zones on an EC lite.

### Remotely Controlled Resistive Nodes

In certain embodiments, the less electrically conductive portions, 465 have variable resistance whose resistance can be varied between 1 mOhm-1 kOhm to dynamically adjust the tint gradient zones, i.e. when no zoning is required, elements 465 are in the low resistance state. That is the bus bar segments 460 and 465, collectively, act as a single bus bar of low resistivity. When zoning is desired, elements 465 are switched to a higher resistance state (than bus bar segments 460) when zoning is desired. The resistance of the element can also be varied to modulate the gradient in the Tvis (lower resistance for lower gradient). The element 465 can be an electronic control element that can modulated remotely (e.g. wireless/Bluetooth/Zigbee etc.) and can be triggered by automated EC control intelligence and/or manually by user input. The control element may be a component of an onboard controller, that is, an EC controller that is integrated with, in, part of the IGU. Such onboard controllers are described in U.S. patent application Ser. No. 13/049,750 titled “ONBOARD CONTROLLER FOR MULTISTATE WINDOWS,” filed on Mar. 16, 2011 and in U.S. patent application Ser. No. 14/951,410 titled “SELF-CONTAINED EC IGU,” filed on Nov. 24, 2015, both of which are hereby incorporated by reference in their entirety.

### Different Bus Bar Types on Each TCO of an EC Device.

In certain embodiments, the top and bottom TCO bus bar configurations may be different, which can be used synergistically to provide even more control over the zoning/gradients. For example, consider a specific cross section (orthogonal to the bus bars) of a monolithic EC device coating having bus bars of different configuration along each side. If the voltage profile, gradient, along one bus bar is different than the voltage profile of the other bus bar, then various tint gradients can be achieved. Thus, with different combinations of bus bar configurations on a single EC coating, almost endless variations in the gradients are possible.

### Low Leakage Current Requirements

The EC device tinting or clearing operation can be divided into a drive step and hold step, e.g. where there is a ramp in voltage followed by a constant voltage, respectively. For monolithic EC device coatings without physical breaks/scribes/resistance zones, but having tint zones as described herein, it is especially important that the leakage current of the device is as low as possible. This is because, the leakage current can normalize or diffuse out any gradients setup due to conduction over the TCOs and change in the V_applied. Thus, leakage currents <5 μA/cm² are desirable to ‘freeze’ the gradients setup in the window. Such low leakage current EC coatings are described, e.g., in US Patent

Advantages of No Break in EC Stack; Smooth Gradients Vs. Sharp Transition

With respect to user aesthetics for gradient tinting EC windows, it is preferable not to have any sharp transitions in Tvis, but rather a gradual shading from one end to the other.

In certain embodiments, an EC lite may be configured to have a combination of tint gradient zones and tint zones that do not have tint gradient capability (non-gradient tint zones). One embodiment is a monolithic EC device having two or more tinting zones, where at least one tinting zone is a tint gradient zone and at least one tinting zone is a non-gradient tint zone. One embodiment is a monolithic EC device having two or more tint gradient zones, with or without also having a non-gradient tint zone.

In one embodiment, the bus bars described in relation to FIG. 4F are configured such that each highly electrically conductive portion, 460a, 460b, and 460c, has its own electrical connection to a power source. Analogous to the separate bus bar pairs described in relation to FIG. 4A (or FIG. 3A or 3D), the bus bars described in relation to FIG. 4F, when configured with each highly electrically conductive portion 460 having its own power source (or sources, e.g. as described in relation to FIG. 4H), may be used to create tint gradient zones with tinting patterns similar to those described in relation to FIGS. 4B and 4C.

In certain embodiments that use powering mechanisms alone to create tinting zones, the tinting front may not be a clean line, but rather have a diffuse appearance along the tinting front due to the charge bleeding off into the EC device's adjacent zone which is not powered at the time. In certain embodiments, resistive zones may be used to aid in maintaining more well-defined tinting fronts. Resistive zones are described in more detail below.

Resistive Zones with or without Configuring Powering Mechanism of EC Devices

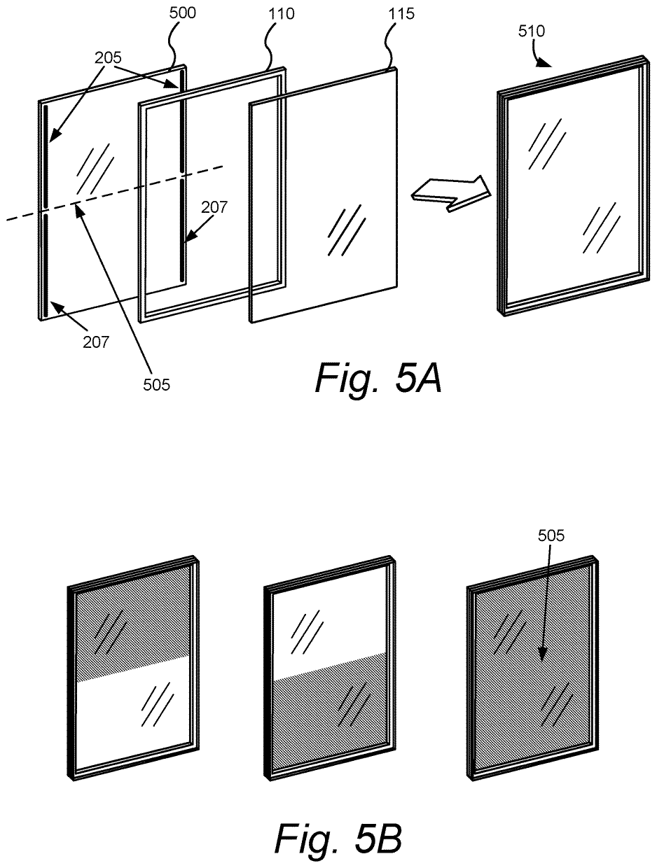

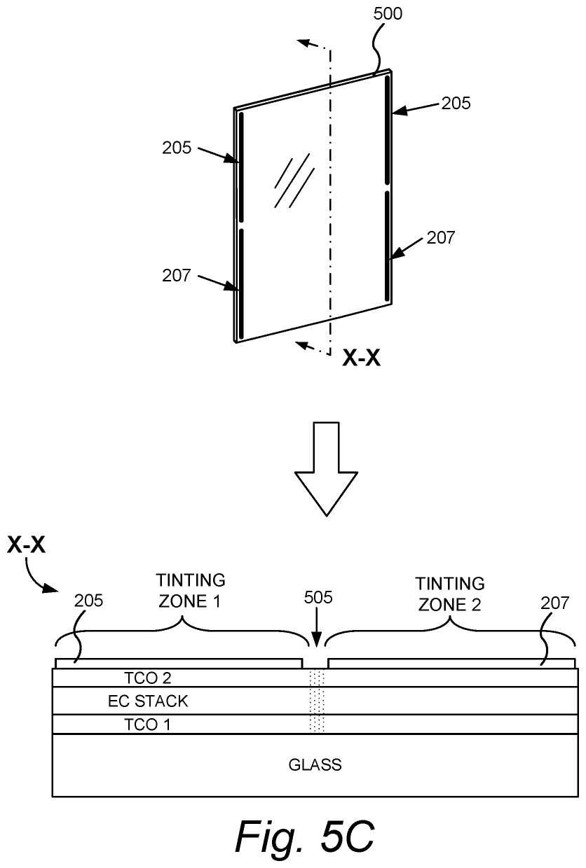

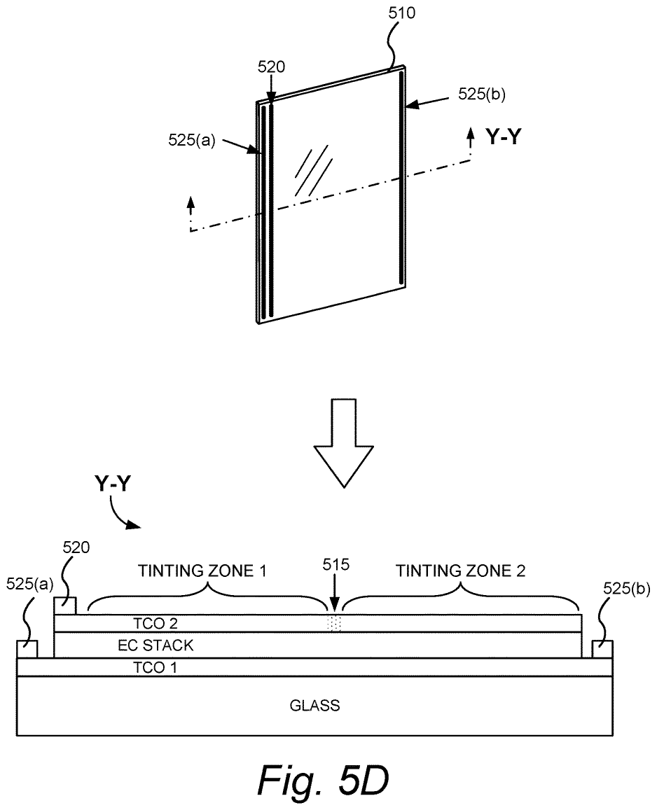

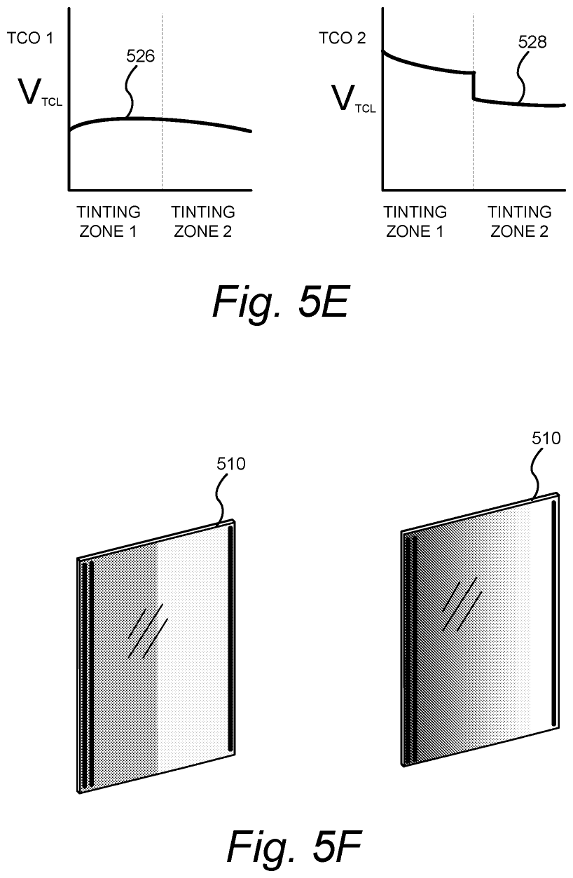

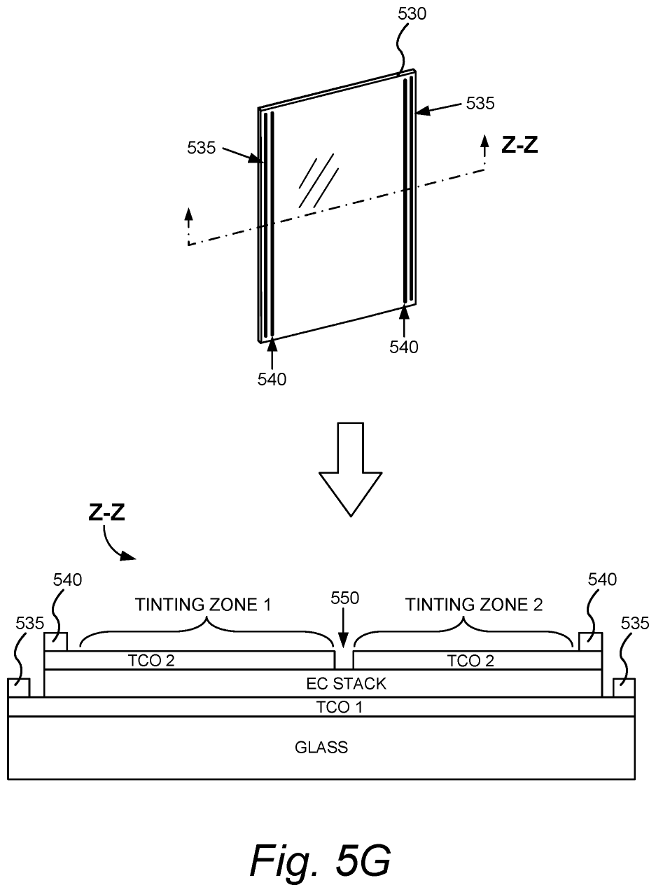

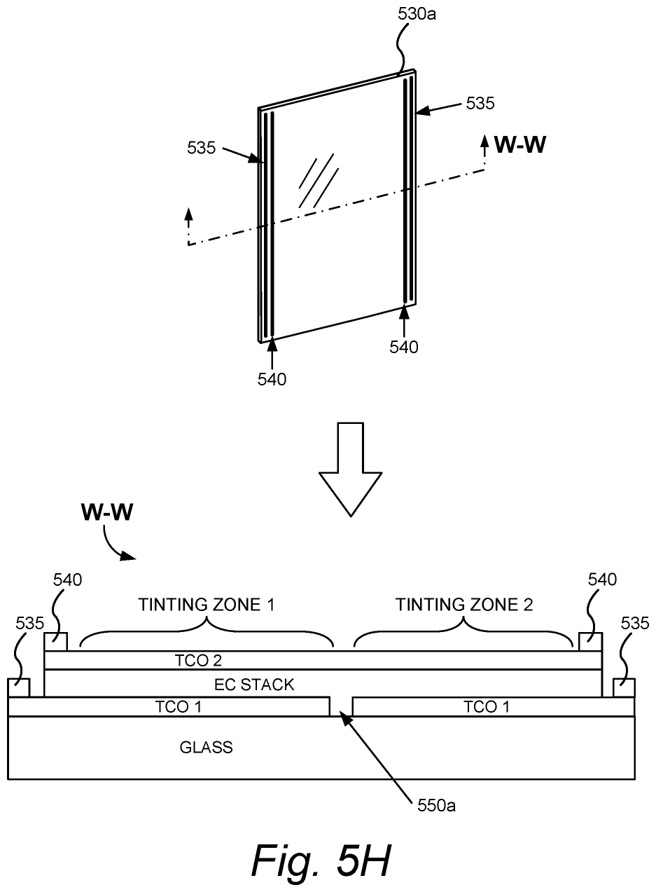

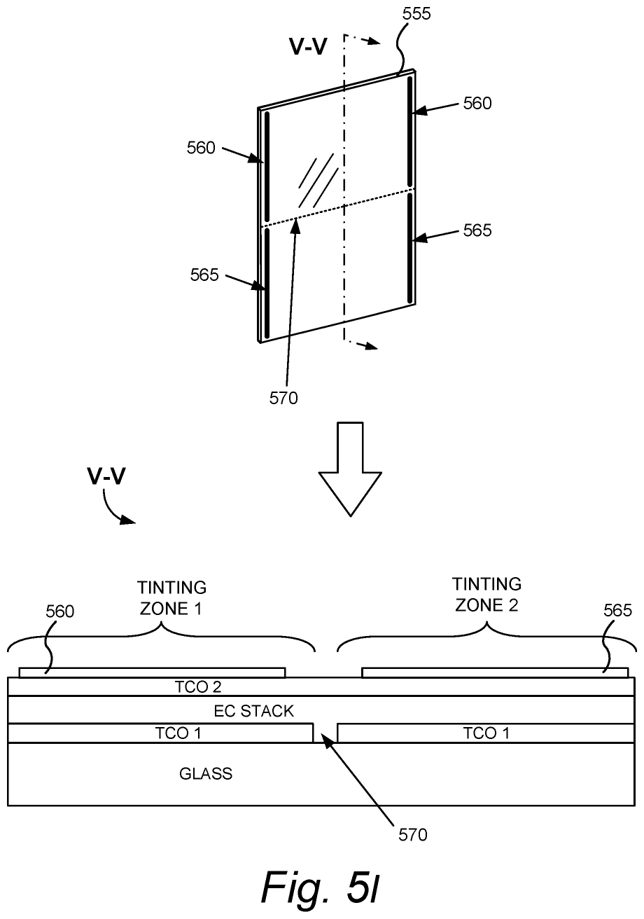

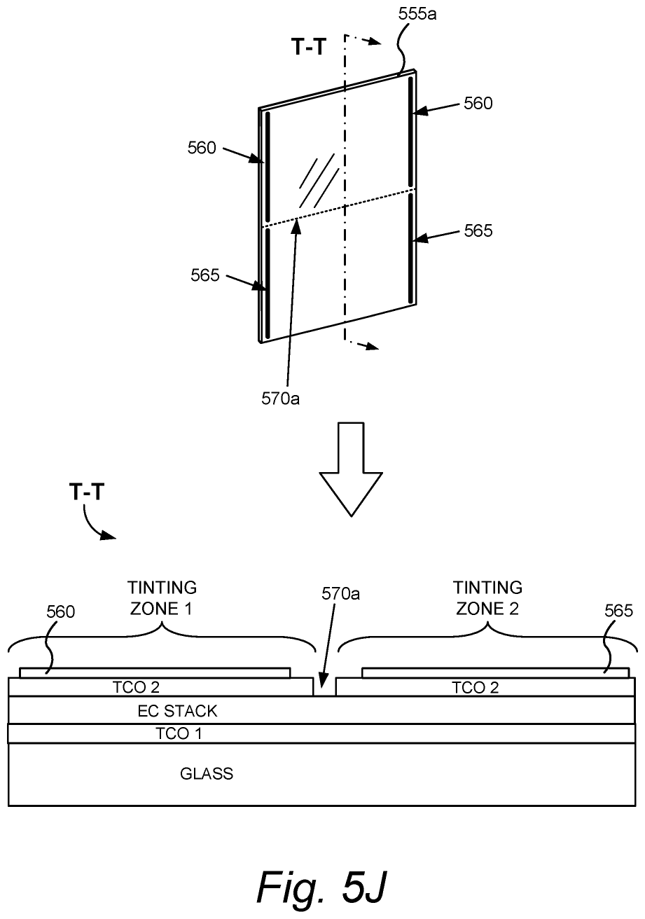

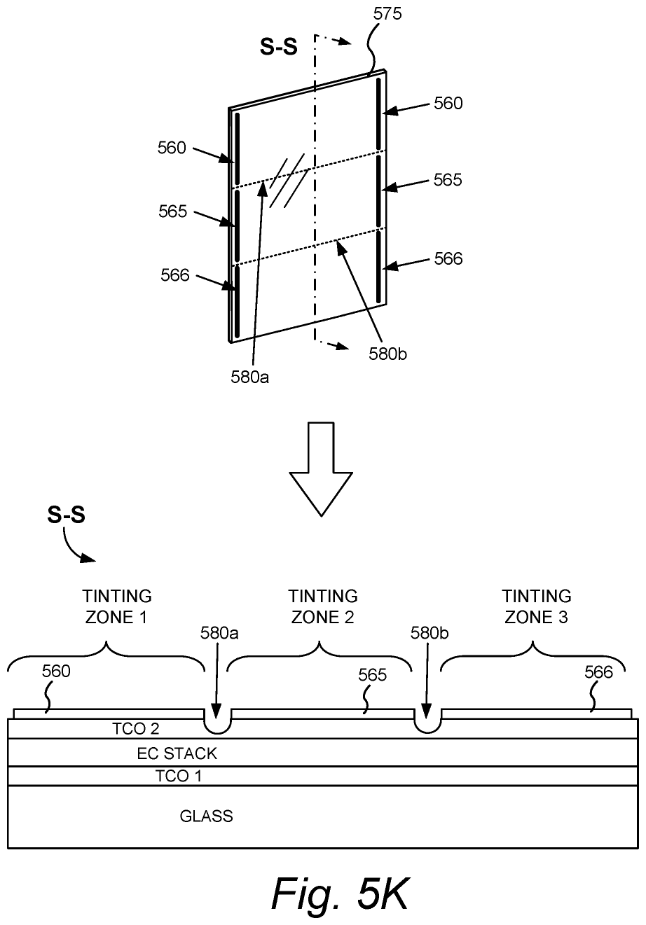

In certain embodiments, resistive zones are configured in the monolithic EC device. These resistive zones may allow for more uniform tinting fronts, e.g., when used in combination with bus bar powering mechanisms described herein. Referring to FIG. 5A, an EC lite, 500, much like EC lite 200 of FIG. 2A, is configured with two pairs of bus bars for creating two tinting zones, in this example (as depicted) a top and a bottom zone. EC lite 500 may be incorporated into an IGU, 510, with a spacer 110 and a mate lite 115 as depicted. A major difference between lite 200 of FIG. 2A and lite 500 of FIG. 5A is that lite 500 does not have a laser scribe 225 across the lite to bifurcate the EC device into two devices. Lite 500 has a single EC device over the viewable area of the lite. However, the EC device on lite 500 includes a resistive zone, 505, that spans the width of the EC device. The heavy dotted line in FIG. 5A indicates the approximate position of resistive zone 505.

As depicted in the IGU construct 510, resistive zone 505, like laser scribe 225, may not be visible to the naked eye when the EC lite's zones are not tinted. However, unlike laser scribe 225, when adjacent tinting zones of EC lite are tinted, resistive zone 505 may not be visually discernible to the naked eye. This is illustrated schematically in the right portion of FIG. 5B. The reason resistive zone 505 tints is because it is not a physical bifurcation of the EC device into two devices, but rather a physical modification of the single EC device coating and/or its associated transparent conductors within a resistive zone. The resistive zone is an area of the EC device where the activity of the device is impeded, specifically through higher electrical resistivity and/or greater resistance to ion movement and/or lower ion density compared to the remainder of the EC device. Thus one or both of the transparent conductors may be modified to have increased electrical resistivity in the resistive zone, and/or the EC device stack may be modified so that ion movement is slower in the resistive zone relative to the EC device stack in the adjacent tinting zones. The modifications may be made during deposition of the EC device or post deposition through a thermal and/or laser treatment. The EC device still functions, tints and bleaches, in this resistive zone, but at a slower rate and/or with less intensity of tint than the remaining portions of the EC device. For example, the resistive zone may tint as fully as the remainder of EC device in the adjacent tinting zones, but the resistive zone tints more slowly than the adjacent tinting zones. In another example, the resistive zone may tint less fully than the adjacent tinting zones, and at a slower rate.

FIG. 5C is a perspective and a cross section, X-X, of EC lite 500 as described with respect to FIGS. 5A and 5B. The cross section, X-X, spans the upper and lower tinting zones (tinting zones 1 and 2, respectively) of EC lite 500 as well as resistive zone 505 (only the bus bars on the top TCO are depicted in cross section X-X, they are orthogonal to resistive zone 505 in this example). Cross section X-X (lower portion of FIG. 5C) is not to scale, but rather a schematic representation of the structure of EC lite 500. On the glass substrate is an EC device including a first transparent conducting oxide layer, TCO 1, a second transparent conductive oxide layer, TCO 2, and sandwiched in between the TCOs is an EC stack which contains one or more electrochromic materials, e.g., the transitions of which are driven by intercalation/de-intercalation of ions, such as lithium ions. Resistive zone 505 is an area in the EC device where one or more layers of the EC device have their function impaired, either partially or completely, but device function is not cut off across the zone. For example, one or both of the TCOs has a higher resistance to electrical flow in resistive zone 505 than in the tinting zones. Thus, e.g., if tinting zone 1 is activated, electrons flow across the TCOs at a given rate, but that flow is restricted along resistive zone 505. This allows the electrons to be sufficiently retained in tinting zone 1 and thus leak more slowly across resistive zone 505 than otherwise would be the case if TCO function had not been impaired there.

Resistive zone 505 could be thought of as a “dam” for electrical and/or ionic flow, impairing rate of flow (either ionic current or electronic current) across it, the flow can be partially or fully impaired in one or both TCOs, for example. Due to the restricted or slowed rate of electrical flow across resistive zone 505, ion intercalation in the EC stack between the TCOs at resistive zone 505 is also impaired. Because the EC device is not physically cut into two devices, this is unlike conventional devices having zones created by physical bifurcation of one more layers of a single device coating. Resistive zone 505 may have physical impairment of ion flow in one or more of the EC material layers. In one example, both the top and bottom TCO's electrical conductivity is impaired, either partially or fully, in resistive zone 505, but the function of the EC device stack layers is substantially unchanged. Thus, when one tinting zone is tinted and the adjacent zone is not-tinted, the device will tint under resistive zone 505. When adjacent tinting zones are both tinted, there is no bright line discernible to the end user, because the device tints under resistive zone 505. In embodiments where ion flow is impaired in resistive zone 505, the device may still color, but more slowly than the bulk device. This rate difference in coloring may or may not be visually discernible to the end user.

Resistive zone 505 may be fabricated, for example, by exposure of the area at the resistive zone 505 to irradiation, e.g. laser or heat source, in order to modify but not destroy the function at resistive zone 505. For example, one or both of the TCO layers may be heated sufficiently to change the morphology while retaining the function, albeit impaired relative to the remainder of the TCO layers in the tinting zones. In certain embodiments, it is advantageous to impair the function of only one TCO in a resistive zone. Resistive zones may also be created by impairing the function of one or more layers of the EC device (including, or not, one or both TCOs) by chemical doping. For example, in one embodiment the lower TCO is treated along a line (at resistive zone 505, e.g.) with heat and oxygen to create a more resistive TCO at the resistive zone. In another embodiment, one or both TCOs are fabricated thinner along the resistive zone than the rest of the TCOs, e.g. TCO material may be removed, but not cut through, along the resistive zone. In another example heating along the zone may densify the EC materials while having no effect on the TCO layers; or may affect the TCO layers as well.

In certain embodiments, the resistive zones may be narrow, e.g. between about 1 μm and 1000 μm wide, or may be wider, e.g. between about 1 mm and about 10 mm wide. Because the EC materials in resistive zones tint and do not necessarily leave a bright line contrast effect typical of conventional laser isolation scribes, there is less concern as to the width of the described resistive zones. Thus, in other embodiments, a resistive zone may be, for example, wider than 1 mm, wider than 10 mm, wider than 15 mm, etc.

In the embodiment described in relation to FIGS. 5A, 5B, and 5C, each of the tinting zones has its own unique pair of bus bars. Thus tinting zones can be colored independently by virtue of operation or the respective bus bar pairs at each tinting zone. In other embodiments, multiple tinting zones may be configured to share a common bus bar, while still being independently controllable.

FIG. 5D depicts a perspective (top portion) and a cross section Y-Y (bottom portion) of an EC lite, 510, having two tinting zones of variable tinting level by virtue of a resistive zone, 515. In this illustrated example, a single set of three bus bars, 525(a), 525(b), and 520, is used with two tinting zones. Cross section, Y-Y, of EC lite 510 spans left and right tinting zones (tinting zones 1 and 2, respectively) of lite 510 as well as resistive zone 515. Resistive zone 515 runs parallel to and between (approximately in the middle of EC lite 510) bus bars 520 and 525(a) and bus bar 525(b) (from top to bottom as depicted in the perspective at the top of FIG. 5D). Cross section Y-Y (lower portion of FIG. 5D) is not to scale, but rather is a schematic representation of the structure of EC lite 510. On the glass substrate is an EC device including a first transparent conducting oxide layer, TCO 1, a second transparent conductive oxide layer, TCO 2, and sandwiched in between TCO 1 and TCO 2 is an EC stack which contains one or more electrochromic materials, e.g., the transitions of which are driven by intercalation/de-intercalation of ions, such as lithium ions. In this example, resistive zone 515 is an area of TCO 2, where the TCO function is impaired but not eliminated. For example, TCO 2 may have its function impaired along a line.

FIG. 5E includes two graphs showing plots of the local voltage W_{TCL} in TCO 1 and TCO 2 of the EC lite, 510, of FIG. 5D that drives transition. At the left, a graph shows a curve 526 of the local values of T_{TCL} in the TCO 1. At the right, a graph shows a curve 528 of the local values of V_{TCL} in the TCO 2. In this example, when the EC device is energized, the bottom TCO 1 has a local voltage potential V_{TCL} across its span similar to that of a typical transparent conductor for an EC device. According to curve 526 of V_{TCL} in TCO 1, the voltage increases slightly in the middle away from where bus bars 525(a) and 525(b) are disposed on TCO 1 where voltage is applied due to the sheet resistance and current passing through TCO 1. The increase will be near bus bar 525(a) and bus bar 520 because of the higher current in this area due to higher voltage potential between bus bar 525(a) and bus bar 520. But TCO 2, by virtue of resistive zone 515, has a higher V_{TCL} in tinting zone 1 than in tinting zone 2. According to curve 528 V_{TCL} in TCO 2, the slight voltage drops between the left hand side where bus bar 520 is disposed on TCO 2 and the resistive zone due to sheet resistance and current passing through TCO 2. At the resistive zone 515, the voltage sharply drops. The voltage slightly drops between the resistive zone 515 and the right hand side due to sheet resistance and current passing through TCO 2. The value of V_{eff} at any location between the bus bars is the difference in values of curves 130 and 125 at that position on the x-axis corresponding to the location of interest. The result is that tinting zone 1 has a higher V_{eff} than tinting zone 2 and thus tinting zone 1 colors more darkly than tinting zone 2. This is represented in FIG. 5F. On the left of FIG. 5F, a visible coloration difference is seen in window 510 corresponding to the location of resistive zone 515 and the rather abrupt drop in voltage in TCO 2 as reflected in FIG. 5E. However, this visual coloration difference need not be so; that is, for example, if resistive zone 515 is sufficiently “leaky”, and allows voltage to flow across the top TCO in a smooth gradient (or if window 510 is configured without resistive zone 515 and the voltage applied to TCO 2 is insufficient to overcome a voltage drop across TCO 2; this is discussed in more detail below) then a gradual transition from darker to lighter results (see FIG. 4F, right side) due to the voltage drop over. Of course, the two tinting zones can be configured as upper and lower portions when installed in a building, and they need not be side by side as depicted.

FIG. 5G depicts an EC lite, 530, configured with a resistive zone created by inhibiting the electrical conductivity of only one of the transparent conducting oxides. The EC lite is much like the one described in relation to FIG. 5E, but in this embodiment one of the TCOs is cut through along the resistive zone (cut 550), while the other TCO is left intact. The EC device stack is unchanged in the resistive zone, only the top TCO is cut. The EC lite 530 has two sets of bus bars, 535 and 540. Bus bar set 535 powers the lower TCO 1, while bus bar set 540 powers the top TCO 2. The lower portion of FIG. 5G shows cross section Z-Z. The EC device will still at least partially color along the resistive zone by virtue of one of the TCOs being fully intact, monolithic, along with the EC stack. While there is a narrow region of the opposite TCO 2 missing, there is sufficient voltage potential established between the intact TCO 1 and the edge of the cut (opposing) TCO 2 along the resistive zone to allow coloration of the EC device in the resistive zone, albeit more slowly than if both TCOs were intact along the resistive zone. The resistive zone may color more lightly when only one of the tinting zones is powered, while with both tinting zones powered, the resistive zone may fully tint or approximate full tinting. Each portion of TCO 2 can be powered independently of TCO 1. In this way, separate zones, tinting zone 1 and tinting zone 2, may, e.g., be tinted more effectively. Since there is a cut through the TCO 2, if only one zone is powered, a tinting level of V_{TCL} is only established in that tinting zone. The cut in TCO 2 aids in establishing and maintaining a uniform tinting front. In this example, since the TCOs are a type of moisture barrier, EC lite 530 may be incorporated into an IGU where the EC device is hermetically sealed within the volume of the IGU, and/or a top coat may be used to hermetically seal the device, with our without lamination to a substrate. A top coat would fill the open trench cut through TCO 2.

In certain embodiments, it may be more desirable to cut the bottom TCO 1 rather than the top TCO 2. FIG. 5H shows EC lite, 530a, where the cut, 550a, is made only through the bottom TCO 1. In this example, the top TCO 2 may maintain its hermeticity by virtue of an intact top transparent conductor layer. The EC material may fill in the trench made by cut 550a, and thus tint along with the trench in TCO 1 that it fills, providing an area of inhibited coloration rate such as a resistive zone.

In certain embodiments, it may more desirable to cut the top TCO 2 rather than the bottom TCO 1. FIG. 5G shows EC lite, 530, where the cut, 550, is made only through the top TCO 2. An advantage of this embodiment may be that the cut can be made after the EC device is fabricated, for example, by laser processing performed after sputter coating.

The bus bars 535 and 540 depicted in FIGS. 5G and 5H need not be parallel, e.g. the bus bars powering each TCO can be orthogonal to each other. Also, the single monolithic TCO need not have two bus bars, but it is desirable so as to have more control over tinting of the individual tinting zones. Bleaching function would work the same way but in reverse polarity to bleach the tinting zones. In the embodiments described in relation to FIGS. 5D-5H, the bus bars are configured parallel to the resistive zone; in FIGS. 5I and 5J, like in FIG. 5C, e.g., the bus bars are configured orthogonally to the resistive zone.

In certain embodiments, there are no bus bars in the viewable area of the EC device, that is, in the area within the spacer of the IGU. Certain conventional EC technologies rely on bus bars running through the viewable area because of slow switching kinetics that would otherwise occur and/or due to ion conductor layer leakage currents that do not allow the EC device to switch across the entire viewable area of larger IGUs (e.g. about a meter wide or more where bus bars would otherwise be configured outside the viewable area at the edges of this width) without such bus bars in the viewable area to provide the extra voltage needed to compensate for the leakage current. Certain embodiments described herein, e.g. where cuts are made through one of the TCOs but not the EC device stack itself, do not require bus bars in the viewable area because they include EC devices with very low leakage current. Examples of such devices are described in US Patent, Ser. No. 12/814,279, filed Jun. 11, 2010, which is herein incorporated by reference in its entirety. For example, the embodiments described where the resistive zone includes a cut through one of the TCOs include examples where there are no bus bars in the viewable area of the EC device.

FIG. 5I depicts an EC lite, 555, configured with a resistive zone, 570, created by inhibiting the electrical conductivity across one of the transparent conducting oxides, in this example a cut is made through the TCO nearer the substrate. The EC lite is much like the one described in relation to FIG. 5C, but in this embodiment one of the TCOs is cut through along the resistive zone (cut 570), while the other TCO is left intact. The EC device stack is unchanged in the resistive zone area, only the bottom TCO is cut. The EC lite 555 has two sets of bus bars, 560 and 565. Bus bar set 560 powers both the upper and the lower TCOs in tint zone 1 (TCO 1 and TCO 2), while bus bar set 565 powers tint zone 2. The lower portion of FIG. 5I shows cross section V-V (only the bus bars on TCO 2 are depicted). The EC device will still at least partially color along the resistive zone by virtue of one of the TCOs being fully intact, monolithic, along with the EC stack. While there is a narrow region of the opposite TCO 1 missing, there is sufficient voltage potential established between the intact TCO 2 and the edge of the cut (opposing) TCO 1 along the resistive zone to allow coloration of the EC device in the resistive zone, albeit more slowly than if both TCOs were intact along the resistive zone. The resistive zone may color more lightly when only one of the tinting zones is powered, while with both tinting zones powered, the resistive zone may fully tint or approximate full tint. Each portion of TCO 1 can be powered independently of TCO 2. In this way, separate zones, tinting zone 1 and tinting zone 2, may, e.g., be tinted more effectively. Since there is a cut through the TCO 1, if only one zone is powered, a tinting level V_{TCL} is only established in that tinting zone. The cut in TCO 1 aids in establishing and maintaining a uniform tinting front. In this example, since the TCOs are a type of moisture barrier, EC lite 555 may be incorporated into an IGU where the EC device is hermetically sealed within the volume of the IGU, and a top coat may not be necessary because TCO 2 remains intact, although in one embodiment a top coat is applied to TCO 2. Because the bus bars in EC lite 555 are orthogonal to the resistive zone 570, the tinting front is also orthogonal to the bus bars.

FIG. 5J depicts an EC lite, 555a, configured with a resistive zone, 570a, created by inhibiting the electrical conductivity across one of the transparent conducting oxides, in this example a cut is made through the TCO distal the substrate. The EC lite is much like the one described in relation to FIG. 5I, but in this embodiment TCO 2 is cut through while TCO 1 is left intact. The EC device stack is unchanged in the resistive zone area, only the top TCO is cut. The EC lite 555a has two sets of bus bars, 560 and 565. Bus bar set 560 powers both the upper and the lower TCOs in tint zone 1 (TCO 1 and TCO 2), while bus bar set 565 powers tint zone 2. The lower portion of FIG. 5J shows cross section T-T (only the bus bars on TCO 2 are depicted). The EC device will still at least partially color along the resistive zone by virtue of one of the TCOs being fully intact, monolithic, along with the EC stack. While there is a narrow region of the opposite TCO 2 missing, there is sufficient voltage potential established between the intact TCO 1 and the edge of the cut (opposing) TCO 2 along the resistive zone to allow coloration of the EC device in the resistive zone, albeit more slowly than if both TCOs were intact along the resistive zone. The resistive zone may color more lightly when only one of the tinting zones is powered, while with both tinting zones powered, the resistive zone may fully tint or approximate full tinting. Each portion of TCO 2 can be powered independently of TCO 1. In this way, separate zones, tinting zone 1 and tinting zone 2, may, e.g., be tinted more effectively. Since there is a cut through the TCO 2, if only one zone is powered, a tinting level of V_{TCL} is only established in that tinting zone. The cut in TCO 2 aids in establishing and maintaining a uniform tinting front. In this example, since the TCOs are a type of moisture barrier, EC lite 555a may be incorporated into an IGU where the EC device is hermetically sealed within the volume of the IGU, and a top coat may be necessary because TCO 2 is cut through, in one embodiment a top coat is applied to TCO 2. Because the bus bars in EC lite 555a are orthogonal to the resistive zone 570a, the tinting front is also orthogonal to the bus bars.

When two bus bars ends of opposite polarity are located proximate each other on an intact TCO, hot spots can result. Hot spots are described in U.S. patent application Ser. No. 13/452,032, filed Apr. 20, 2012 which is incorporated by reference herein in its entirety. When using TCOs that are cut through, e.g. as depicted in FIG. 5J, hot spots may be avoided because the proximate bus bars of a TCO layer cannot electrically communicate with each other through the TCO. However, to avoid stress on the underlying EC device in the area along the resistive zone formed by cutting through TCO, the ends of the bus bars may be configured so they are not directly over (aligned with) the cut made for the resistive zone.

One embodiment is an EC lite as described herein, where a resistive zone is formed by partially cutting through one or both of the TCOs. For example, in one embodiment, e.g. analogous the embodiment described in relation to FIG. 5J, the top TCO is only cut part way through, rather than cut through. In this way a resistive zone is established and the hermiticity of the EC device, imparted by the top TCO is left at least partially intact. FIG. 5K depicts another example.

FIG. 5K depicts an EC lite, 575, configured with two resistive zones, 580a and 580b, created by inhibiting the electrical conductivity across one of the transparent conducting oxides. In this example, partial cuts are made through the TCO distal the substrate (TCO 2). The EC lite is much like the one described in relation to FIG. 5J, but in this embodiment TCO 2 is not cut through, but only some TCO material is removed to form resistive zones 580a and 580b. For example, laser ablation is used to remove material only down to a fraction of the depth of the ITO. In one embodiment, between about 10% and about 90% of the TCO material is removed along the zone, in another embodiment between about 25% and about 75% of the TCO material is removed, in yet another embodiment between about 40% and about 60% of the material is removed. By removing only part of the TCO material, a resistive zone is fabricated while not exposing the EC stack to the ambient. Lite 575 has three tint zones, by virtue of having two resistive zones. The EC lite 575 has three sets of bus bars, 560, 565 and 566. Bus bar set 560 powers both the upper and the lower TCOs in tint zone 1 (TCO 1 and TCO 2), bus bar set 565 powers tint zone 2, and bus bar set 566 powers tint zone 3. Each tint zone can be independently controlled via powering the bottom TCO, and independently charging the TCO 2 bus bars, depending upon which zone tinting is desired. Because the resistive zones have a higher sheet resistance relative to the bulk TCO, charge loss over this barrier is slow and allows the powered zone to fully tint while the tinting front approximates the position of the resistive zone.

The lower portion of FIG. 5K shows cross section S-S (only the bus bars on TCO 2 are depicted). The EC device will still at least partially color along the resistive zone by virtue of TCO 2 being fully intact, monolithic, along with the EC stack. The resistive zone may color more lightly when only one of the tinting zones is powered, or not at all, depending on its width and the thickness of the TCO in the resistive zone. With adjacent tinting zones powered, the resistive zone may fully tint or approximate full tinting. In this example, since the TCOs are a type of moisture barrier, EC lite 575 may be incorporated into an IGU where the EC device is hermetically sealed within the volume of the IGU, and a top coat may be necessary because TCO 2 is at least partially cut through, in one embodiment a top coat is applied to TCO 2. Because the bus bars in EC lite 575 are orthogonal to the resistive zones 580a and 580b, the tinting front is also orthogonal to the bus bars and approximates the line defined by the resistive zones.

Note, in FIG. 5K, the bus bars ends are substantially coextant with the resistive zones. In one embodiment, bus bar material is applied and then the resistive zones are formed by cutting through the bus bar material and at least some of the top TCO. In certain embodiments the top TCO is cut through, while not cutting the EC device stack through (a portion of the EC stack may be cut, but sometimes not through the IC material so as not to form electrical shorts along the resistive zone). By applying, e.g., only two lines of bus bar material (e.g. silver based ink) and firing the bus bars, the resistive zones and individual bus bar pairs can be fabricated in the same process by cutting through the bus bar material and into or through the top TCO simultaneously. This saves process steps. The bus bar on the bottom TCO 1 is cut through without cutting through the bottom TCO. In one embodiment the bus bars on the top TCO are formed by cutting through along with the top TCO, either fully or partially cut, while the bottom bus bars are applied separately to each tinting zone. In certain embodiments, each tinting zone's bus bars are applied individually to each tinting zone. The latter may be done to avoid the aforementioned hot spots, e.g. when cutting through the bus bar and TCO in the same process, the ends of the newly formed bus bars are necessarily aligned with the cut in the TCO, since they were from the same cutting process.

### Resistive Layer Through EC Stack Changes to Speed/Coloration Efficiency

In certain embodiments, a resistive zone can be created by changing the electrochromic behavior of one or more layers of the EC stack vs. applied voltage. In this case, the resistive zone provides a resistance to coloration rather than electrical resistance per se. For example, the resistive zone may color slowly or less deeply (higher Tvis) compared to the rest of the device at same V_{eff}. This can be achieved by, for example, 1) reducing the dose of ions (typically Li⁺) causing the electrochromic reaction, 2) changing the properties of the electrochromic layers (EC, CE) such that the optical change per ion is reduced (i.e. reduced coloration efficiency), 3) reducing ion mobility in the EC and/or CE layers in the resistive zone, and/or 4) increasing the thickness of the IC layer and/or reducing ion mobility in the IC layer such that it is harder for the ions to move across the IC layer. Any of these changes can be done during deposition and/or post fabrication. For example, local heating of the EC stack due thermal/laser irradiation can be used, or for example, selectively altering deposition rate and/or oxidation state in the resistive zone relative to the bulk device.

Certain embodiments concern methods of fabricating apparatus and devices described herein. One embodiment is a method of forming an EC lite having two or more tinting zones, the method including a) forming a EC device (e.g., a monolithic EC device), b) applying a single bus bar to the top TCO of the monolithic EC device, and c) cutting through the bus bar and at least part way through the top TCO thereby fabricating said two or more tinting zones each having separate bus bars on the top TCO by virtue of c.

Resistive zones need not be linear as depicted, but rather may be of any shape. For example, for desired effects, one might choose a resistive zone that is zigzagged, curved or irregularly shaped along adjacent tinting zones.

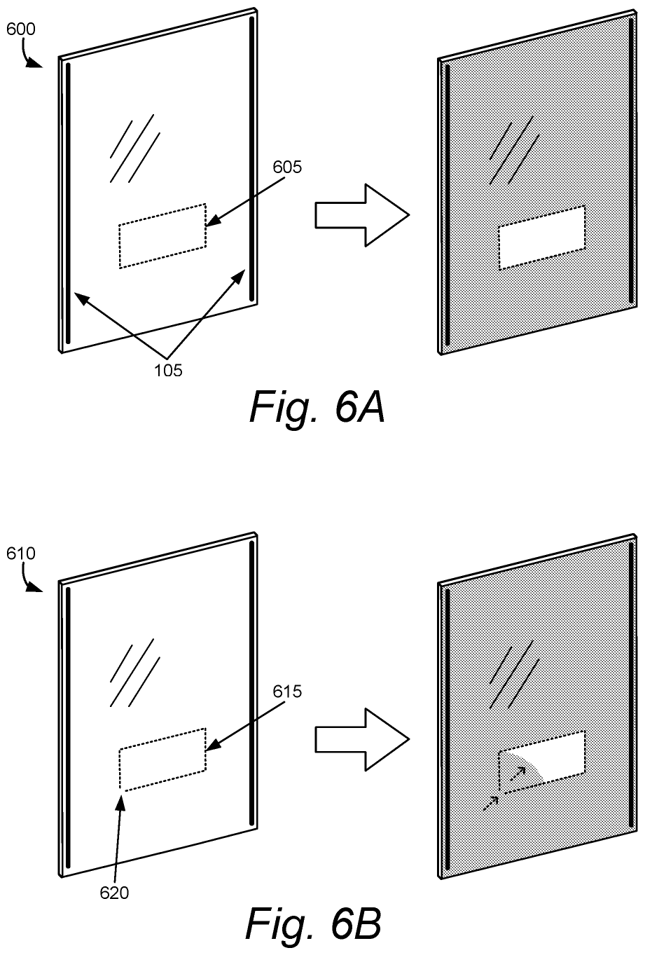

In certain embodiments, resistive zones are used to define a perimeter, closed or open, of a region of an EC window, that is, a sub-portion (area) of a monolithic EC device. For example, these resistive zones can be used to highlight particular symbols or shapes in the viewable region of the EC window. One embodiment with such a resistive zone is illustrated in FIGS. 6A and 6B. For example, an end user may wish to have an area of the EC window that does not tint, or that becomes tinted more slowly, than the remainder of the tintable EC window.

FIG. 6A depicts an EC lite, 600, which includes a single pair of bus bars, 105, as well as a resistive zone, 605. In this example, the resistive zone is in the shape of a closed rectangle (as indicated by the dotted line). Resistive zone 605 may not be visually discernible to the naked eye. In one embodiment, resistive zone 605 is configured such that the portions of the TCOs of the EC device in the resistive zone (as indicated by the dotted line) have a higher electrical resistance than the portions of the TCOs in the remainder of the EC device on either side of the resistive zone (in this example both outside and inside the rectangular perimeter zone), but the resistive zone still passes charge. In this embodiment, when the EC device is tinted, the area around the resistive zone 605 tints first, the tinting front slowing when it reaches the rectangular closed resistive zone 605. This momentarily, e.g. for a period of minutes, gives the effect of a small untinted view port in a larger tinted window. As the charge bleeds beyond the resistive zone and into the untinted rectangular region within the zone, this gives the effect of the small untinted view port closing as it tints. In another embodiment, resistive zone 605 is configured such that the portions of the TCOs of the EC device in the resistive zone (as indicated by the dotted line) have a very high resistance to electrical charge as compared to the portions of the TCOs in the remainder of the EC device on either side of the resistive zone (in this example both outside and inside the rectangular perimeter zone), that is, the resistive zone effectively blocks electrical charge. In this embodiment, when the area outside the zone is tinted, the area inside the zone may never tint because the charge may not be able to pass the resistive barrier 605. This gives the effect of a small untinted view port in a larger tinted window, so long as the EC device is tinted. In another embodiment, resistive zone 605 is configured such that the portions of the TCOs of the EC device in the resistive zone (as indicated by the dotted line) and in the region within the resistive zone have a very high resistance to electrical charge as compared to the portions of the TCOs in the remainder of the EC device on the outside of the resistive zone.

FIG. 6B shows a similar EC lite, 610, having a resistive zone, 615, which is “open” by virtue of a gap, 620, in the perimeter. In this example, the resistive zone 615 is configured to block electrical charge. When the EC device is tinted, the area around the resistive zone 615 tints first, the tinting front slowing when it reaches the rectangular closed resistive zone 615, except at the open portion 620, where the tinting front gives the effect of “pouring in” or “filling in” (as indicated by the two dotted arrows) the rectangular region within resistive zone 615. Eventually, when the area inside resistive zone 615 is tinted, resistive zone 615 may no longer be discernible to the naked eye, as the EC device colors under the zone, as described above. Configuring resistive zones in such a way can be used to achieve permanent or transient tinting effects on EC windows, e.g., to display a logo or words in a transient manner for presentation during marketing purposes, or to achieve tinted and non-tinting zones on an EC lite. EC lites so configured can be incorporated into IGUs as describe and/or laminated with mate lites.

### Multi-EC Lite Patterns

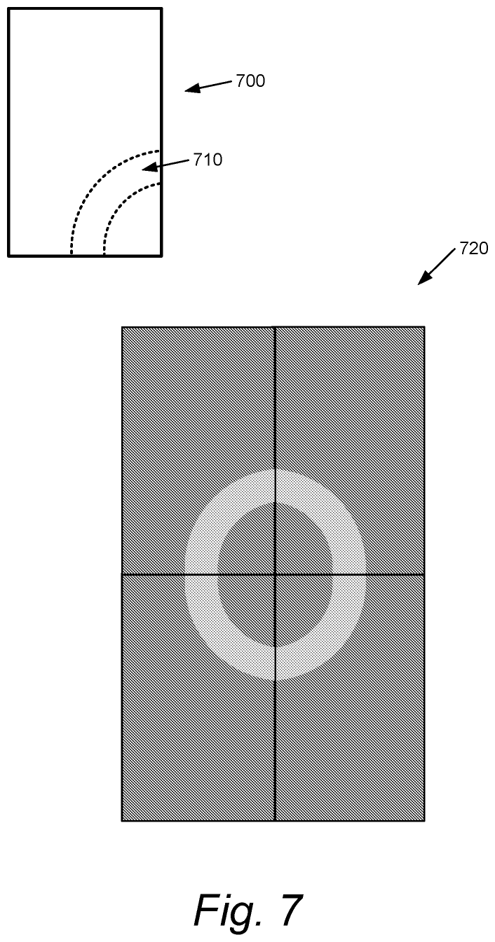

Embodiments described can also be used to create patterns that encompass more than one IGU, laminate or other construct containing one or more monolithic EC lites. For example, as depicted in FIG. 7, an EC lite, 700, is configured with a resistive zone or zones, such that a portion, 710, of the EC lite does not color, or colors less intensely than the bulk device (the dotted lines are only to depict where the portion 710 is on the EC lite). Four similarly configured lites 700 are arranged so that when colored, they form a display, such as the letter “O” in this example.

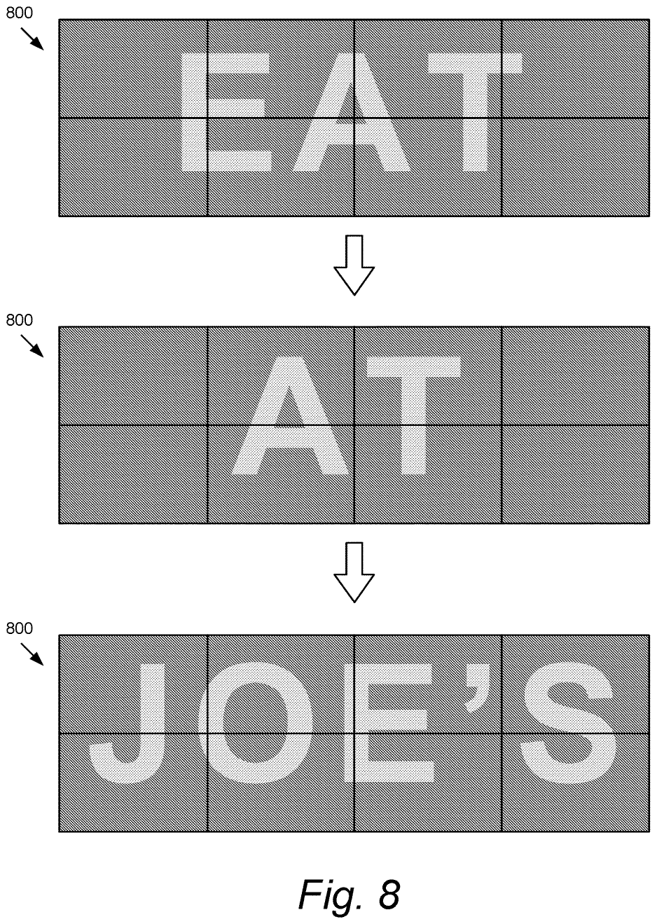

Many such lites can be configured for display purposes, e.g. on a curtain wall or façade of a building for advertising purposes. Since EC monolithic EC lites can be made quite large, e.g., 6 feet×10 feet, very large words, symbols, ornamental designs and the like can be made for retail facades, schools, military installations, airports and the like. Moreover, since e.g. laminates and/or IGUs can have two or more registered EC lites, and each EC lite of any laminate and/or IGU can have tinting features as described herein, many possibilities for changing words, symbols and/or ornamental designs are possible. For example, as depicted in FIG. 8, a glass facade, 800, has eight 5′×10′ triple pane IGUs, each IGU having three EC lites, each EC lite is patterned with resistive zones such that different words can be displayed on the facade. In this example, the letters of the words are approximately 6′ high, however any pattern, size or arrangement is possible. In one embodiment, the facade includes a “normal” mode where no words are displayed, rather the glass is tinted uniformly across all eight IGUs. The multi-EC lite pattern can be used for skylights, facades, or any place where such displays are desired, e.g. in large skylights at airports or other buildings, words and/or symbols, changing or not, can be communicated to aircraft.

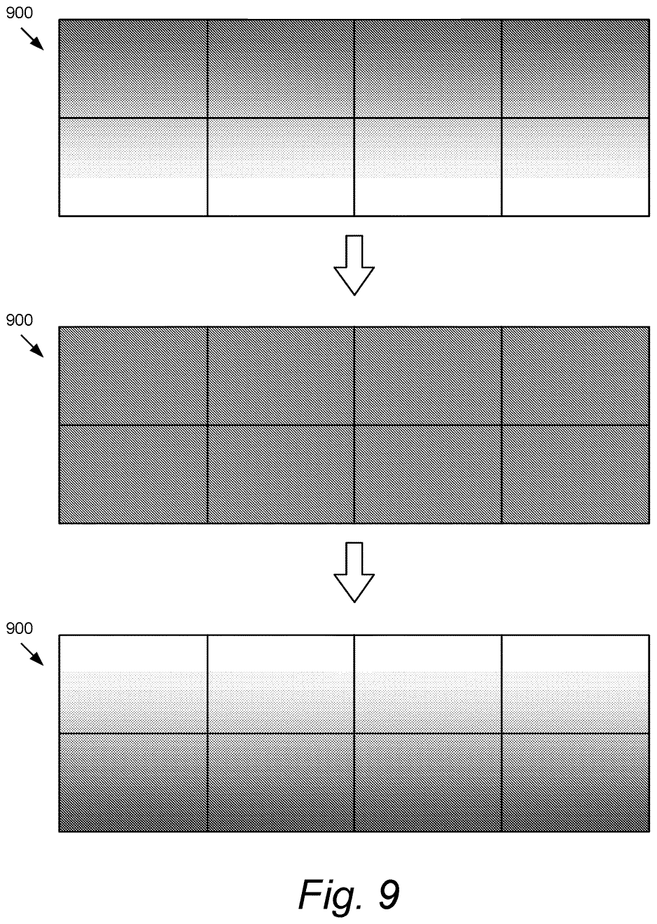

Gradient zoning can also be done across multiple EC lites, e.g. laminates and/or IGUs, for example as depicted in FIG. 9. FIG. 9 depicts a glass facade, 900, having eight 5′×10′ IGUs. In this example, each IGU has a single EC lite, each configured with a monolithic EC device coating and appropriate bus bars and electrical control (e.g. dual feed bus bars as described above) so that each IGU can fully bleach, fully tint, or create gradient coloration across the entire monolithic EC coating. Referring again to FIG. 9, the facade can be made to tint in a gradient from dark to light, from top to bottom, respectively (top façade), tint uniformly across all IGUs (middle façade) or e.g. tint in a gradient from dark to light, from bottom to top, respectively.

### Additional Tint Gradient Configurations

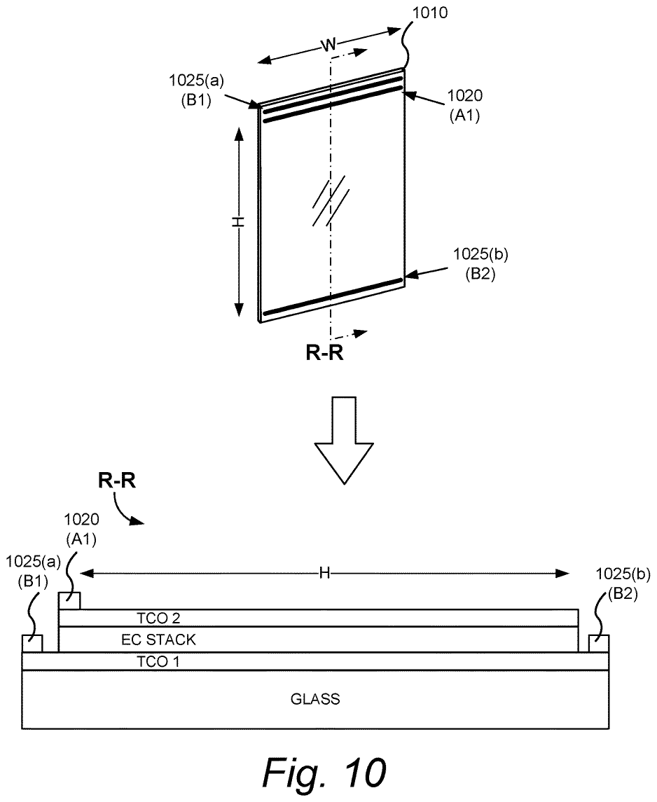

As noted above, a window with a monolithic EC device, at least one pair of bus bars on one TCO layer, and at least one bus bar on the other TCO layer as provided herein, without a resistive zone, may be used to produce and control various characteristics of a tint gradient. FIG. 10 depicts a perspective and a cross section of an EC device, EC lite 1010, similar to FIG. 5D. Here, two bus bars 1025(a) and 1020 are located at the top of the window and one bus bar 1025(b) is located at the bottom of the window. In the depicted embodiment, these three bus bars run along the width W of the EC lite 1010. As seen in the cross-sectional view in the bottom portion of FIG. 10, taken along line R-R, the EC lite 1010 has a first pair of bus bars 1025(a)/(B1) and 1025(b)/(B2) located on a first transparent conducting oxide layer, TCO 1, and a bus bar 1020/(A1) located on a second transparent conductive oxide layer, TCO 2. Cross-section R-R is not to scale, but rather is a schematic representation of the structure of EC lite 1010. Sandwiched in-between TCO 1 and TCO 2 is an EC stack which contains one or more electrochromic materials, e.g., the transitions of which are driven by intercalation/de-intercalation of ions, such as lithium ions.

With at least the configuration of FIG. 10, the EC lite 1010 can be tinted, including tinting with a tint gradient, and various attributes of the tinting and tint gradient can be controlled. In some implementations, as described below, creating a voltage gradient across TCO 1 between bus bars 1025(a) and 1025(b) while maintaining a constant voltage on TCO 2 is capable of causing the EC lite 1010 to tint along at least some of the length, or height H, of the EC lite 1010. The EC lite 1010 tints when ions flow between the TCO layers through the thickness of the EC stack, and this ion flow occurs when a potential is created between the two TCO layers. Each TCO layer has an inherent sheet resistance and when a voltage gradient is created along the height H of a TCO layer, such as TCO 1, the voltage decreases along the height H of the TCO layer which in turn decreases the ion flow and thus decreases the tinting, thereby creating a tint gradient. In some implementations of the configuration of FIG. 10, a tint gradient can be creating along the height H by the combination of creating a voltage gradient across TCO 1, the inherent resistance of the TCO 1 layer, and the equipotential of TCO 2.

The tinting created by the EC lite 1010 may have independent characteristics that can be controlled by voltages applied to the bus bars of EC lite 1010. These independent tint characteristics include (i) the location of the tint front, (ii) the abruptness or gradient of the tint front transition between the tinting and non-tinting, clear area, and (iii) the depth to which the darkest portion of the EC device tints. As noted above, a “tint front” or “tinting front” can refer to an area of the EC device where the potential applied across the devices TCOs by the bus bars reaches a level that is insufficient to tint the device (e.g. by movement of ions through the layers of the device to balance charge). A location of a tint front may not be an exact and/or linear location, but instead may be considered an average nominal position on the EC device. For example, referring back to FIG. 3C, the tint front 310 is nonlinear and curved, thereby causing it to have multiple, actual tint front locations and the “tint front location” for these tint fronts 310 can be averaged to a single, average nominal location along the curve, such as a linear location.

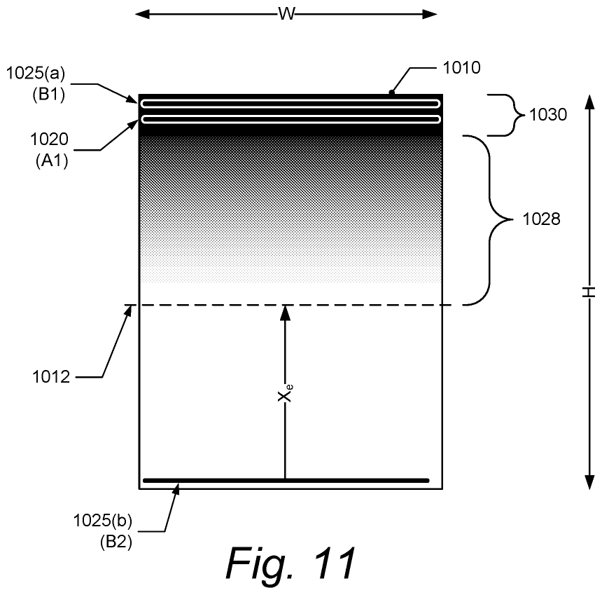

The various tinting attributes are further illustrated in FIG. 11 which depicts a front view of the EC lite 1010 of FIG. 10 in an exemplary tinted state. Here, the EC lite 1010 is tinted in a first tint state having a tint front 1012, which is the average, nominal tint front represented by dashed line 1012, at a tint front location X as measured from the bottom, single bus bar 1025(b). The tinting also has a tint transition region 1028 where the tint transitions between tinting and non-tinting (this may also be considered a tint gradient area), and a darkest tint area 1030 where the tinting is the darkest. It is one or more of these tinting attributes that may be controlled and adjusted by, for example, adjusting the voltages applied to the bus bars.

Control of the tint front location will now be discussed. In some implementations, for EC lite 1010 of FIGS. 10 and 11, the tint front location or position, as measured from the bottom, single bus bar 1025(b), can be represented by a relationship between the voltage drop between (i) the two bus bars 1025(a) and 1025(b) on TCO 1 and (ii) the voltage of the bus bar 1020 on TCO 2. This relationship may be represented by the following formula:

$$\frac{{x}_{e}}{h} = \frac{{V}_{threshold} - V ( B 2 ) + V ( A 1 )}{V ( B 1 ) - V ( B 2 )}$$

In this formula, Xe represents the tint front location Xe in FIG. 11, h represents the height H of the EC lite in FIGS. 10 and 11, which may be the distance between bus bars 1025(a) and 1025(b) on TCO 1, V_{threshold} represents the threshold voltage needed to create a tint or coloration in the EC device, V(A1) is the voltage at, or applied to, the bus bar on TCO 2, such as bus bar 1020 in FIG. 10, V(B1) is the voltage at, or applied to, the bus bar on TCO 1 that is proximate to the bus bar on TCO 2, such as bus bar 1025(a) in FIG. 10, and V(B2) is the voltage at, or applied to, the bus bar on the opposite end of the EC device, such as bus bar 1025(b) in FIG. 10. These additional A1, B1, and B2 labels are included in FIGS. 10 and 11. According to this relationship, in some embodiments, this tint front location may be inversely proportional to the voltage drop between bus bars 1025(a) and 1025(b) on TCO 1, i.e., between V(B1) and V(B2), and proportional to the voltage V(A2) of the bus bar 1020 on TCO 2. For example, the tint front location Xe increases as the voltage drop across TCO 1 decreases, and/or increases as the voltage applied to bus bar on TCO 2, 1020/(A1) increases, thereby causing the tint front location to become farther from bus bar 1025(b)/(B2).

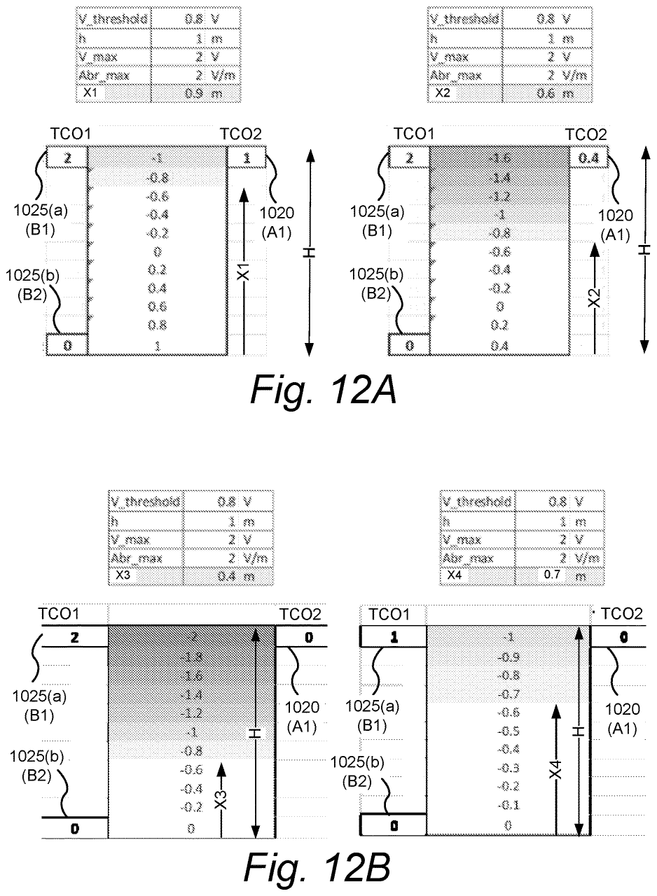

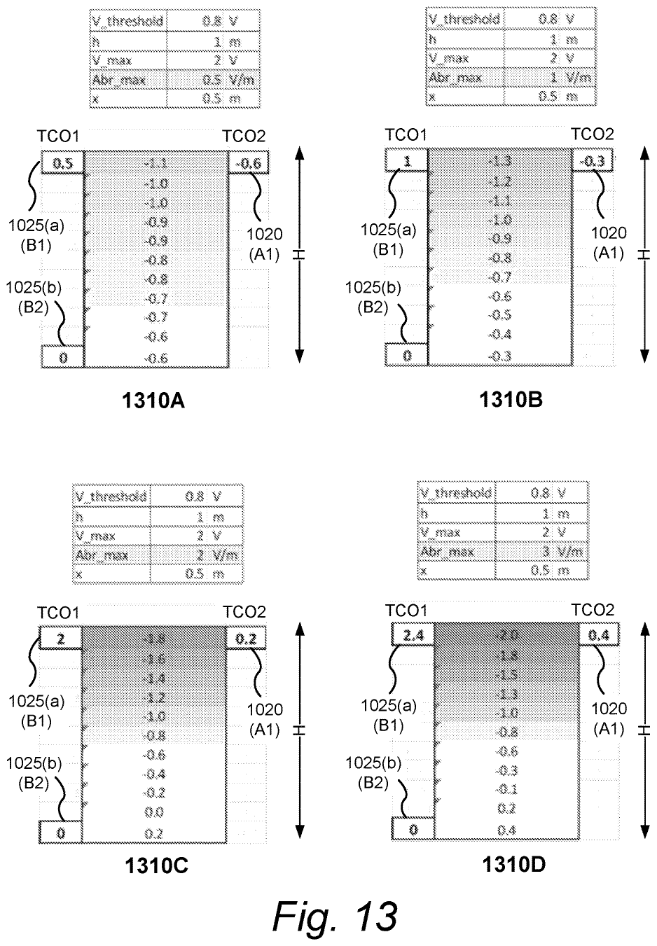

The positioning of the tint front according to this relationship is illustrated in FIGS. 12A and 12B. FIG. 12A depicts a first example illustration of repositioning a tint front location on the EC device of FIGS. 10 and 11, and FIG. 12B depicts a second example illustration of repositioning a tint front location on the EC device of FIGS. 10 and 11. In FIG. 12A, two schematic representations of the EC lite 1010 of FIGS. 10 and 11 are provided which depict the bus bars 1025(a)/(B1) and 1025(b)/(B2) positioned on TCO 1, along with the bus bar 1020/(A1) positioned on TCO 2 and in close proximity to bus bar 1025(a)/(B1), e.g., at the same end of the EC lite 1010. Some operating parameters are provided above each schematic, including the height “h” of the EC lite as 1 meter and the V_{threshold} as 0.8 V. The numbers associated with each labeled bus bar indicate the voltage applied, or not applied, to the respective bus bar and the numbers in the middle of the EC device indicate the voltage of, applied to, or seen by the EC device at various locations along the height “h”.

As can be seen in FIG. 12A, in the left schematic a voltage of 2 V is applied to bus bar 1025(a)/(B1) and a voltage of 0 V, such as a ground, is applied to bus bar 1025(b)/(B2), thereby creating a voltage drop of 2 V along TCO 1. A voltage of 1 V is applied to bus bar 1020/(A1) on TCO 2, thereby creating a voltage differential between TCO 1 and TCO 2. The resulting tint front location in the left schematic is at a distance X1 from the bottom bus bar 1025(b)/(B2). In the right schematic, TCO 1 has the same voltages, but the equipotential applied to TCO 2 is different than the left schematic; a voltage of 0.4 V is applied to bus bar 1020/(A1) on TCO 2, thereby creating a larger voltage differential between TCO 1 and TCO 2. The resulting tint front location in the right schematic is at a distance X2 from the bottom bus bar 1025(b)/(B2) which is less than the distance X1. With these voltages in FIG. 12A, the EC device is also caused to tint beginning at the location between the two bus bars on opposite TCOs where the voltage differential is greatest, i.e., the top end where bus bars 1025(a)/(B1) and 1020/(A1) are located.

As further illustrated in FIG. 12A, the voltage differential between TCO 1 and TCO 2 decreases along the length of the EC device given, for instance, the sheet resistance and voltage drop along TCO 1, such that the voltage differential between the two TCO layers reaches a location where it cannot overcome the V_{threshold} necessary to color the EC device. Here, once the voltage differential between TCO 1 and TCO 2 drops below the threshold voltage of 0.8 V, the EC device no longer tints. This transition may be considered the location of the tint front. According to the relationship above, when the listed voltages are applied to the bus bars as illustrated, the tint front Xe (in the formula; X1 and X2 in the Figure) moves location or is repositioned. For instance, in FIG. 12A the voltage drop across TCO 1 is maintained at a substantially constant voltage drop while the voltage applied to the bus bar 1020/(A1) on TCO 2 is greater in the left schematic than in the right schematic, and the resulting tint front location X1 in the left schematic is therefore greater than the tint front location X2 in the right schematic. This illustrates that the position of the tint front location may be proportional to voltage applied to the TCO with the single bus bar, e.g., TCO 2 with bus bar 1020/(A1). Based on this, adjusting the voltage applied to TCO 2 with the single bus bar 1020/(A1), i.e., the TCO with the equipotential voltage, repositions the average nominal tint front location.

As further illustrated in FIG. 12A, in some implementations, the tint front location may also be characterized as dependent on the voltage differential between the two bus bars that are proximate to each other but on the different TCO layers, such as bus bars 1025(a)/(B1) and 1020/(A1). Adjusting this voltage differential may move or reposition the tint front location. For example, referring to FIG. 12A, the voltage differential between bus bars 1025(a)/(B1) and 1020/(A1) in the left schematic is 1 V and in the right schematic is 1.6 V, and the tint front location is repositioned as a result of this adjusted voltage differential between proximate bus bars on different TCO layers. As shown, the lower the voltage differential, the greater the tint front distance, with the lower differential creating distance X1 in the left schematic that is greater than distance X2 created by the higher differential in the right schematic.

In FIG. 12B, the voltage drop across the TCO layer with two bus bars on opposite ends, i.e., TCO 1 and bus bars 1025(a)/(B1) and 1025(b)/(B2), is adjusted which repositions the tint front in a new average nominal position. In the left schematic, the voltage applied to the first bus bar 1025(a)/(B1) on TCO 1 is 2 V, and the voltage applied to second bus bar 1025(b)/(B2) on TCO 1 is 0 V, therefore creating a voltage drop across TCO 1 of 2V, while the voltage applied to bus bar 1020/(A1) on TCO 2 is 0 V. The resulting tint front location in the left schematic is at a distance X3 from the bottom bus bar 1025(b)/(B2). In the right schematic, the only adjustment or change is to the voltage drop on TCO 1 decreasing to 1 V; the voltage applied to the first bus bar 1025(a)/(B1) on TCO 1 is 1 V and the voltage applied to the second bus bar 1025(b)/(B2) on TCO 1 is 0 V, therefore creating a voltage drop across TCO 1 of 1 V. The resulting tint front location in the left schematic is at a distance X4 from the bottom bus bar 1025(b)/(B2) that is greater than X3. As can be seen, given the nature of the relationship above, these two schematics in FIG. 12B illustrate the inverse relationship between tint front location and voltage drop on TCO 1, with the tint front location or distance from bus bar 1025(b)/(B2) increasing as the voltage drop decreases. Here in FIG. 12B, the tint front location X3 is less in the left schematic than the tint front location X4 in the right schematic, while the voltage drop on TCO 1 is greater in the left schematic than in the right schematic. Based on this, adjusting the voltage drop across TCO 1 with two bus bars 1025(a)/(B1) and 1025(b)/(B2) on opposite ends of the EC device repositions the average nominal tint front location.

In some embodiments, the average nominal tint front location may be repositioned by one or more of adjusting the voltage drop across TCO 1 and between bus bars 1025(a)/(B1) and 1025(b)/(B2), i.e., the voltage drop between the two bus bars on the same TCO, adjusting the equipotential voltage of TCO 2, i.e., the voltage applied to the single bus bar 1020/(A1) on TCO 2, or a combination thereof.

As noted above, another attribute of the tinting that can be adjusted is the tint state of the darkest portion of the tinting, which may also be referred to as the depth of tinting. Referring back to FIG. 11, this section of the tinting is area 1030 that has the greatest depth of tinting. In some implementations, the darkest portion of the tinting may be directly related to the maximum potential difference between the two TCO layers, e.g., TCO 1 and TCO 2. Using the EC lite 1010 of FIGS. 10 and 11, the relationship between maximum tint depth may be characterized by:

$$Max depth of tint ∝ maximum [ ( V ( B 1 ) - V ( A 1 ) ) , ( V ( B 2 ) - V ( A 1 ) ) ]$$

Here, like above, with respect to FIGS. 10 and 11, “V(B1)” is the voltage applied to bus bar 1025(a)/(B1) on TCO 1 at the top of the window, “V(B2)” is the voltage applied to bus bar 1025(b)/(B2) on TCO 1 at the opposite, bottom end of the window, and “V(A1)” is the voltage applied to the bus bar 1020/(A1) on TCO 2. Referring back to FIG. 12A, this relationship is illustrated with the depicted voltages on the bus bars and TCOs. As can be seen, the left schematic has a maximum potential difference between the TCO layers of 1 V, (i.e., a maximum[(2−1), (0−1)] is 1) and therefore a tint depth of 1 between bus bars 1025(a)/(B1) and 1020/(A1), while the right schematic has a maximum potential difference between the TCO layers of 1.6 V (i.e., a maximum[(2−0.4), (0−0.4)] is 1.6) between bus bars 1025(a)/(B1) and 1020/(A1). According to the above relationship, the right schematic's greater maximum potential different between TCO layers results in a higher depth of tint than the left schematic and its lower maximum potential between the TCO layers. As mentioned above, the numbers within the EC device itself (e.g., the 11 numbers within the box with −1.6 at the top and decreasing to 0.4 at the bottom) represent, at least in part, the tint depths of the EC lite along the length H, with the maximum tint occurring where the two adjacent bus bars on different TCOs are located, i.e., bus bars 1025(a)/(B1) and 1020/(A1).

FIG. 12B also illustrates the above relationship such that the left s schematic has a maximum potential difference between the TCO layers of 2 V, (i.e., a maximum[(2−0), (0−0)] is 2) and therefore a tint depth of 2 between bus bars 1025(a)/(B1) and 1020/(A1), while the right schematic has a maximum potential difference between the TCO layers of 1 V (i.e., a maximum[(1−0), (0−0)] is 1) between bus bars 1025(a)/(B1) and 1020/(A1). According to the above relationship, the left schematic's greater maximum potential different between TCO layers results in a higher depth of tint than the right schematic and its lower maximum potential between the TCO layers. In some embodiments, depth of tint may therefore be adjusted by adjusting the maximum potential difference between the two TCOs.

Yet another attribute of the tinting that can be adjusted is the abruptness of the transition between the clear and tinted portions of the EC device. This abruptness may be considered a gradient or a part of a tinting gradient. FIG. 11 illustrates this gradient area 1028 on the EC device. In some embodiments, this abruptness is related to and dependent upon the voltage drop in the TCO with two bus bars, i.e., TCO 1 having bus bars 1025(a)/(B1) and 1025(b)/(B2). A relationship between this tint transition abruptness and the TCO layer voltage drop may be characterized by the following:

$$Transition abruptness {∝}_{V ( B 1 ) - V ( B 2 )}$$

Like above, “V(B1)” is the voltage applied to bus bar 1025(a)/(B1) on TCO 1 at the top of the window and “V(B2)” is the voltage applied to bus bar 1025(b)/(B2) on TCO 1 at the opposite, bottom end of the window. In some implementations, the transition abruptness may be increased by increasing the voltage drop across TCO 1. FIG. 13 depicts an example illustration of adjusting a tint transition abruptness on the EC device of FIG. 10. Here in FIG. 13, four EC device schematics are shown and labeled 1310A-D. The EC device is the same as that in FIGS. 10-12B, such that TCO 1 includes two bus bars, bus bar 1025(a)/(B1) on the top end and bus bar 1025(b)/(B2) on the opposite, bottom end, and TCO 2 includes one bus bar 1020/(A1) at the same end as bus bar 1025(a)/(B1). Above each schematic are additional parameters for that schematic including the tint front location “x” (like Xe provided above) and the transition abruptness “Abr_max” that results from the applied voltages using the above relationship. As can be seen, the tint front location X remains substantially the same in each schematic, i.e., at about 0.5 m, and the voltage drop across TCO 1 is adjusted from 0.5 V in schematic 1310A, to 1 V in schematic 1310B, to 2 V in schematic 1310C, and to 2.4 V in schematic 1310D. As can be seen, increasing the voltage drop across TCO 1 results in increasing the abruptness of the tint transition. This increasing of the abruptness may also be considered changing the tint gradient and/or increasing the depth of the tint gradient.

The relationships provided above may be used to control the EC device of FIG. 10 in various manners in order to produce desired tint attributes. As provided above, the voltages applied to each bus bar, including a voltage of 0V or ground, and their various relationships are the elements that create and drive the EC device's tinting and the resulting attributes of this tinting. The voltages applied to each bus bars are therefore the independently controllable variables that can be adjusted and controlled to produce the one or more tint attributes. The one or more tint attributes may be selected or determined and then inserted into the above relationships to determine the necessary voltage(s) for producing such attributes. Accordingly, the relationships provided above may be rewritten in order to solve for a necessary bus bar voltage given a desired, set, or determined tint attribute. In the rewritten relationships, the tint attributes become the independent variables and one or more voltages become the dependent variables. The above relationships may be rewritten into the following two equations that can return the necessary voltage(s) applied to TCO 1, e.g., to bus bar 1025(a)/(B1), and to TCO 2, e.g., bus bar 1020/(A1) for producing a given tint front location, a given tint depth, and/or a tint gradient (or transition abruptness) level.

$$V ( B 1 ) = minimum ( {Abr}_{max} \times h , \frac{{V}_{max} - {V}_{threshold}}{( 1 - \frac{x}{h} )} ) \qquad ( 1 )$$

$$V ( A 1 ) = ( V ( B 1 ) \times \frac{x}{h} ) - {V}_{threshold} \qquad ( 2 )$$

In the first equation, the voltage applied to TCO 1 bus bar 1025(a)/(B1) is the dependent variable while tint front location “x” and the tint gradient “Abrₘₐₓ” are independent variables. In the second equation, the voltage applied to the TCO 2 bus bar 1020/(A1) is the dependent variable while tint front location “x” and the voltage applied to TCO 1 bus bar 1025(a)/(B1) are independent variables. These relationships can therefore determine the voltages necessary for producing one or more given or determined tint attributes, tint front location “x” and/or tint gradient “Abrₘₐₓ”. In these examples, the voltage applied to “V(B2)” or bus bar 1025(b)/(B2) is ground or 0 V.

For example, a tint front location of 0.6 m may be determined or selected by a user so that the EC device tints with a tint front location at this location (e.g., as measured from the bottom bus bar 1025(b)/(B2) in FIGS. 10 and 11), and the necessary voltage(s) for each bus bar on the TCO layers are needed. Referring back to FIG. 12A in the right schematic, for instance, in order for the tint front to be located at 0.6 m as indicated above the right schematic, these relationships may return a required or necessary voltage to be applied to TCO 1 bus bar 1025(a)/(B1) of 2 V and a required or necessary voltage applied to the TCO 2 bus bar 1020/(A1) of 0.4 V. In another example, a tint gradient level (or tint abruptness) of medium, e.g., 1 V/m, may be selected and again, the necessary voltage(s) are needed for producing such a tint gradient level. Referring back to FIG. 13, schematic 1310B, for instance, in order for the tint gradient level to be at this level, these relationships may return a required or necessary voltage to be applied to TCO 1 bus bar 1025(a)/(B1) of 1 V and a required or necessary voltage applied to the TCO 2 bus bar 1020/(A1) of −0.3 V. In yet another example, a depth of tint of heavy, e.g., 2 V, may be selected and the necessary voltage(s) are needed for producing this depth may be, according to the above relationships, a voltage applied to TCO 1 bus bar 1025(a)/(B1) of 2 V and a voltage applied to the TCO 2 bus bar 1020/(A1) of 0 V as shown in the left schematic of FIG. 12B.

Provided herein are various techniques for tinting an EC device of FIGS. 10 and 11 in order to produce desired tint attributes. As provided above, some embodiments may begin by first determining one or more tint attributes or characteristics that are desired or intended; this determining may be based on a user's selection, a detection or signal by one or more sensors, a time-based selection, or other parameter. Given the one or more determined attributes, the necessary voltages may be set or applied at each of the bus bars in order to produce such determined attributes given the relationships above. In some implementations, additional determinations may be made to determine the values of the voltages that are to be applied at each bus bar in order to produce the one or more tint attributes. Alternatively, or additionally, some embodiments may include associating one or more determined tint attributes with a previously determined or set voltage profile that may be stored in a look-up table or other information stored on a memory of a controller.

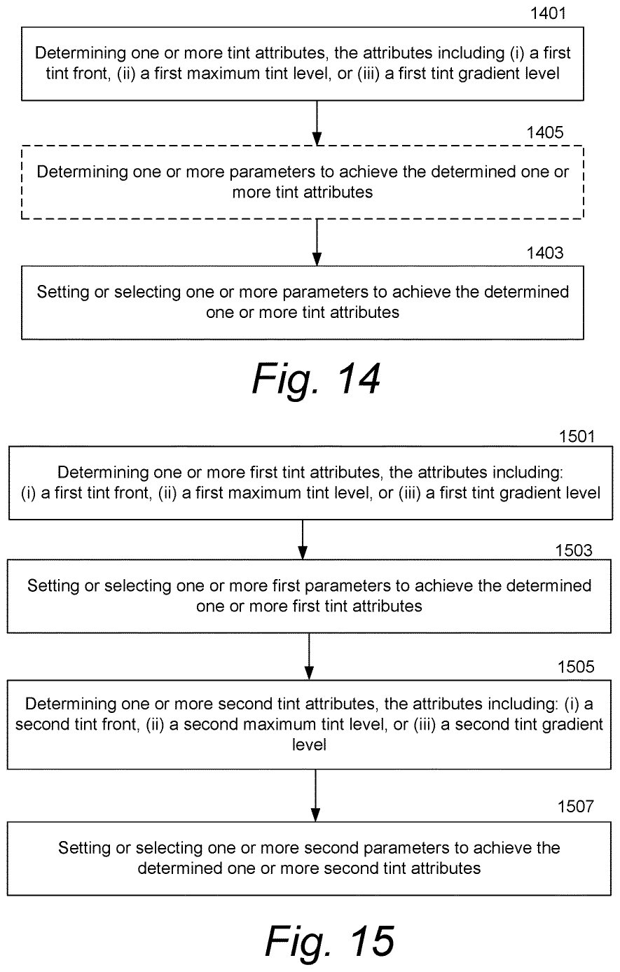

FIG. 14 depicts an example technique for tinting an EC window having the structure of FIG. 10. In block 1401, a determination of one or more tint attributes for tinting the EC device is performed, with the one or more tint attributes including (i) a tint front location, (ii) a maximum tint level, (iii) a tint gradient level, or a combination thereof. This determination may be based, at least in part, on a user input, signals from one or more controllers, signals from one or more sensors, or a combination thereof, for instance. In block 1403, one or more parameters are set and/or selected to achieve the determined one or more attributes. As provided above, with respect to the EC device of FIG. 10, the one or more parameters may include a first voltage drop across TCO 1, a first voltage to one of the bus bars on TCO 1 (such as bus bar 1025(a)/(B1)), a second voltage to the other bus bar on TCO 1 (such as bus bar 1025(b)/(B2)), a third voltage to the single bus bar on TCO 2, a potential differential between one bus bar on TCO 1 and a bus bar on TCO 2 (such as bus bars 1025(a)/(B1) and 1020 (A1)), or a combination thereof. Referring to one of the above described examples also illustrated in the right schematic of FIG. 12A, a tint front location of 0.6 m may be determined or selected by a user in block 1401 and the setting or selecting one or more parameters of block 1403 may include setting the voltage(s) for each bus bar in order to cause the EC lite to tint with a tint front at this location. This may include, for instance, applying a voltage of 2 V to TCO 1 bus bar 1025(a)/(B1), setting a voltage of 0 V to the other TCO 1 bus bar 1025(b)/(B2), and applying a voltage of 0.4 V to the TCO 2 bus bar 1020/(A1) as illustrated in the right schematic of FIG. 12A.

In some implementations, an additional determining step may be provided that determines the one or more parameters that result in the desired one or more tint attributes. FIG. 14 includes optional block 1405 in which this determination is made. In some embodiments, the determining may include applying the determined tint attributes in block 1401 to one or more of the relationships of the EC device provided above, including those that have the voltage applied to TCO 1 bus bar 1025(a)/(B1) and the voltage applied to the TCO 2 bus bar 1020/(A1) as dependent variables, for example. This determining may also include accessing data in a look-table or other association between a desired tint attribute and one or more voltages necessary to achieve that tint attribute.

The setting or selecting the one or more parameters to achieve the determined one or more tint attributes in block 1403 of FIG. 14 may be performed in various manners. For example, as explained above, for the tint attribute of a tint front location at a particular position in a viewable area of the EC device, some embodiments may achieve this tint attribute by creating a voltage drop, as referenced to the EC device of FIG. 10, between the two bus bars on TCO 1, i.e., bus bar 1025(a)/(B1) and bus bar 1025(b)/(B2). This may include applying one voltage to one of the bus bars on TCO 1 and setting the other bus bar on TCO at ground, or applying different non-zero voltages to each bus bar on TCO 1, such as 2 V to bus bar 1025(a)/(B1) and 1 V to bus bar 1025(b)/(B2). In some embodiments, setting a tint front location may additionally, or alternatively, include setting or applying a particular voltage to, or at, the bus bar of TCO 2, and/or creating a potential differential between the two TCO layers, i.e., TCO 1 and TCO 2 of FIG. 10. Various examples of the creation, application, and adjustment of voltages to achieve a desired tint front location are described above and shown in FIGS. 12A and 12B, for instance.

In additional example, as explained above, for the tint attribute of a particular maximum tint depth in a viewable area of the EC device, some embodiments may achieve this tint attribute by creating a potential difference, as referenced to FIG. 10, between the two TCO layers, i.e., TCO 1 and TCO 2. This potential difference may be created, in some instances, by applying one voltage to one of the bus bars on TCO 1 and applying a different voltage to the bus bar on TCO 2, or by applying one voltage to one of the bus bars on TCO 1 and setting the voltage on the TCO 2 bus bar to ground, or 0 V. Various examples of the creation, application, and adjustment of voltages to achieve a desired maximum tint gradient are described above and shown in FIGS. 12A, 12B, and 13, for instance.

In additional example, as explained above, for the tint attribute of a particular tint gradient, or abruptness of the tint transition, in a viewable area of the EC device, some embodiments may include achieve this tint attribute by creating a voltage drop, as referenced to the EC device of FIG. 10, between the two bus bars on TCO 1, i.e., bus bar 1025(a)/(B1) and bus bar 1025(b)/(B2). This may include applying one voltage to one of the bus bars on TCO 1 and setting the other bus bar on TCO at ground, or applying different non-zero voltages to each bus bar on TCO 1, such as 2 V to bus bar 1025(a)/(B1) and 1 V to bus bar 1025(b)/(B2). Various examples of the creation, application, and adjustment of voltages to achieve a desired tint gradient are described above and shown in FIG. 13, for instance.

Some embodiments provided herein may also adjust or change an EC device's tint profile from one profile to a second tint profile that includes one or more different tint attributes. Some such implementations may include adjusting or changing a tint front location, a tint gradient abruptness, a maximum tint depth, or a combination thereof. These changes or adjustments may be made using the relationships provided above and adjusting or changing the voltage applied to, or set at, one or more bus bars. FIG. 15 depicts another example technique for tinting an EC window having the structure of FIG. 10. Blocks 1501 and 1503 may be the same as blocks 1401 and 1403 in the technique of FIG. 14. In some embodiments, although not depicted, the technique of FIG. 15 may also include the optional determining step of block 1405.

In block 1501, a determination of one or more tint attributes for tinting the EC device is performed, with the one or more tint attributes including (i) a first tint front location, (ii) a first maximum tint level, (iii) a first tint gradient level, or a combination thereof. In block 1503, one or more parameters are set and/or selected to achieve the determined one or more attributes including, for example, a first voltage drop across TCO 1, a first voltage to one of the bus bars on TCO 1 (such as bus bar 1025(a)/(B1)), a second voltage to the other bus bar on TCO 1 (such as bus bar 1025(b)/(B2)), a third voltage to the single bus bar on TCO 2, a potential differential between one bus bar on TCO 1 and a bus bar on TCO 2 (such as bus bars 1025(a)/(B1) and 1020/(A1)), or a combination thereof.

Following block 1503, the tinting of the EC device may be adjusted by changing one or more attributes of the tinting. In block 1505 one or more second tint attributes are determined. Similar to above, this determination may be based on a user selection or input, a signal from a sensor or controller, or other information. For example, a user may select a different tint front location to account for the sun moving during the day, or the maximum tint depth may be decreased at the end of a day to allow for more light in a room. In block 1505, the one or more second tint attributes may be different than the one or more first tint attributes, including a different tint front, maximum tint depth, and/or tint transition abruptness.

In block 1507, one or more second parameters to achieve the determined one or more second tint attributes are set or selected. As provided above, changing a voltage value to one or more of the bus bars may result in changing one or more of these tint attributes. For example, in order to reposition a tint front location to a second tint front location different than a first tint location, some embodiments may include changing the voltage drop, as referenced to the EC device of FIG. 10, of the TCO 1, i.e., the voltage drop between the two TCO 1 bus bars 1025(a)/(B1) and bus bar 1025(b)/(B2). This may include changing the value of a voltage applied to one of these bus bars, while setting the other bus bar at ground or at a different voltage than the other bus bar. In some embodiments, repositioning a tint front location to a second, different position may additionally, or alternatively, include adjusting the voltage applied to, or set at, the bus bar of the other TCO layer, e.g., TCO 2 and/or the potential differential between the two TCO layers, i.e., TCO 1 and TCO 2 of FIG. 10. Examples of the creation, application, and adjustment of voltages to achieve repositioning of tint front locations are described above and shown in FIGS. 12A and 12B, for instance. In some embodiments, repositioning a tint front location from a smaller distance with respect to bus bar 1025(b)/(B2) to a larger distance may occur by decreasing the potential differential between the two TCO layers (as shown in FIG. 12A) and/or by increasing the voltage applied to bus bar on TCO 2, 1020/(A1).

In another example, changing a maximum tint depth in a viewable area of the EC device from one depth level to another depth level may include adjusting or changing a potential difference, as referenced to FIG. 10, between the two TCO layers, i.e., TCO 1 and TCO 2. This change in the potential difference may be performed, in some instances, by changing the applied voltage on one of the bus bars on TCO 1 to a different voltage than the voltage applied to, or set at, the bus bar on TCO 2, and/or changing the applied voltage on the TCO 2 bus bar. Examples of the creation, application, and adjustment of voltages to change a maximum tint gradient are described above and shown in FIGS. 12A, 12B, and 13, for instance.

In some embodiments, to adjust a particular tint gradient to another gradient or abruptness, in a viewable area of the EC device, some embodiments may include adjusting a voltage drop, as referenced to the EC device of FIG. 10, between the two bus bars on TCO 1, i.e., bus bar 1025(a)/(B1) and bus bar 1025(b)/(B2). This may include changing the one voltage applied to one of these TCO 1 bus bars, and/or changing the voltage applied to, or set at, the other TCO 1 bus bar. Examples of the creation, application, and adjustment of voltages to achieve a desired tint gradient are described above and shown in FIG. 13, for instance. In some implementations, a tint gradient abruptness may be increased by increasing the voltage drop across TCO 1 which may be done in various ways, such as increasing the voltage to one bus bar (e.g., changing bus bar 1025(a)/(B1) from 1 V to 2 V while maintaining bus bar 1025(b)/(B2) at the same voltage, e.g., 0 V), decreasing the voltage to one TCO 1 bus bar (e.g., maintaining bus bar 1025(a)/(B1) at 2 V while decreasing the voltage at bus bar 1025(b)/(B2), e.g., from 1 V to 0V), or both.

While these examples are explained with respect to a single changed attribute, it will be understood that more than one attribute may be changed. This may include changing both a tint depth and tint gradient. The relationships provided above illustrate how such adjustments may be made.

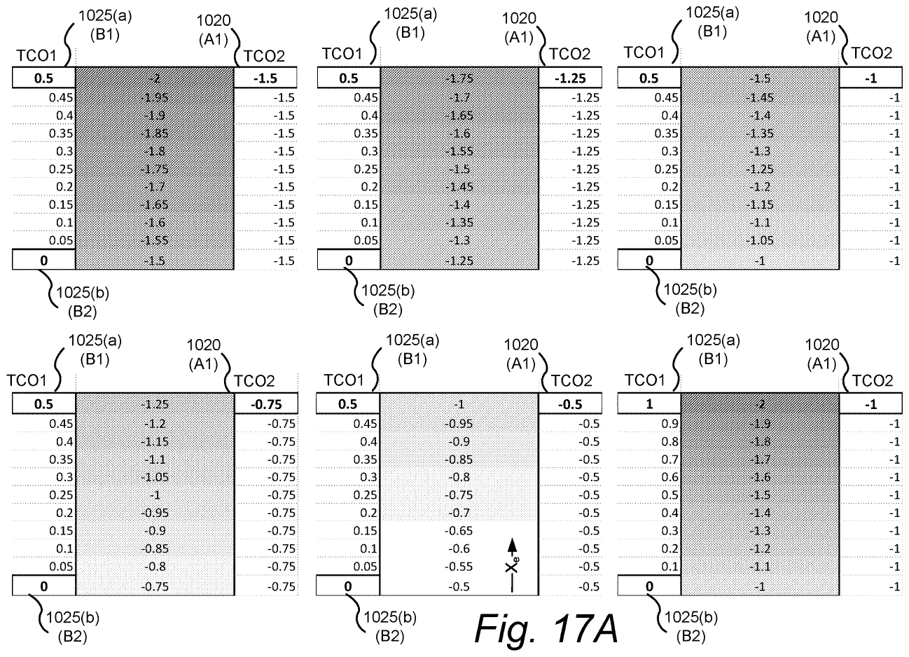

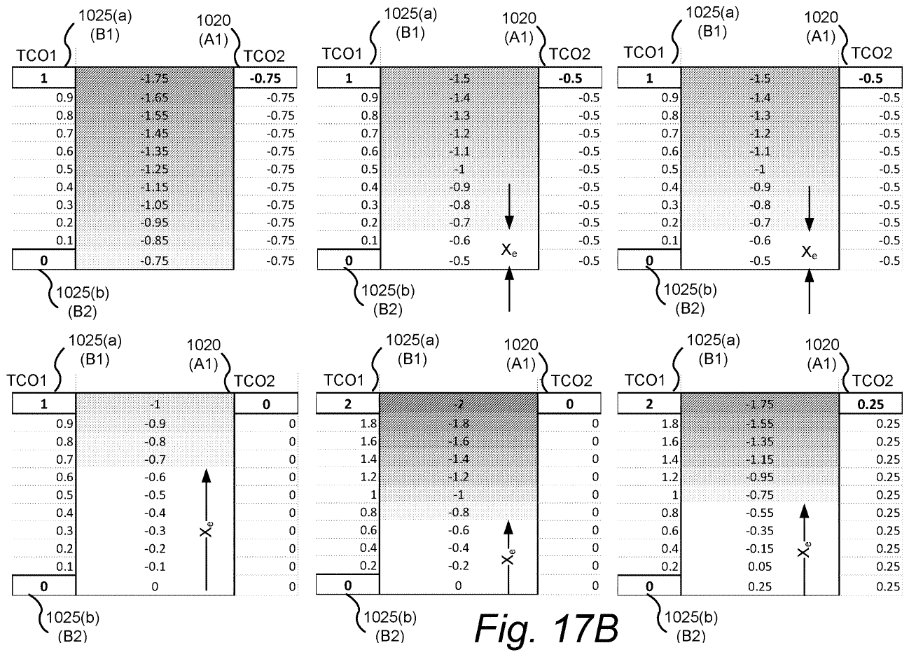

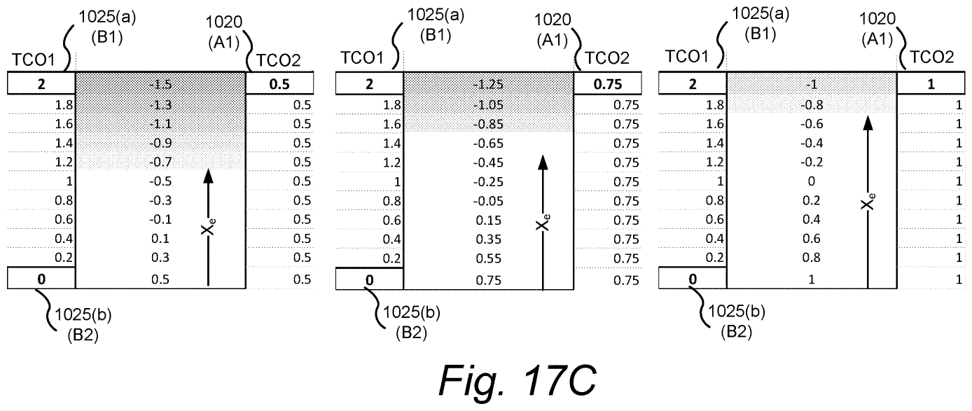

Further to the examples provided in FIGS. 12A, 12B, and 13, FIGS. 17A-C depict additional examples of EC device schematics set to various voltages. The same EC device 1010 is depicted in each schematic with TCO 1 and bus bars 1025(a)/(B1) and 1025(b)/(B2) positioned thereon, and TCO 2 with bus bar 1020/(A1) positioned thereon. FIGS. 17A and 17B both include six schematics and FIG. 17C includes 3 schematics. Various voltages are applied to each of the schematics and the voltage across each TCO layer and the EC device are listed in the corresponding schematic, i.e., as the eleven listed numbers within the box representing the EC lite. As can be seen, the different voltages result in different tinting characteristics and attributes, such as various depth of tint, tint front location (some of which are labeled), and/or different tint transition abruptness (or tint gradient). For example, the schematic of the left-most column and top row of FIG. 17A has a greater tint depth than that of the schematic directly below it. These schematics illustrate, at least in part, some relationships between the different EC device voltages and the resulting tint attributes, and how such attributes can be created, adjusted, changed, and/or modified.

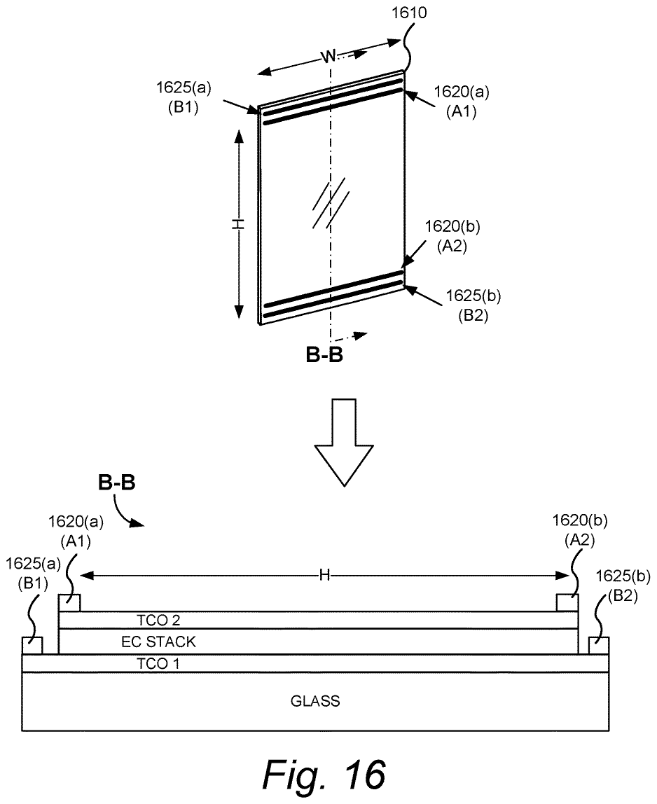

In some embodiments, an EC device may be provided with at least four bus bars, with two bus bars on opposite ends of one TCO layer and to bus bars on opposite ends of the other TCO layer. FIG. 16 depicts a perspective and a cross section of an EC lite 1610, similar to FIG. 5G. Here, two bus bars 1625(a)/(B1) and 1620(a)/(A1) are located at the top of the window and two bus bars 1625(b)/(B2) and 1620(b)/(A2) are located at the bottom of the window. In the depicted embodiment, these four bus bars run along the width W of the EC lite 1610. As seen in the cross-sectional view in the bottom portion of FIG. 16, taken along line Q-Q, the EC lite 1610 has a first pair of bus bars 1625(a)/(B1) and 1625(b)/(B2) located on a first transparent conducting oxide layer, TCO 1, and a second pair of bus bars 1620(a)/(A1) and 1620(b)/(A2) located on a second transparent conductive oxide layer, TCO 2. Cross section Q-Q is not to scale, but rather is a schematic representation of the structure of EC lite 1610. Sandwiched in-between TCO 1 and TCO 2 is an EC stack which contains one or more electrochromic materials, e.g., the transitions of which are driven by intercalation/de-intercalation of ions, such as lithium ions.

With at least the configuration of FIG. 16, the EC lite 1610 can be tinted, including tinting with a tint gradient, and various attributes of the tinting and tint gradient can be controlled. For example, the tinting can be controlled and started from both ends, instead of the single end having the two bus bars of FIG. 10. Here, the tinting directionality can be controlled based on, for instance, the voltages set at, or applied to, either bus bar 1620(a)/(A1) or 1620(b)/(A2) on TCO 2. For instance, referring to FIG. 12A above, the same top down tint profiles can be created from the bottom up by switching the voltages applied to the TCO 1 bus bars 1025(a) and 1025(b) as well as applying the set voltage shown on bus bar 1020 in FIG. 12A to the other, bottom bus bar on TCO 2. This may result in EC lite 1610 tinting from the bottom up by applying a voltage of 2 V to TCO 1 bus bar 1625(b)/(B2), a voltage of 0 V to the other TCO 1 bus bar 1625(a)/(B1), i.e., flipping the applied voltages of FIG. 12A, setting the top TCO 2 bus bar 1620(a)/(A1) to 0 V, and applying a voltage of 1 V to the bottom TCO 2 bus bar 1620(b)/(A2), i.e. thereby flipping the left schematic of FIG. 12A.

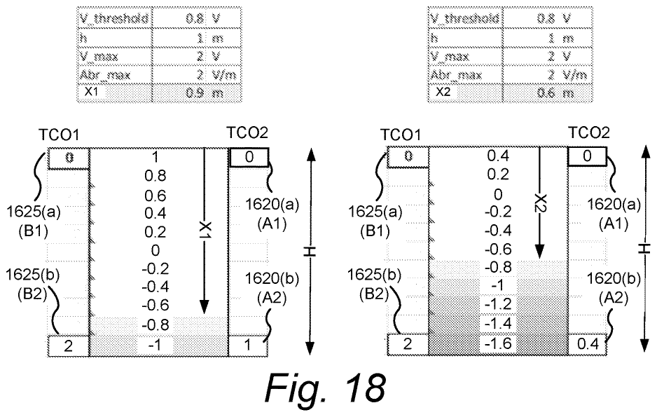

FIG. 18 depicts an example illustration of repositioning a tint front location on the EC device of FIG. 16. Here, similar to FIG. 12A, two schematic representations of the EC lite 1610 of FIG. 16 is provided which depict the bus bars 1625(a)/(B1) and 1625(b)/(B2) positioned on TCO 1, along with bus bars 1620(a)/(A1) and 1620(b)/(A2) positioned on TCO 2. Bus bars 1625(a)/(B1) and 1620(a)/(A1) are in close proximity to each other and at the same end of the EC lite 1610, while bus bars 1625(b)/(B2) and 1620(b)/(A2) are in close proximity to each other and at the same end of the EC lite 1610. The same operating parameters are provided above each schematic in FIG. 18 as in FIG. 12A. As can be seen, the voltages applied to the bus bars in FIG. 12A have been flipped so that the bottom two bus bars 1625(b)/(B2) and 1620(b)/(A2) have the applied voltages of bus bars 1025(a)/(B1) and 1020(a)/(A1) of FIG. 12A, respectively, and bus bar 1625(a)/(B1) has the same applied voltage of bus bar 1025(b)/(B2) of FIG. 12A with bus bar 1620(a)/(A1) being set to ground. Because of this, the same tinting profiles of FIG. 12A are created from the bottom up in FIG. 18. Accordingly, any of the same tinting profiles of FIGS. 12A-13 and 17A-C can be created from the bottom up by flipping the applied voltages and setting to top TCO 2 bus bar 1620(a)/(A1) to ground or zero, in some implementations.

As also illustrated in FIG. 18, in some implementations the tint front location is measured from the top down instead of the bottom up as provided above in FIGS. 12A-13 and 17A-C. The same relationships exist with the tint front location, except that they occur in the opposite direction.

Further, in some implementations, creating a voltage gradient across TCO 1 between bus bars 1625(a)/(B1) and 1625(b)/(B2) while maintaining a constant voltage and/or a gradient on TCO 2 is able to create a tint gradient along at least some of the length, or height H, of the EC lite 1610.

Similar to above, the tinting created by the EC lite 1610 may have independent characteristics that can be controlled by voltages applied to the bus bars of EC lite 1610. These independent tint gradient characteristics include (i) the location of the tint front, (ii) the abruptness or gradient of the tint front transition between the tinting and non-tinting, clear area, and (iii) the depth to which the darkest portion of the EC device tints. In some implementations, the tint front location or position, as measured from the bottom bus bars 1625(b)/(B2) and 1620(b)/(A2), can be represented by a relationship between the voltage drop between bus bars 1625(a)/(B1) and 1625(b)/(B2) on TCO 1, and the voltage and/or voltage drop between bus bars 1620(a)/(A1) and 1620(b)/(A2) on TCO 2. This relationship may be represented by the following formula:

$$\frac{{x}_{e}}{h} = \frac{{V}_{threshold} - V ( B 2 ) + V ( A 2 )}{[ ( V ( B 1 ) - V ( B 2 ) ) - ( V ( A 1 ) - V ( A 2 ) ) ]}$$

Similar to above, xₑ represents the tint front location Xe in FIG. 11, h represents the height H of the EC lite 1610 in FIG. 16, which may be measured between bus bars 1625(a)/(B1) and 1625(b)/(B2) on TCO 1, V_{threshold} represents the threshold voltage needed to create a tint or coloration in the EC device, V(A1) is the voltage applied to bus bar 1620(a)/(A1) on TCO 2, V(A2) is the voltage applied to bus bar 1620(b)/(A2) on the other end of TCO 2, V(B1) is the voltage applied to bus bar 1625(a)/(B1) on TCO 1 that is proximate to bus bar 1620(a)/(A1) on TCO 2, and V(B2) is the voltage applied to the bus bar 1625(b)/(B2) on the opposite end of the EC device and proximate to 1620(b)/(A2). These additional A1, A2, B1, and B2 labels are included in FIGS. 16 and 18. According to this relationship, in some embodiments, this tint front location may be inversely proportional to the voltage drop between bus bars 1625(a)/(B1) and 1625(b)/(A1) on TCO 1, to the voltage drop between bus bars 1620(a)/(A1) and 1620(b)/(A2), and/or to the difference between the voltage drops across both TCOs. This tint front location may also be proportional to the voltage of one bus bar 1620(b)/(A2) on TCO 2 and one bus bar 1625(b)/(B2) on TCO 1. For example, the tint front location Xe increases as the voltage drop across TCO 1 decreases and/or as the voltage drop across TCO 2 also decreases. In another example, the tint front location Xe may increase as the voltage applied to bus bar 1620(b)/(A2) on TCO 2 increases and/or as the voltage applied to bus bar 1625(b)/(B2) decreases, thereby causing the tint front location to become farther from bus bar 1625(b)/(B2). As provided above, the directionality of the tinting may also be controlled by flipping or switching the applied voltages to the bus bars on each TCO layer, e.g., switching the voltages applied to bus bars 1625(a)/(B1) and 1625(b)/(B2) of TCO 1.

In some embodiments, the abruptness of the tint transition, or the tint gradient depth or level, may be based on a relationship between the difference between the voltage drops of the two TCOs. This relationship may be the following:

$$Transition abruptness {∝}_{( V ( B 1 ) - V ( B 2 ) ) - ( V ( A 1 ) - V ( A 2 ) )}$$

Here, the same A1, A2, B1, and B2 voltages are those to the respective bus bars in FIG. 16. As can be seen, the transition abruptness may be adjusted by changing the voltage drop on TCO 1, TCO 2, or both TCOs. According to this relationship, for example, the transition abruptness may be increased by increasing the voltage drop across TCO 1, i.e., between bus bars 1625(a)/(B1) and 1625(b)/(B2), decreasing the voltage drop across TCO 2, i.e., between bus bars 1620(a)/(A1) and 1620(b)/(A2), or both. The transition abruptness may be decreased in the opposite matter. As provided above, the directionality of the tinting and its abruptness may also be controlled by flipping or switching the applied voltages to the bus bars on each TCO layer, e.g., switching the voltages applied to bus bars 1625(a)/(B1) and 1625(b)/(B2) of TCO 1.

In some implementations, the depth of tint may be based on a relationship between the maximum potential difference between the two TCOs. This relationship may be the following:

$$Max depth of tint ∝ maximum [ ( V ( B 1 ) - V ( A 1 ) ) , ( V ( B 2 ) - V ( A 2 ) ) ]$$

Here, the same A1, A2, B1, and B2 voltages are those to the respective bus bars in FIG. 16. As can be seen, the tint depth may be adjusted by changing the maximum potential difference between the voltages applied to the two bus bars that are proximate to each other and on opposite TCO layers. For example, the tint depth may be adjusted or changed by changing the voltage potential difference between bus bars 1625(a)/(B1) and 1620(a)/(A1) and/or between bus bars 1625(b)/(B2) and 1620(b)/(A2). In another instance, the tint depth may be increased by increasing the potential difference between one or both of these sets of proximate bus bars. As provided above, the directionality of the tinting and its maximum tint depth may also be controlled by flipping or switching the applied voltages to the bus bars on each TCO layer, e.g., switching the voltages applied to bus bars 1625(a)/(B1) and 1625(b)/(B2) of TCO 1.

In some embodiments, the techniques of FIGS. 14 and 15 may be used with the EC device 1610 of FIG. 16 using the relationships provided above. This includes determining one or more of a tint front, tint depth, and/or transition abruptness and then setting or selecting the voltages applied to all four bus bars to achieve the determined tint attribute. This also includes adjusting one or more tint attributes to a second tint attribute by changing one or more voltages applied or set on one or more of the bus bars on EC device 1610 of FIG. 16. This may also include switching the direction of the tint from top to bottom, or bottom to top, by switching the voltages seen in FIGS. 12A, 12B, 13, and 17A-C for example, of the voltages applied to TCO 1 and TCO 2, including setting the TCO 2 voltage on the other bus bar 1620(b)/(A2). This flipping or switching is illustrated in FIG. 18 and described above.

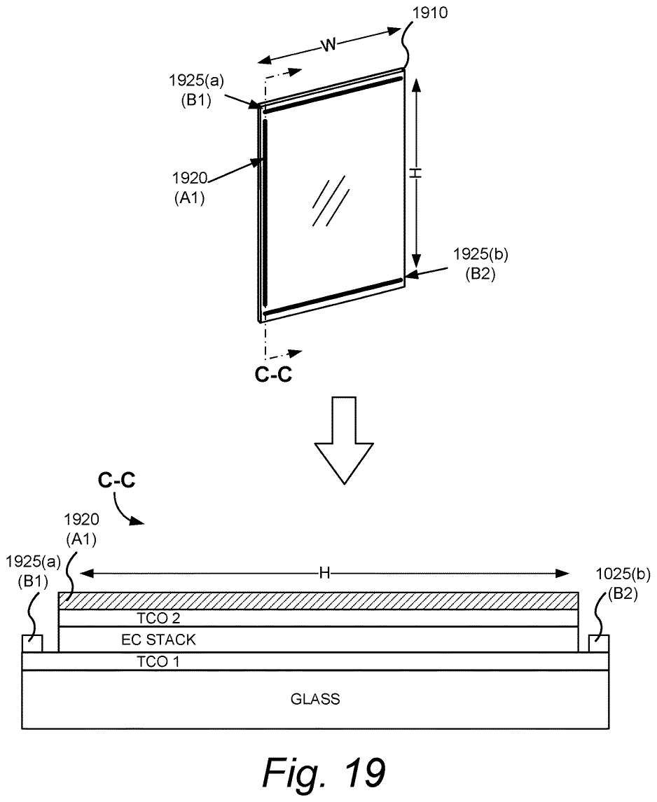

In some embodiments, the orientations of one or more of the bus bars may be different than shown in FIGS. 10-13 and 16-18. This may include one or more bus bars being orthogonal to the other bus bars, such as a bus bar on one TCO layer being orthogonal to the bus bars on the other TCO layer. FIG. 19 depicts a perspective and a cross-section of an EC device, EC lite 1910. Here, two bus bars 1925(a) and 1925 (b) are located along the width W of the EC lite 1910 and one bus bar 1920 is orthogonal to these other two bus bars and oriented along the length, or height H, of the EC lite 1910. Bus bar 1925(a)/(B1) is located at the top of the window and bus bar 1925 (b)/(B2) is located at the bottom; bus bar 1920 is located on the left of the EC lite 1910. As seen in the cross-sectional view in the bottom portion of FIG. 19, taken along line P-P, the EC lite 1910 has a first pair of bus bars 1925(a)/(B1) and 1925 (b)/(B2) located on a first transparent conducting oxide layer, TCO 1, and a bus bar 1920/(A1) located on a second transparent conductive oxide layer, TCO 2. Cross-section P-P is not to scale, but rather is a schematic representation of the structure of EC lite 1910. Sandwiched in-between TCO 1 and TCO 2 is an EC stack which contains one or more electrochromic materials, e.g., the transitions of which are driven by intercalation/de-intercalation of ions, such as lithium ions.

With at least the configuration of FIG. 19, the EC lite 1910 can be tinted, including tinting with a tint gradient, and various attributes of the tinting and tint gradient can be controlled. The tinting created by the EC lite 1910 may have independent characteristics that can be controlled by voltages applied to the bus bars of EC lite 1910. These independent tint characteristics include (i) the location of the tint front, (ii) the abruptness or gradient of the tint front transition between the tinting and non-tinting, clear area, and (iii) the depth to which the darkest portion of the EC device tints. These tint characteristics or tint attributes may have the same relationships as those provided above with respect to EC lites 1010 of FIGS. 10-13 and 17A-C. For EC lite 1910, the tinting shape and direction may be different than those of EC lite 1010 as illustrated in FIGS. 10-13 and 17A-C, such as originating from the corner of the EC lite instead of from the top or bottom along the width as shown in FIGS. 10-13 and 17A-C.

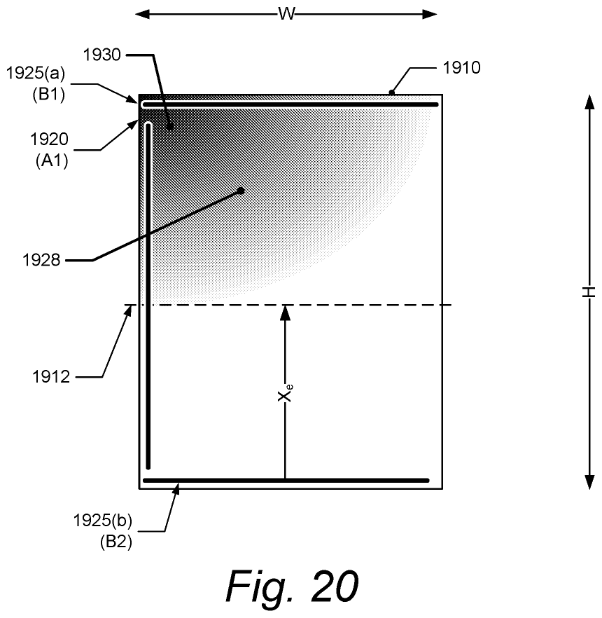

The various tinting attributes of EC lite 1910 are further illustrated in FIG. 20 which depicts a front view of the EC lite 1910 of FIG. 19 in an exemplary tinted state. Here, the EC lite 1910 is tinted in a first tint state having a tint front 1912, which is the average, nominal tint front represented by dashed line 1912, at a tint front location Xe as measured from the bottom, single bus bar 1925 (b). The tinting also has a tint transition region 1928 where the tint transitions between tinting and non-tinting (this may also be considered a tint gradient area), and a darkest tint area 1930 where the tinting is the darkest. It is one or more of these tinting attributes that may be controlled and adjusted by, for example, adjusting the voltages applied to the bus bars. Also for EC lite 1910, the darkest tinting area occurs at the corner where bus bars 1925(a)/(B1) and 1920/(A1) are closest. The tint gradient area may emanate and spread out from this same corner and the tint front location 1912 may again be the average nominal location of the tinting.

In some implementations, the corner from which the tinting originates may be controlled or adjusted. In FIG. 19, the voltage differential between bus bars 1925(a)/(B1) and 1920/(A1) causes the tinting to begin in the corner where these bus bars are proximate to each other, similar to the proximity of bus bars 1025(a)/(B1) and 1020/(A1) described above. In some embodiments, the location of the corner from where the tinting originates may be changed by adjusting the voltage applied to the TCO 1 bus bars, similar to the flipping described above. This may be achieved by switching or flipping the voltage applied to the TCO 1 bus bars, or changing the location of the maximum voltage differential between the TCO layers. For instance, in FIG. 20, EC lite 1910 may be caused to tint by applying a voltage of 2 V to TCO 1 bus bar 1925(a)/(B1), setting a voltage of 0 V to the other TCO 1 bus bar 1925 (b)/(B2), and applying a voltage of 1 V to the TCO 2 bus bar 1920/(A1). By flipping the voltages of the TCO 1 bus bars, or flipping the location of the largest potential between the TCO layers, the corner from where the tinting originates may change. For example, the voltage of bus bars 1925(a)/(B1) and 1925 (b)/(B2) may be switched or flipped such that bus bar 1925(a)/(B1) is set to 0 V and bus bar 1925 (b)/(B2) at the bottom has an applied voltage of 2 V. This change creates a larger voltage potential between bus bar 1925 (b)/(B2) and further causes the tinting to originate from the bottom left corner instead of the top left corner as illustrated.

The tinting of EC lite 1910 may again be created, controller, and adjusted according to the same relationships described above. For instance, a relationship between the voltages applied to EC lite 1910 and the transition abruptness can be expressed in the same relationship as above:

$$Transition abruptness {∝}_{V ( B 1 ) - V ( B 2 )}$$

Like above, “V(B1)” is the voltage applied to bus bar 1925(a)/(B1) on TCO 1 at the top of the window and “V(B2)” is the voltage applied to bus bar 1925 (b)/(B2) on TCO 1 at the opposite, bottom end of the window. A difference with EC lite 1910 is that the transition abruptness may occur in a different direction and shape than provided in FIGS. 11-13 and 17A-C, for instance. In some implementations, the transition abruptness of EC lite 1910 may be increased by increasing the voltage drop across TCO 1. This increasing of the abruptness may also be considered changing the tint gradient and/or increasing the depth of the tint gradient.

In some implementations, the above relationships may be used to control the EC device 1910 of FIG. 19 in various manners in order to produce desired tint attributes. Similar to above, the relationships may be rewritten in order to solve for a necessary bus bar voltage given a desired, set, or determined tint attribute. In the rewritten relationships, the tint attributes become the independent variables and one or more voltages become the dependent variables. The same two equations from above can return the necessary voltage(s) applied to TCO 1, e.g., to bus bar 1925(a)/(B1), and to TCO 2, e.g., bus bar 1920/(A1) for producing a given tint front location, a given tint depth, and/or a tint gradient (or transition abruptness) level.

$$V ( B 1 ) = minimum ( {Abr}_{max} \times h , \frac{{V}_{max} - {V}_{threshold}}{( 1 - \frac{x}{h} )} ) \qquad ( 1 )$$

$$V ( A 1 ) = ( V ( B 1 ) \times \frac{x}{h} ) - {V}_{threshold} \qquad ( 2 )$$

In some embodiments, the techniques of FIGS. 14 and 15 may be used with the EC device 1910 of FIG. 19 using the relationships provided above. This includes determining one or more of a tint front, tint depth, and/or transition abruptness and then setting or selecting the voltages applied to all four bus bars to achieve the determined tint attribute. This also includes adjusting one or more tint attributes to a second tint attribute by changing one or more voltages applied or set on one or more of the bus bars on EC device 1910 of FIG. 19.

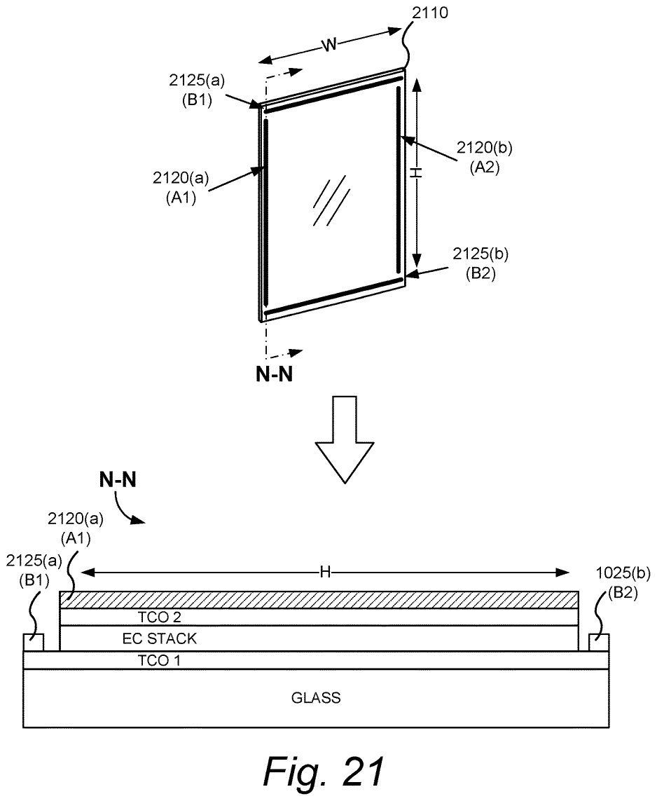

In implementations, an EC lite may contain two pairs of bus bars with one pair on one TCO layer that is orthogonal to the other pair located on the other TCO layer. FIG. 21 depicts a perspective and a cross-section of an EC device, EC lite 2110. Here, one pair of bus bars, bus bars 2125(a) and 2125 (b), is located along the width W of the EC lite 2110 and a second pair of bus bars, bus bars 2120(a) and 2120 (b) are orthogonal to the first pair of bus bars 2125(a) and 2125 (b) and oriented along the length, or height H, of the EC lite 2110. Bus bar 2125(a)/(B1) is located at the top of the window, bus bar 1925 (b)/(B2) is located at the bottom, bus bar 1920(a)/(A1) is located on the left side of the EC lite 2110, and bus bar 1920 (b)/(A2) is located on the right side of the EC lite 2110. As seen in the cross-sectional view in the bottom portion of FIG. 21, taken along line N-N, the EC lite 2110 has a first pair of bus bars 2125(a)/(B1) and 2125 (b)/(B2) located on a first transparent conducting oxide layer, TCO 1, and a second pair of bus bars 2120(a)/(A1) and 2120 (b)/(A2) located on a second transparent conductive oxide layer, TCO 2. Cross-section N-D is not to scale, but rather is a schematic representation of the structure of EC lite 12110. Sandwiched in-between TCO 1 and TCO 2 is an EC stack which contains one or more electrochromic materials, e.g., the transitions of which are driven by intercalation/de-intercalation of ions, such as lithium ions.

With at least the configuration of FIG. 21, the EC lite 2110 can be tinted, including tinting with a tint gradient, and various attributes of the tinting and tint gradient can be controlled. The tinting created by the EC lite 2110 may have independent characteristics that can be controlled by voltages applied to the bus bars of EC lite 2110. These independent tint characteristics include (i) the location of the tint front, (ii) the abruptness or gradient of the tint front transition between the tinting and non-tinting, clear area, and (iii) the depth to which the darkest portion of the EC device tints. These tint characteristics or tint attributes may have the same relationships as those provided above with respect to EC lites 2110 of FIGS. 10-13 and 16-18, including the four bus bar configuration of EC lite 1610 of FIG. 16. For EC lite 2110, the tinting shape and direction may be similar to that of FIG. 19. Similar to above, one or more of EC lite 2110's tinting attributes that may be controlled and adjusted by, for example, adjusting the voltages applied to the bus bars.

With the implementation of EC lite of FIG. 21, the tinting may be controlled in the same manners as provided above and also controlled such that the tinting may originate from any of the corners of the EC lite 2110. For example, the tinting may originate from the top left corner or bottom left corner as described above with respect to FIGS. 19 and 20. With EC lite 2110, the tinting may be caused to originate from the top right or bottom right corners by creating a potential difference between TCO 1 and the right-side bus bar 2120 (b)/(A2) and, in some implementations, setting the voltage of the left-side bus bar 2120(a)/(A1) to 0 V.

The tinting of EC lite 2110 may again be created, controller, and adjusted according to the same relationships described above. For instance, a relationship between the voltages applied to EC lite 2110 and the maximum tint can be expressed in the same relationship as above with respect to FIG. 16 which may be based on a relationship between the maximum potential difference between the two TCOs:

$$Max depth of tint ∝ maximum [ ( V ( B 1 ) - V ( A 1 ) ) , ( V ( B 2 ) - V ( A 2 ) ) ]$$

Here, the same A1, A2, B1, and B2 voltages are those to the respective bus bars in FIG. 21. As can be seen, the tint depth may be adjusted by changing the maximum potential difference between the voltages applied to the two bus bars that are proximate to each other and on opposite TCO layers. For example, the tint depth may be adjusted or changed by changing the voltage potential difference between bus bars 2125(a)/(B1) and 2120(a)/(A1) and/or between bus bars 2125 (b)/(B2) and 2120 (b)/(A2).

In some embodiments, the techniques of FIGS. 14 and 15 may be used with the EC device 2110 of FIG. 21 using the relationships provided above. This includes determining one or more of a tint front, tint depth, and/or transition abruptness and then setting or selecting the voltages applied to all four bus bars to achieve the determined tint attribute. This also includes adjusting one or more tint attributes to a second tint attribute by changing one or more voltages applied or set on one or more of the bus bars on EC device 2110 of FIG. 21. This may also include switching the direction of the tint between any of the corners of the EC lite 2110.

One of ordinary skill in the art, armed with this disclosure, would appreciate that tint gradient zones can be used with resistive zones and this combination is within the scope of the embodiments described herein. For example a single EC lite, or a façade, can be made to both tint with gradients and display words, symbols and the like.

Although the foregoing embodiments have been described in some detail to facilitate understanding, the described embodiments are to be considered illustrative and not limiting. It will be apparent to one of ordinary skill in the art that certain changes and modifications can be practiced within the scope of the above description and the appended claims.

What is claimed is:

1. A method of tinting an electrochromic (“EC”) window lite comprising a monolithic EC device disposed on a transparent substrate, the monolithic EC device having a first transparent conductive oxide (“TCO”) layer, a second TCO layer, and an EC stack between the first and second TCO layers, and the EC window lite further comprising a first bus bar disposed on the first TCO layer, a second bus bar disposed on the first TCO layer and at an opposite end of the monolithic EC device from the second bus bar, and a third bus bar disposed on the second TCO layer, the method comprising:
determining one or more tint attributes for tinting the monolithic EC device, wherein the one or more tint attributes are selected from the group consisting of:
a first tint front at a first average nominal position within a viewable area of the monolithic EC device,
a first maximum tint level, and
a first tint gradient; and
setting or selecting one or more parameters to achieve the one or more tint attributes, wherein the one or more parameters include a first voltage of the first bus bar, a second voltage to the second bus bar, a third voltage of the third bus bar, a voltage drop between the first and second bus bars, a first voltage differential between the first bus bar and the third bus bar, a second voltage differential between the second bus bar and the third bus bar, or a combination thereof.

2. The method of claim 1, wherein:
the one or more attributes includes the first tint front at the first average nominal position, and
the one or more parameters to achieve the one or more tint attributes includes setting or selecting the first voltage and the second voltage to create the voltage drop between the first bus bar and the second bus bar.

3. The method of claim 2, wherein the first average nominal position of the first tint front is based, at least in part, on a relationship between a voltage differential between the second bus bar and the third bus bar, and the voltage drop between the first bus bar and the second bus bar.

4. The method of claim 3, wherein:
the relationship is expressed as:
$$\frac{first average nominal position of first tint front}{a height of the EC window lite} = \frac{{V}_{threshold} - V ( B 2 ) + V ( A 1 )}{V ( B 1 ) - V ( B 2 )}$$
and “V(B1)” is the first voltage, “V(B2)” is the second voltage, “V(A1)” is the third voltage, and “V_{threshold}” is a threshold voltage at which voltage the EC window lite tints.

5. The method of claim 3, wherein the first average nominal position of the first tint front is:
inversely proportional to the voltage drop between the first bus bar and the second bus bar, and
proportional to the third voltage.

6. The method of claim 2, further comprising:
determining a second tint front at a second average nominal position within the viewable area of the monolithic EC device; and
setting or selecting one or more second parameters to achieve the second tint front, wherein the one or more second parameters include setting or selecting one or more of a fourth voltage for the first bus bar, a fifth voltage for the second bus bar, a sixth voltage for the third bus bar, a second voltage drop between the first bus bar and the second bus bar, or a combination thereof.

7. (canceled)

8. (canceled)

9. (canceled)

10. (canceled)

11. The method of claim 2, wherein:
the first and third bus bars are positioned proximate to each other at a first end of the EC window lite and the second bus bar is positioned at a second end of the EC window lite opposite the first end, and
the first average nominal position of the first tint front location is measured from the second bus bar and extending towards the first and second bus bars.

12. The method of claim 1, wherein:
the one or more attributes includes the first maximum tint level, and
the one or more parameters to achieve the one or more tint attributes includes setting or selecting the first voltage, the second voltage, the third voltage, the first voltage differential, the second voltage differential, or a combination thereof.

13. The method of claim 12, wherein the first maximum tint level is based, at least in part, on a relationship between the first voltage differential and/or the second voltage differential.

14. (canceled)

15. The method of claim 12, wherein the first maximum tint level is proportional to the first voltage differential and proportional to the second voltage differential.

16. The method of claim 12, further comprising:
determining a second maximum tint level; and
setting or selecting one or more second parameters to achieve the second maximum tint level, wherein the one or more second parameters include setting or selecting one or more of a fourth voltage for the first bus bar, a fifth voltage for the second bus bar, a sixth voltage for the third bus bar, a third voltage differential between the first bus bar and the third bus bar, a fourth voltage differential between the second bus bar and the third bus bar, or a combination thereof.

17. (canceled)

18. (canceled)

19. The method of claim 1, wherein:
the one or more attributes includes the first tint gradient, and
the one or more parameters to achieve the one or more tint attributes includes setting or selecting the first voltage and the second voltage to create the voltage drop.

20. The method of claim 19, wherein the first tint gradient is based, at least in part, on a relationship between the first voltage and the second voltage.

21. (canceled)

22. The method of claim 19, wherein the first tint gradient is proportional to the voltage drop.

23. The method of claim 19, further comprising:
determining a second tint gradient; and
setting or selecting one or more second parameters to achieve the second tint gradient, wherein the one or more second parameters include setting or selecting one or more of a fourth voltage for the first bus bar, a fifth voltage for the second bus bar, a second voltage drop between the first bus bar and the second bus bar, or a combination thereof.

24. (canceled)

25. (canceled)

26. The method of claim 1, wherein the first, second, and third bus bars span the length of the EC window lite.

27. The method of claim 1, wherein EC window lite includes only three bus bars.

28. The method of claim 1, wherein the third bus bar is orthogonal to the first and second bus bars.

29. The method of claim 1, wherein:
the EC window lite further includes a fourth bus bar disposed on the second TCO layer and at an opposite end of the EC window lite from the third bus bar, and
the one or more parameters further include a fourth voltage of the fourth bus bar, a second voltage drop between the third and fourth bus bars, a third voltage differential between the first bus bar and the fourth bus bar, a fourth voltage differential between the second bus bar and the fourth bus bar, or a combination thereof.

30. The method of claim 29, wherein:
the one or more attributes includes the first tint front at the first average nominal position, and
the one or more parameters to achieve the one or more tint attributes includes setting or selecting the first voltage and the second voltage to create the voltage drop between the first bus bar and the second bus bar, setting or selecting the third voltage and the fourth voltage to create the second voltage drop between the third bus bar and the fourth bus bar.

31. The method of claim 30, wherein the first average nominal position of the first tint front is based, at least in part, on a relationship between a voltage differential between the second bus bar and the fourth bus bar, the voltage drop between the first bus bar and the second bus bar, and the voltage drop between the third bus bar and the fourth bus bar.

32. (canceled)

33. (canceled)

34. (canceled)

35. The method of claim 29, wherein:
the one or more attributes includes the first maximum tint level, and
the one or more parameters to achieve the one or more tint attributes includes setting or selecting the first voltage, the second voltage, the third voltage, the fourth voltage, the first voltage differential, the fourth voltage differential, or a combination thereof.

36. (canceled)

37. (canceled)

38. The method of claim 35, further comprising:
determining a second maximum tint level; and
setting or selecting one or more second parameters to achieve the second maximum tint level, wherein the one or more second parameters include setting or selecting one or more of a fifth voltage for the first bus bar, a sixth voltage for the second bus bar, a seventh voltage for the third bus bar, eighth voltage for the fourth bus bar, a fifth voltage differential between the first bus bar and the third bus bar, a sixth voltage differential between the second bus bar and the fourth bus bar, or a combination thereof.

39. (canceled)

40. The method of claim 29, wherein:
the one or more attributes includes the first tint gradient, and
the one or more parameters to achieve the one or more tint attributes includes setting or selecting the first voltage and the second voltage to create the voltage drop and/or setting or selecting the third voltage and the fourth voltage to create the second voltage drop.

41. The method of claim 40, wherein the first tint gradient is based, at least in part, on a relationship between the first voltage drop and the second voltage drop.

42. (canceled)

43. The method of claim 40, further comprising:
determining a second tint gradient; and
setting or selecting one or more second parameters to achieve the second tint gradient, wherein the one or more second parameters include setting or selecting one or more of a fifth voltage for the first bus bar, a sixth voltage for the second bus bar, a seventh voltage for the third bus bar, an eighth voltage for the fourth bus bar, a third voltage drop between the first bus bar and the second bus bar, a fourth voltage drop between the third bus bar and the fourth bus bar, or a combination thereof.

44. (canceled)

45. The method of claim 29, wherein the third and fourth bus bar are orthogonal to the first and second bus bars.

46. An electrochromic window lite comprising:
a transparent substrate;
a monolithic electrochromic device disposed on the transparent substrate and having a first transparent conductive oxide (“TCO”) layer, a second TCO layer opposite the first TCO layer, and an electrochromic stack between the first and second TCO layers; and
a pair of bus bars disposed on the first TCO layer, wherein:
one bus bar has a substantially uniform cross-sectional area along its length, and
variable resistance exists between the one bus bar and the first TCO layer.

47. The electrochromic window lite of claim 46, further comprising an insulating layer of material between the one bus bar and the first TCO layer, wherein:
the one bus bar is in direct contact with the insulating layer of material,
the insulating layer of material has variable resistance along its length.

48. The electrochromic window lite of claim 47, wherein the insulating layer of material has a variable cross-sectional area along its length.

49. The electrochromic window lite of claim 48, wherein the insulating layer of material has one or more of: a variable height along its length, a variable width along its length, a tapered cross-sectional area along its length, variable density along its length, or variable morphology along its length.

50. The electrochromic window lite of claim 47, wherein:
the insulating layer of material has a first resistance in a first section, and
the insulating layer of material has a second resistance in a second section different than the first resistance.

51. The electrochromic window lite of claim 46, wherein:
the one bus bar is in direct contact with the first TCO layer,
a first resistance exists in a first area between the one bus bar and the first TCO layer, and a second resistance less than the first resistance exists in a second area between the one bus bar and the first TCO layer.

52. The electrochromic window lite of claim 51, wherein the first TCO layer has a first thickness in the first area and a second thickness in the second area.

53. The electrochromic window lite of claim 51, wherein the first TCO layer has a first morphology in the first area and a second morphology in the second area.
